(19) United States
(12) Patent Application Publication
(10) Pub. No.: US 2019/0156188 A1
(43) Pub. Date: May 23, 2019

(54) ARITHMETIC PROCESSING DEVICE

(71) Applicant: KABUSHIKI KAISHA TOSHIBA, Minato-ku (JP)

(72) Inventors: Mizuki Ono, Yokohama (JP); Kosuke Tatsumura, Yokohama (JP); Masaya Yamasaki, Ome (JP)

(73) Assignee: KABUSHIKI KAISHA TOSHIBA, Minato-ku (JP)

(21) Appl. No.: 15/917,076

(22) Filed: Mar. 9, 2018

(30) Foreign Application Priority Data
Nov. 17, 2017 (JP) 2017-222293

(51) Int. Cl. G06N 3/063; G06F 17/15

(52) U.S. Cl. CPC G06N 3/063; G06F 17/15

(57) ABSTRACT

An arithmetic processing device according to an embodiment includes: a first storage device including a first array having memory elements arranged in a first direction and a second direction intersecting with the first direction; a second storage device including a second array having memory elements arranged in the first direction; a third storage device including a third array having memory elements arranged in the first and second directions, the third array having a smaller number of memory elements arranged in the first direction than the memory elements of the first array, arranged in the first direction, and having a smaller number of memory elements arranged in the second direction than the memory elements of the first array, arranged in the second direction; and a first process layer, using data stored in the memory elements of the third array, to perform a convolution process.

### CROSS REFERENCE TO RELATED APPLICATIONS

This application is based upon and claims the benefit of priority from the prior Japanese Patent Application No. 2017-222293 filed on Nov. 17, 2017, the entire contents of which are incorporated herein by reference.

### FIELD

Embodiments described herein relate generally to an arithmetic processing device.

### BACKGROUND

Conventionally, an arithmetic processing device, which realizes a convolutional neural network including a plurality of process layers, includes a storage device, for each process layer, which stores all outputs of the process layer. The arithmetic processing device performs all process of each process layer, stores all outputs of the process layer in the storage device, and then, using the numerical values stored in the storage device, performs a process of the succeeding process layer.

Moreover, the arithmetic processing device, which realizes a convolutional neural network including a plurality of process layers, reads out the numerical values stored in a storage device located externally (also referred to as an external storage device), each time, for use in a plurality of processes, that is, for use by a plurality of times.

The conventional arithmetic processing device has a problem of a large occupied area in the chip and a slow operation speed, as explained later.

### BRIEF DESCRIPTION OF THE DRAWINGS

FIG. 1 is a schematic diagram explaining a problem of a conventional arithmetic processing device.

FIG. 2 is a schematic diagram explaining a problem of a conventional arithmetic processing device.

FIG. 3 is a block diagram showing an arithmetic processing device according to a first embodiment.

FIG. 4 is a diagram explaining the arithmetic processing device of the first embodiment.

FIGS. 5A to 5Q are diagrams explaining a convolution process according to the first embodiment.

FIGS. 6A to 6F are diagrams explaining a pooling process according to the first embodiment.

FIG. 7 is a diagram explaining part of the convolution process according to the first embodiment.

FIGS. 8A to 8F are diagrams explaining part of the pooling process according to the first embodiment.

FIGS. 9A to 9F are diagrams explaining part of the pooling process according to the first embodiment.

FIG. 10 is a diagram explaining part of the pooling process according to the first embodiment.

FIG. 11 is a diagram explaining part of the pooling process according to the first embodiment.

FIG. 12 is a diagram showing an arithmetic processing device according to a second embodiment.

FIGS. 13A to 13L are diagrams explaining part of a convolution process according to the second embodiment.

FIGS. 14A to 14M are diagrams explaining part of the convolution process according to the second embodiment.

FIG. 15 is a diagram showing an arithmetic processing device according to a first modification of the first or the second embodiment.

FIG. 16 is a diagram showing an arithmetic processing device according to a second modification of the first or the second embodiment.

FIG. 17 is a diagram showing an arithmetic processing device according to a third modification of the first or the second embodiment.

FIG. 18 is a diagram showing an arithmetic processing device according to a third embodiment.

FIG. 19 is a diagram showing an arithmetic processing device according to a first modification of the third embodiment.

FIG. 20 is a diagram explaining an operation of the first modification of the third embodiment.

FIGS. 21A to 21E are diagrams explaining an operation of the first modification of the third embodiment.

FIGS. 22A to 22K are diagrams explaining an operation of the first modification of the third embodiment.

FIG. 23 is a diagram showing an arithmetic processing device according to another example of the first modification of the third embodiment.

FIG. 24 is a diagram showing an arithmetic processing device according to a second modification of the third embodiment.

FIG. 25 is a diagram explaining an operation of the second modification of the third embodiment.

FIGS. 26A to 26K are diagrams explaining an operation of the second modification of the third embodiment.

FIG. 27 is a diagram explaining an operation of the second modification of the third embodiment.

FIG. 28 is a diagram explaining an operation of the second modification of the third embodiment.

FIG. 29 is a diagram showing an arithmetic processing device according to a third modification of the third embodiment.

FIG. 30 is a diagram explaining an operation of the third modification of the third embodiment.

FIGS. 31A and 31B are diagrams explaining an operation of the third modification of the third embodiment.

FIGS. 32A to 32J are diagrams explaining an operation of the third modification of the third embodiment.

FIG. 33 is a diagram showing an arithmetic processing device according to another example of the third modification of the third embodiment.

### DETAILED DESCRIPTION

Before explaining the embodiments, the circumstances that led to the embodiments will be explained.

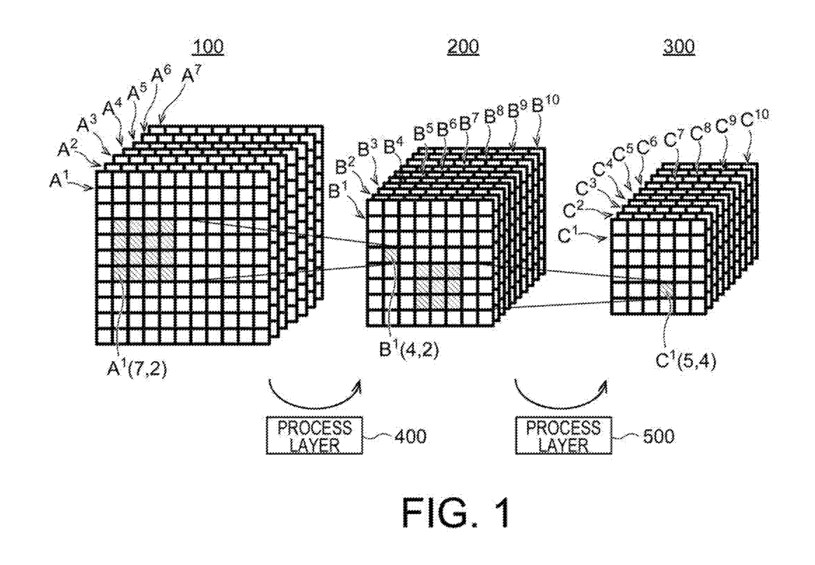

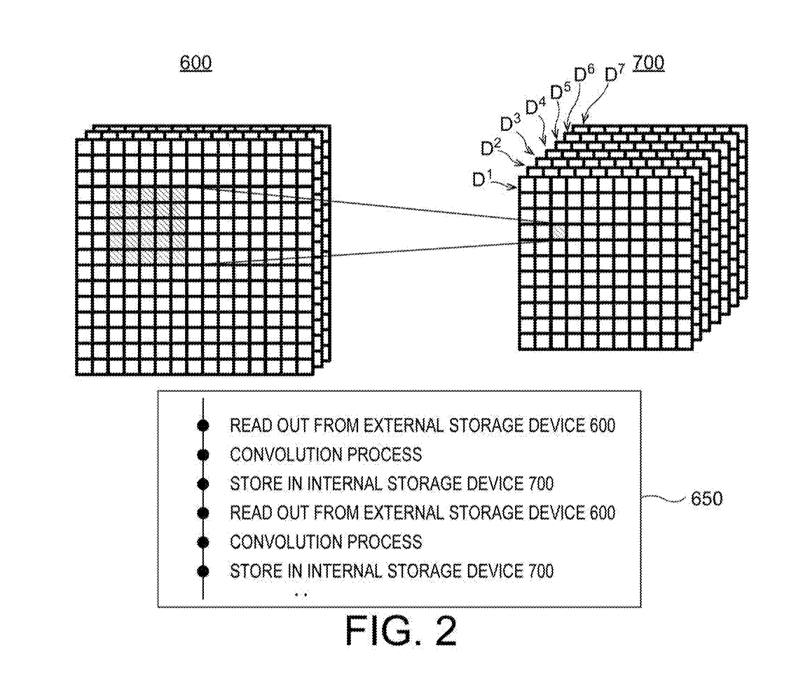

First of all, a brief description of an example of a conventional arithmetic processing device that realizes a convolutional neural network including a plurality of process layers will be made with reference to FIGS. 1 and 2. This arithmetic processing device includes a storage device 100, a storage device 200, a storage device 300, a process layer 400, and a process layer 500. The storage device 100 includes seven groups of arrays A¹ to A⁷, each array Aⁱ (i=1, . . . , 7) having memory elements arranged in 11 rows and 11 columns. There are seven arrays A¹ to A⁷ arranged in a direction (depth direction) that intersects with an in-plane direction in which each array is disposed. A memory element in a j-th (j=1, . . . , 11) row and a k-th (k=1, . . . , 11) column in each array Aⁱ (i=1, . . . , 7) is expressed as Aⁱ (j, k) which also expresses a numerical value to be stored in the memory element of the j-th row and the k-th column in the array Aⁱ (i=1, . . . , 7). The storage device 200 includes 10 groups of arrays B¹ to B¹⁰, each array Bⁱ (i=1, . . . , 10) having memory elements arranged in eight rows and eight columns. A memory element in a j-th (j=1, . . . , 8) row and a k-th (k=1, . . . , 8) column in each array B′ (i=1, . . . , 10) is expressed as Bⁱ (j, k) which also expresses a numerical value to be stored in the memory element of the j-th row and the k-th column in the array Bⁱ (i=1, . . . , 10). The storage device 300 includes 10 groups of arrays C¹ to C¹⁰, each array Cⁱ (i=1, . . . , 10) having memory elements arranged in six rows and six columns. A memory element in a j-th (j=1, . . . , 6) row and a k-th (k=1, . . . , 6) column in each array Cⁱ (i=1, . . . , 10) is expressed as Cⁱ (j, k) which also expresses a numerical value to be stored in the memory element of the j-th row and the k-th column in the array Cⁱ (i=1, . . . , 10). Moreover, in this example, the process layer 400 is a layer of, for example, performing a convolution process and the process layer 500 is a layer of, for example, performing a pooling process. In the present specification, a product-to-sum operation is referred to as a convolution process, hereinafter. It does not matter in which direction of dimension the numerical values, which are a target of the convolution process, are arranged. For example, the space with a first direction is referred to as one dimension, the space with the first direction and a second direction is referred to as two dimensions, and the space with the first direction, the second direction, and also a third direction (a depth, a depth direction) is referred to as three dimensions. It also does not matter in which dimension targets of the convolution process are arranged.

The process layer 400 uses, for example, first to tenth kernels, not shown, configured with memory elements arranged in an array of four rows and four columns to calculate products of numerical values stored in memory elements of four rows and four columns in the storage device 100. The sum of these products is stored in the corresponding memory element of the corresponding array of the storage device 200. In the same manner as A¹ to A⁷, there are seven arrays for each of the first to tenth kernels, in a direction (depth direction) that intersects with the in-plane direction in which each array is disposed. In other words, each of the first to tenth kernels has seven arrays of four rows and four columns. A product-to-sum operation using each of the first to tenth kernels is performed. For example, a product-to-sum operation using the first kernel is performed as follows. Products of a numerical value stored in a memory element in a depth of one in the first kernel and numerical values in the corresponding memory elements of memory elements A¹ (4, 2) to A¹ (7, 5) shown by oblique lines are calculated and the sum of these products is stored in a memory element B¹ (4, 2) shown by oblique lines in the corresponding array of the storage device 200. For example, a product of a numerical value stored in a memory element of the first row and first column in the depth of one in the first kernel and a numerical value stored in the memory element A¹ (4, 2), a product of a numerical value stored in a memory element of the second row and first column of the first kernel and a numerical value stored in the memory element A¹ (5, 2), a product of a numerical value stored in a memory element of the third row and first column of the first kernel and a numerical value stored in the memory element A¹ (6, 2), and a product of a numerical value stored in a memory element of the fourth row and first column of the first kernel and a numerical value stored in the memory element A¹ (7, 2) are calculated. In the same manner, a product of a numerical value stored in each memory element of the second column of the first kernel and numerical values stored in the corresponding memory elements in the fourth row and third column to the seventh row and third column in the array A¹, a product of a numerical value stored in each memory element of the third column of the first kernel and numerical values stored in the corresponding memory elements in the fourth row and fourth column to the seventh row and fourth column in the array A¹, and a product of a numerical value stored in each memory element of the first row and fourth column of the first kernel and numerical values stored in the corresponding memory elements in the fourth row and fifth column to the seventh row and fifth column in the array A¹ are calculated. Thereafter, the sum of those products, that is, product-to-sum, is calculated. The above-described product-to-sum operation is performed in a manner that a sum of products is calculated for an array in a depth of i (i=1, . . . , 7) of the first kernel and the array A¹ to obtain a sum of products for each “i”. The total sum of the product-to-sum obtained in this way is stored in a memory element of the array B¹. This product-to-sum operation is performed for each of the first to tenth kernels to complete the convolution process. In detail, a result of the convolution process using the second kernel is stored in the array B² and a result of the convolution process using the i-th (i=3, . . . , 10) kernel is stored in the array Bⁱ.

The process layer 500, for example, calculates one representative value from numerical values stored in memory elements of three rows and three columns, such as, a partial array configured with memory elements B¹ (5, 4) to B¹ (7, 6) shown by oblique lines and stores the representative value in the corresponding memory element C¹ (5, 4), shown by oblique lines, of the corresponding array of the storage device 300. As the representative value, a maximum value, an average value, etc. are used. The process layer 500 performs the same arithmetic operation to any memory elements of three rows and three columns in each array Bⁱ (i=1, . . . , 10) of the storage device 200 and stores a result of the arithmetic operation in the corresponding memory element of the corresponding array Cⁱ in the storage device 300.

As described above, the conventional arithmetic processing device includes a storage device, corresponding to each process layer, which stores all outputs of the process layer. Each process layer performs all processes and stores all its outputs in the above-described storage device. Thereafter, the next process layer performs a process using the numerical values stored in the above-described storage device. For this reason, it is preferable to have a storage device, per process layer, which has a capacity to store all outputs of each process layer. Because of this, a large occupied area in the chip is required and, as a result, there is a problem of causing increase in production cost.

Moreover, as shown in FIG. 2, in the case of using the numerical values stored in a storage device located outside the arithmetic processing device, which is an external storage device 600, for a plurality of processes, the conventional arithmetic processing device reads out the numerical values from the external storage device 600 for each process. FIG. 2 shows an example of a convolution process performed by a process layer 650 to the numerical values read out from the external storage device 600. In detail, the conventional arithmetic processing device repeats an operation by a necessary number of times to store a result, obtained by a convolution process to the numerical values read out from the external storage device 600, in an array D¹ of a storage device (internal storage device) 700 built in the arithmetic processing device, again store a result, obtained by the convolution process to the numerical values read out from the external storage device 600, in an array D² in the next depth of the internal storage device 700, and again store a result, obtained by the convolution process to the numerical values read out from the external storage device 600, in an array D³ in the next depth of the internal storage device 700.

As described above, in the case of using the numerical values stored in the external storage device for a plurality of processes, that is, by a plurality of number of times, the conventional arithmetic processing device reads out the numerical values for each process. Reading out the numerical values stored in the external storage device requires a longer readout time than reading out the numerical values stored in an internal storage device, and hence requires a long process time. This causes a problem of not achieving a high operation speed and hence of difficulty in application in use requiring a high operation speed, for example, in moving body recognition. Although it is possible to perform parallel processing with a lot of processors, it requires a large occupied area, causing a problem of increase in production cost.

In view of above, as a result of intensive search, the inventors have thought in the following way. For a process layer in which at least part of the next process can start as long as there is part of outputs of the process layer, a smaller number of storage devices than the number of the outputs may be provided as a storage device to store the outputs. Moreover, the inventors have thought in the following way. For a process layer to perform a plurality of processes using the numerical values of an external storage device, a storage device that temporarily stores the numerical values of the external storage device may be provided so that the numerical values can be read out from the temporal storage device in performing a process. Having the temporal storage device, it can be achieved to shorten a process time taken along the reading out of the numerical values of the external storage device, and hence shortening the total process time, which achieves a high operation speed.

An arithmetic processing device according to an embodiment includes: a first storage device including at least one first array having memory elements arranged in a first direction and a second direction intersecting with the first direction; a second storage device including at least one second array having memory elements arranged in the first direction; a third storage device including at least one third array having memory elements arranged in the first and second directions, the third array having a smaller number of memory elements arranged in the first direction than the memory elements of the first array, arranged in the first direction, and having a smaller number of memory elements arranged in the second direction than the memory elements of the first array, arranged in the second direction; and a first process layer, using data stored in the memory elements of the third array, to perform a convolution process to data stored in the memory elements of the first array, and to store a result of the convolution process in the memory elements of the second array.

Embodiments will now be explained with reference to the accompanying drawings. Although the numerical values shown in the drawings are arranged in a specific way of arrangement for explanation, how the numerical values are arranged is not important, they may be arranged in another way of arrangement. The present invention is not limited to the following embodiments, which can be used in a variety of modifications.

### First Embodiment

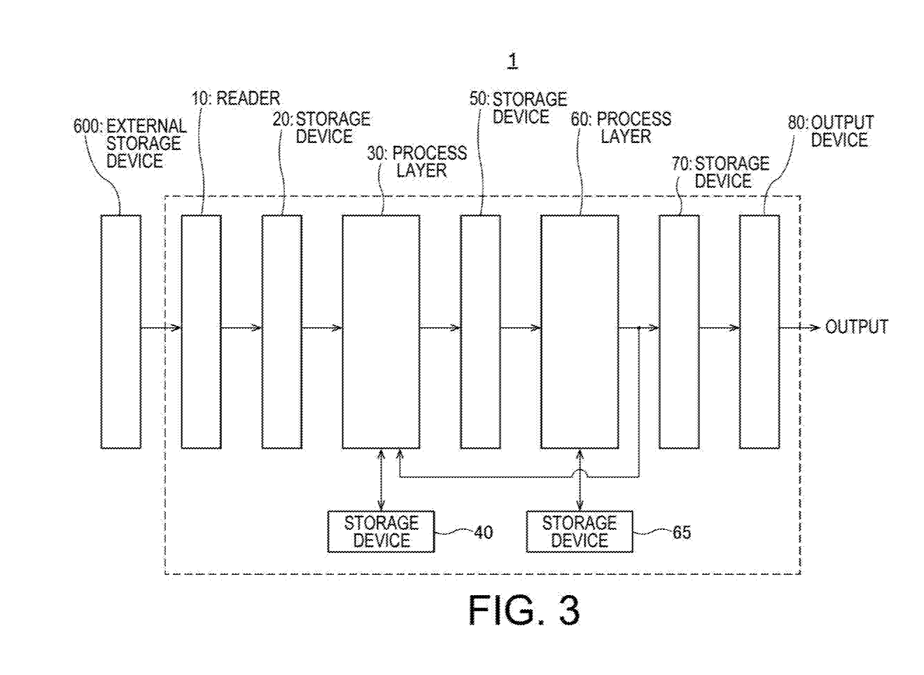

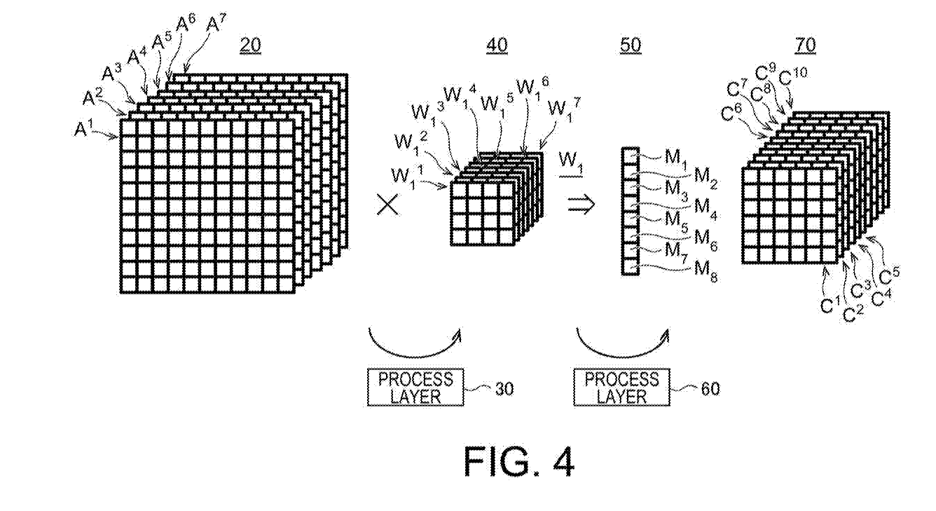

FIGS. 3 and 4 show an arithmetic processing device according to a first embodiment. As shown in FIG. 3, the arithmetic processing device 1 of the present embodiment realizes a convolutional neural network, includes a reader 10, a storage device 20, a process layer 30, a storage device 40, a storage device 50, a process layer 60, a storage device 65, a storage device 70, and an output device 80. The reader 10 reads out data from an external storage device 600 and stores the data in the storage device 20.

As shown in FIG. 4, the storage device 20 includes seven arrays A¹ to A⁷, each array Aⁱ (i=1, . . . , 7) including memory elements arranged in 11 rows and 11 columns. In other words, the storage device 20 includes a memory with a size of 11×11 and a depth of 7 in the in-plane direction in FIG. 4. A numerical value stored in a memory element of a j-th (j=1, . . . , 11) row and a k-th (k=1, . . . , 11) column in each array Aⁱ (i=1, . . . , 7) is expressed as Aⁱ (j, k).

As shown in FIG. 4, the storage device 40 stores first to tenth kernels W₁ to W₁₀ to be used for a convolution process. FIG. 4 only shows the first kernel W₁. Each i-th kernel Wᵢ (i=1, . . . , 10) includes first to seventh arrays Wᵢ¹ to Wᵢ⁷. Each array Wᵢ^{j} (i=1, . . . , 10, j=1, . . . , 7) includes memory elements arranged in four rows and four columns. In other words, the storage device 40 includes arrays Wᵢ^{j} (i=1, . . . , 10, j=1, . . . , 7) with a size of 4×4 in the in-plane direction in FIG. 4). Each array Wᵢ^{j} (i=1, . . . , 10, j=1, . . . , 7) includes memory elements arranged in four rows and four columns. In other words, the storage device 40 includes an array with a size of 4×4 and a depth of 7 in the in-plane direction in FIG. 4. A numerical value stored in a memory element of an m-th (m=1, . . . , 4) row and an n-th (n=1, . . . , 4) column in each array Wᵢ^{j} (i=1, . . . , 10, j=1, . . . , 7) is expressed as Wᵢ^{j}(m, n).

As shown in FIG. 4, the storage device 50 includes memory elements M₁ to M₈ arranged in eight rows and one column.

The storage device 65 stores kernels to be used for a convolution or pooling process.

As shown in FIG. 4, the storage device 70 includes 10 arrays C¹ to C¹⁰, each array Cⁱ (i=1, . . . , 10) including memory elements arranged in six rows and six columns. In other words, the storage device 70 includes a memory with a size of 6×6 and a depth of 10 in the in-plane direction in FIG. 4. A numerical value stored in a memory element of a j-th (j=1, . . . , 6) row and a k-th (k=1, . . . , 6) column in each array Cⁱ (i=1, . . . , 7) is expressed as Cⁱ (j, k).

The process layer 30 performs a convolution process between the kernels of the storage device 40 and the arrays of the storage device 20, and stores a result of process in the storage device 50. The process layer 60 performs a pooling process based on the data stored in the storage device 50 and stores a result of process in the storage device 70.

(First Convolution Process)

Subsequently, a first convolution process of the process layer 30 will be explained.

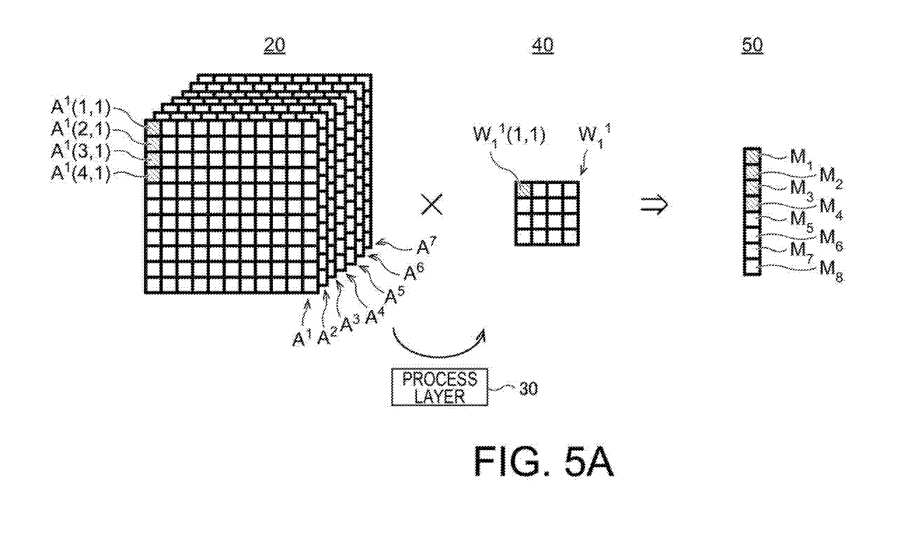

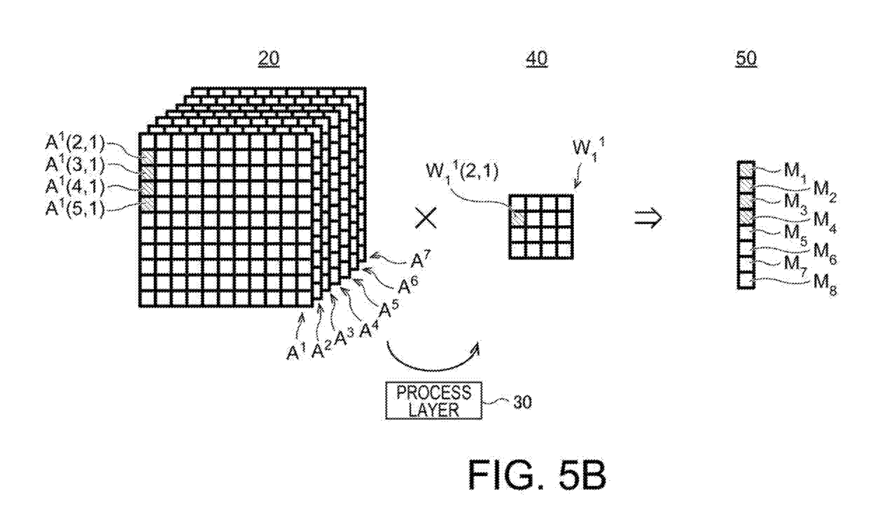

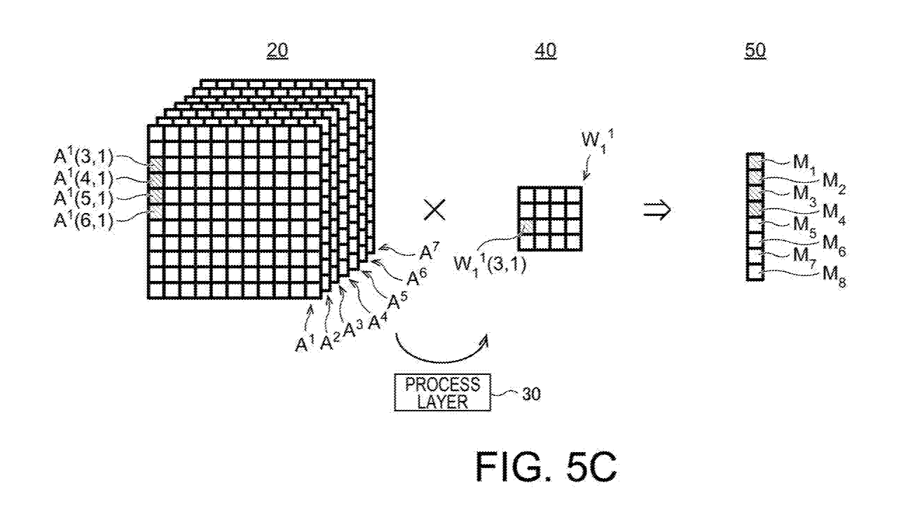

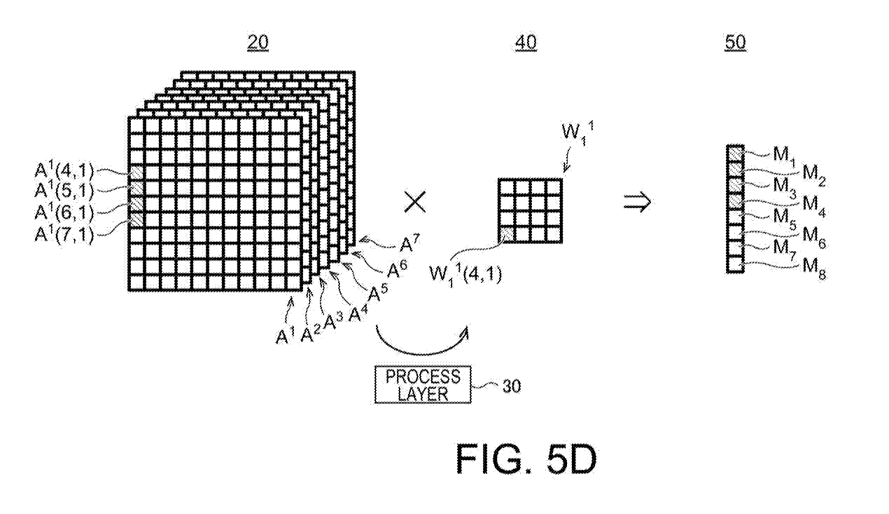

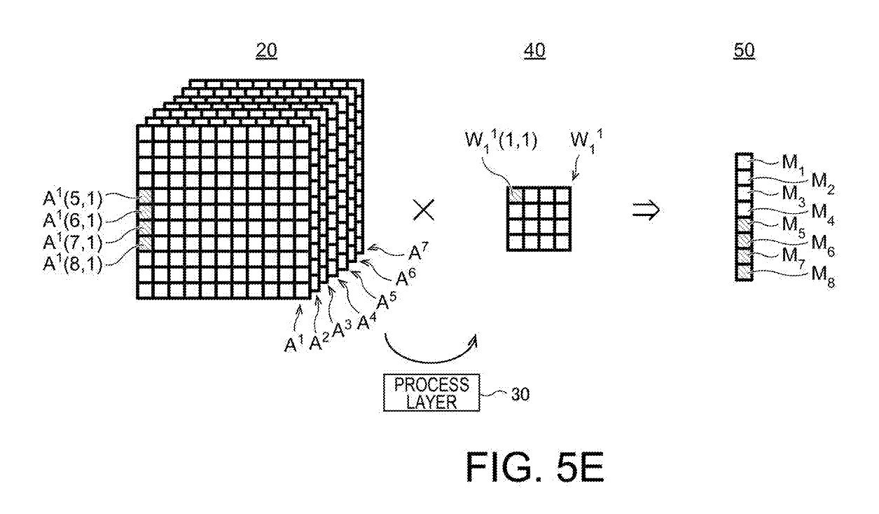

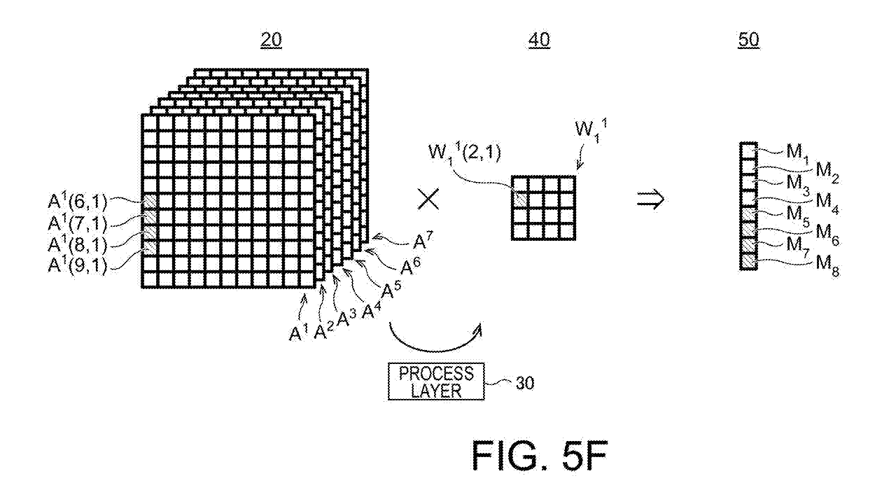

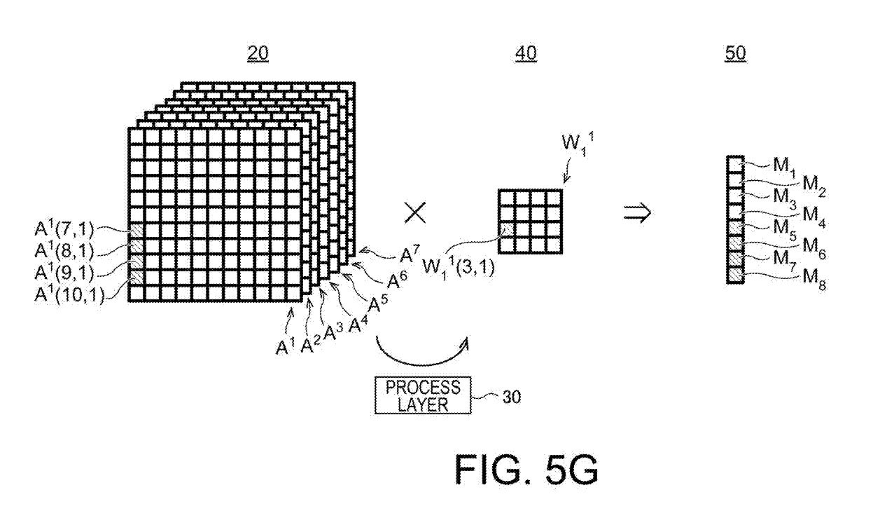

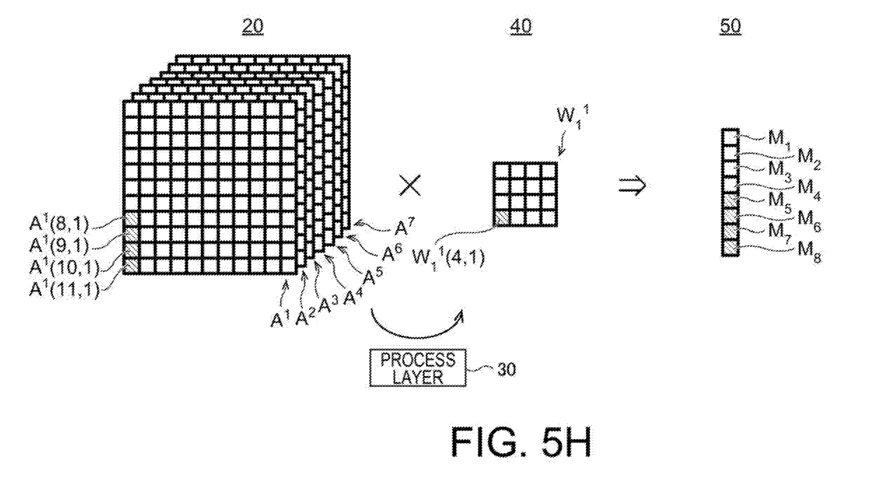

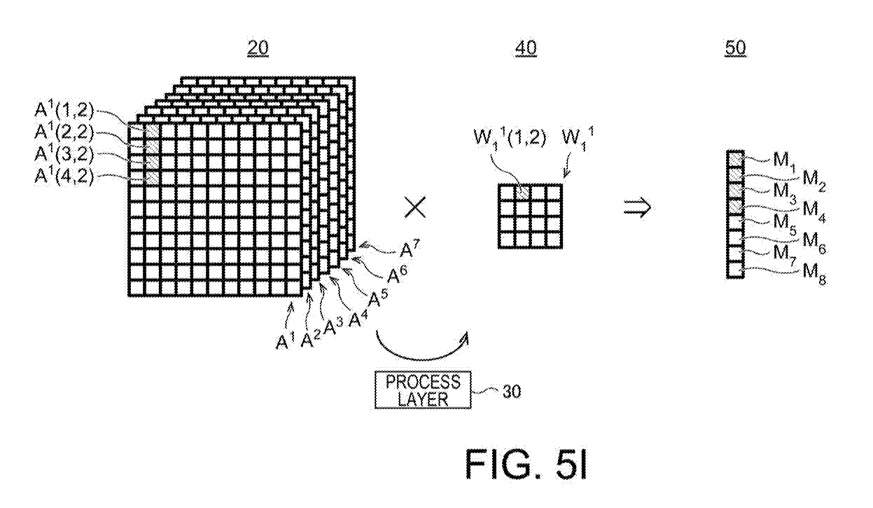

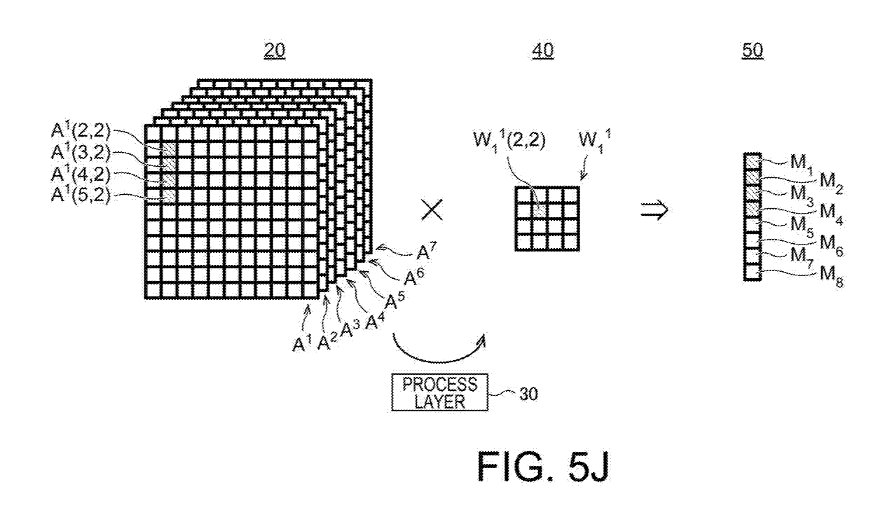

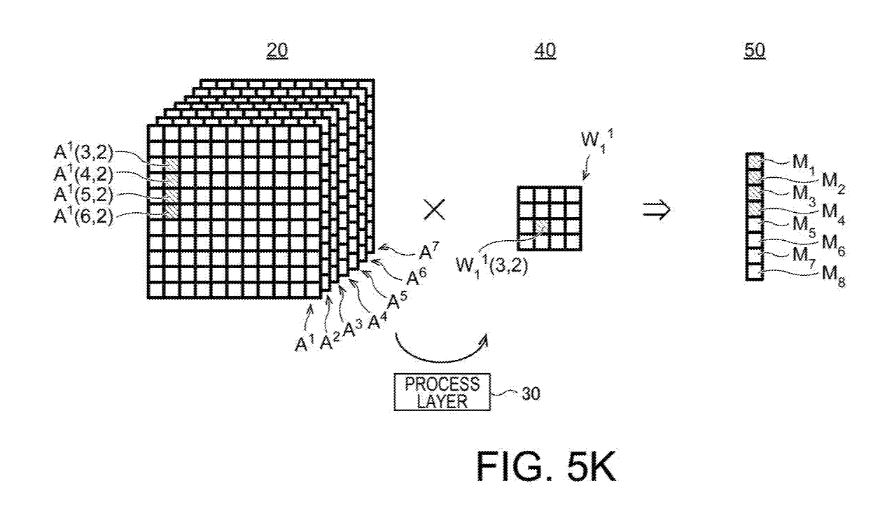

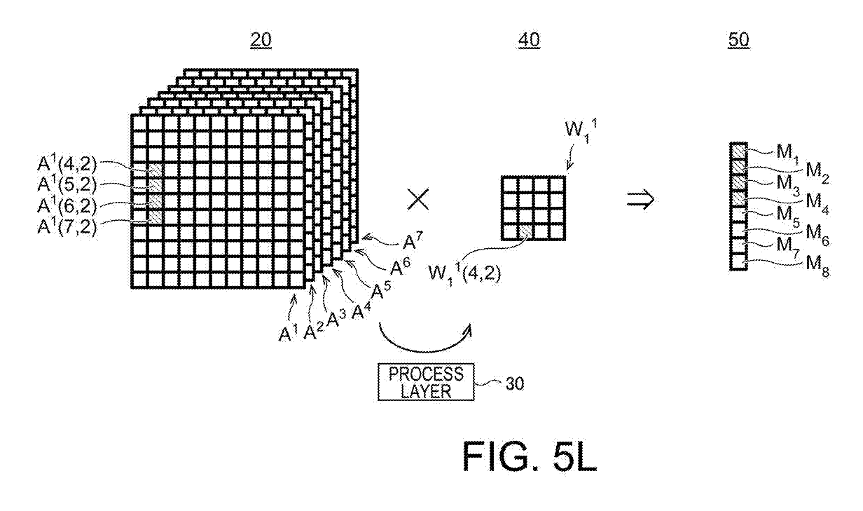

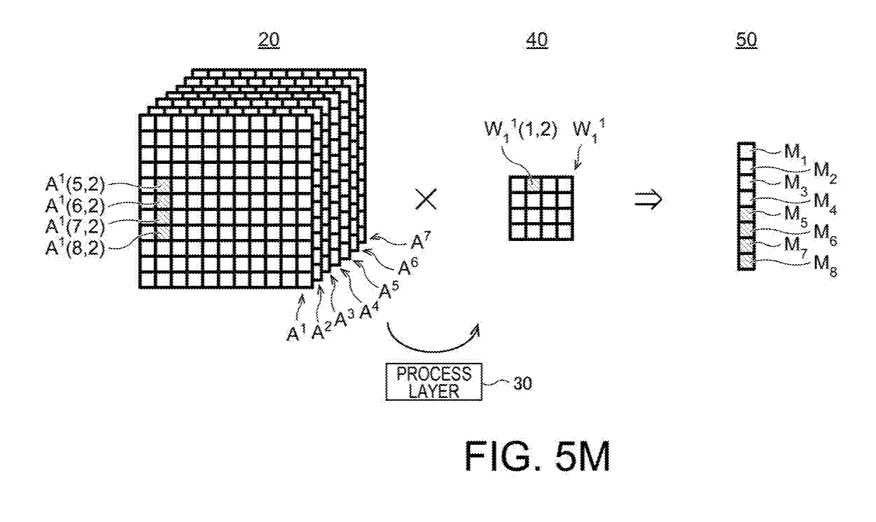

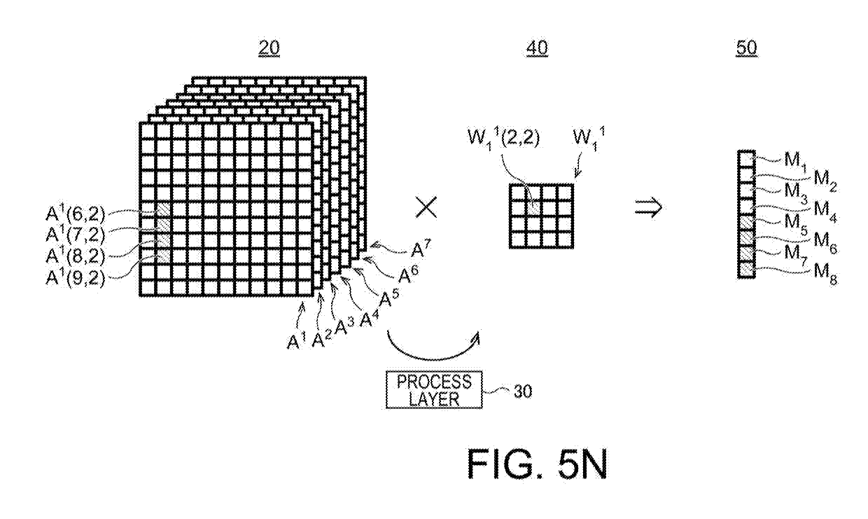

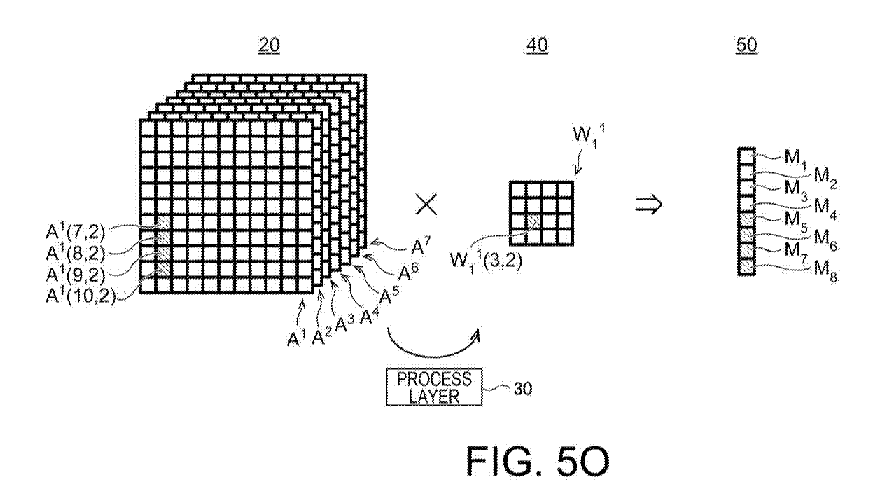

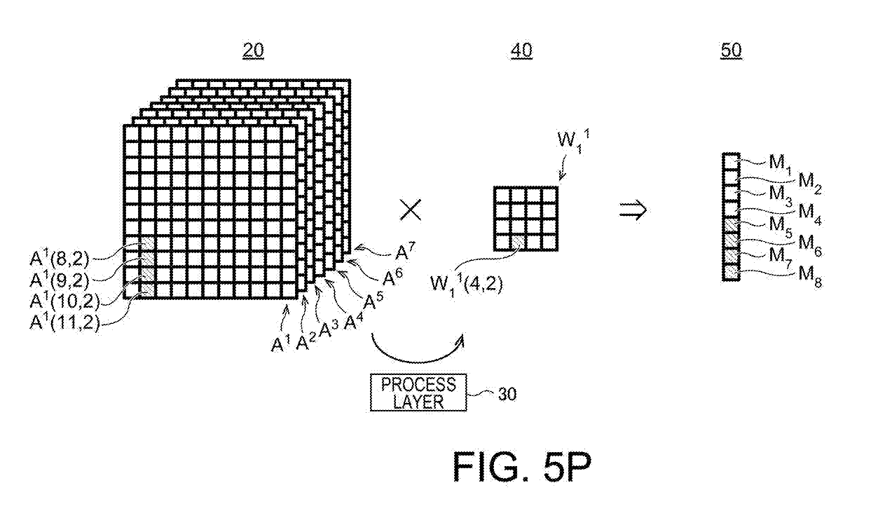

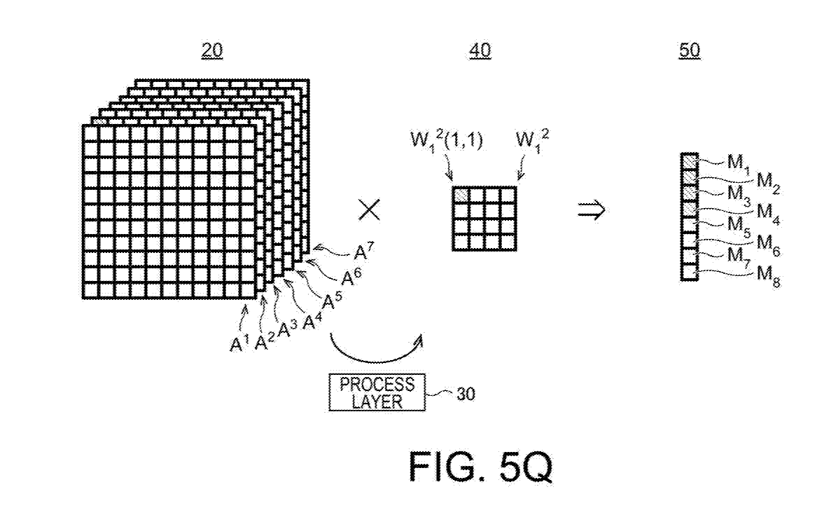

A convolution process using a first array W₁¹ of the first kernel W₁ of four rows and four columns with a depth of 7 stored in the storage device 40 to the first to fourth columns of the arrays A¹ to A⁷ of the storage device 20 will be explained with reference to FIGS. 5A to 5Q.

A convolution process using the first column of the array W₁¹ of the storage device 40 to the first column of the array A¹ of the storage device 20 will be explained with reference to FIGS. 5A to 5H.

As shown in FIG. 5A, a product of each of numerical values A¹ (1, 1) to A¹ (4, 1) shown by oblique lines stored in memory elements in the first column of the array A¹ of the storage device 20 and a numerical value W₁¹ (1, 1) shown by oblique lines stored in a memory element in the first row and first column of the array W₁¹ of the storage device 40 is calculated and results of arithmetic operation are stored in the memory elements M₁ to M₄ of the storage device 50. In detail, a product of W₁¹ (1, 1) and A¹ (1, 1) is calculated and this product is stored in the memory element M₁ of the storage device 50. Subsequently, a product of W₁¹ (1, 1) and A¹ (2, 1) is calculated and this product is stored in the memory element M₂ of the storage device 50. Subsequently, a product of W₁¹ (1, 1) and A¹ (3, 1) is calculated and this product is stored in the memory element M₃ of the storage device 50. Furthermore, a product of W₁¹ (1, 1) and A¹ (4, 1) is calculated and this product is stored in the memory element M₄ of the storage device 50. These arithmetic processes can be executed in parallel. The parallel arithmetic processing is advantageous in shortening the process time.

Subsequently, as shown in FIG. 5B, a product of each of numerical values A¹ (2, 1) to A¹ (5, 1) shown by oblique lines stored in memory elements in the first column of the array A¹ of the storage device 20 and a numerical value W₁¹ (2, 1) shown by oblique lines stored in a memory element in the second row and first column of the array W₁¹ of the storage device 40 is calculated, and sums of these products and the numerical values stored in the memory elements M₁ to M₄ of the storage device 50 are calculated, respectively, and newly stored in the memory elements M₁ to M₄, respectively. In detail, a product of W₁¹ (2, 1) and A¹ (2, 1) is calculated, and a sum of this product and the numerical value stored in the memory element M₁ of the storage device 50 is calculated and newly stored in the memory element M₁. Subsequently, a product of W₁¹ (2, 1) and A¹ (3, 1) is calculated, and a sum of this product and the numerical value stored in the memory element M₂ of the storage device 50 is calculated and newly stored in the memory element M₂. Subsequently, a product of W₁¹ (2, 1) and A¹ (4, 1) is calculated, and a sum of this product and the numerical value stored in the memory element M₃ of the storage device 50 is calculated and newly stored in the memory element M₃. Furthermore, a product of W₁¹ (2, 1) and A¹ (5, 1) is calculated, and a sum of this product and the numerical value stored in the memory element M₄ of the storage device 50 is calculated and newly stored in the memory element M₄. These arithmetic processes can be executed in parallel. The parallel arithmetic processing is advantageous in shortening the process time.

Subsequently, as shown in FIG. 5C, a product of each of numerical values A¹ (3, 1) to A¹ (6, 1) shown by oblique lines stored in memory elements in the first column of the array A¹ of the storage device 20 and a numerical value W₁¹ (3, 1) shown by oblique lines stored in a memory element in the third row and first column of the array W₁¹ of the storage device 40 is calculated, and sums of these products and the numerical values stored in the memory elements M₁ to M₄ of the storage device 50 are calculated, respectively, and newly stored in the memory elements M₁ to M₄, respectively. In detail, a product of W₁¹ (3, 1) and A¹ (3, 1) is calculated, and a sum of this product and the numerical value stored in the memory element M₁ of the storage device 50 is calculated and newly stored in the memory element M₁. Subsequently, a product of W₁¹ (3, 1) and A¹ (4, 1) is calculated, and a sum of this product and the numerical value stored in the memory element M₂ of the storage device 50 is calculated and newly stored in the memory element M₂. Subsequently, a product of W₁¹ (3, 1) and A¹ (5, 1) is calculated, and a sum of this product and the numerical value stored in the memory element M₃ of the storage device 50 is calculated and newly stored in the memory element M₃. Furthermore, a product of W₁¹ (3, 1) and A¹ (6, 1) is calculated, and a sum of this product and the numerical value stored in the memory element M₄ of the storage device 50 is calculated and newly stored in the memory element M₄. These arithmetic processes can be executed in parallel. The parallel arithmetic processing is advantageous in shortening the process time.

Subsequently, as shown in FIG. 5D, a product of each of numerical values A¹ (4, 1) to A¹ (7, 1) shown by oblique lines stored in memory elements in the first column of the array A¹ of the storage device 20 and a numerical value W₁¹ (4, 1) shown by oblique lines stored in a memory element in the fourth row and first column of the array W₁¹ of the storage device 40 is calculated, and sums of these products and the numerical values stored in the memory elements M₁ to M₄ of the storage device 50 are calculated, respectively, and newly stored in the memory elements M₁ to M₄, respectively. In detail, a product of W₁¹ (4, 1) and A¹ (4, 1) is calculated, and a sum of this product and the numerical value stored in the memory element M₁ of the storage device 50 is calculated and newly stored in the memory element M₁. Subsequently, a product of W₁¹ (4, 1) and A¹ (5, 1) is calculated, and a sum of this product and the numerical value stored in the memory element M₂ of the storage device 50 is calculated and newly stored in the memory element M₂. Subsequently, a product of W₁¹ (4, 1) and A¹ (6, 1) is calculated, and a sum of this product and the numerical value stored in the memory element M₃ of the storage device 50 is calculated and newly stored in the memory element M₃. Furthermore, a product of W₁¹ (4, 1) and A¹ (7, 1) is calculated, and a sum of this product and the numerical value stored in the memory element M₄ of the storage device 50 is calculated and newly stored in the memory element M₄. These arithmetic processes can be executed in parallel. The parallel arithmetic processing is advantageous in shortening the process time.

Subsequently, as shown in FIG. 5E, a product of each of numerical values A¹ (5, 1) to A¹ (8, 1) shown by oblique lines stored in memory elements in the first column of the array A¹ of the storage device 20 and the numerical value W₁¹ (1, 1) shown by oblique lines stored in the memory element in the first row and first column of the array W₁ of the storage device 40 is calculated and results of arithmetic operation are stored in the memory elements M₅ to M₈ of the storage device 50. In detail, a product of W₁¹ (1, 1) and A¹ (5, 1) is calculated and this product is stored in the memory element M₅ of the storage device 50. Subsequently, a product of W₁¹ (1, 1) and A¹ (6, 1) is calculated and this product is stored in the memory element M₆ of the storage device 50. Subsequently, a product of W₁¹ (1, 1) and A¹ (7, 1) is calculated and this product is stored in the memory element M₇ of the storage device 50. Furthermore, a product of W₁¹ (1, 1) and A¹ (8, 1) is calculated and this product is stored in the memory element Mg of the storage device 50. These arithmetic processes can be executed in parallel. The parallel arithmetic processing is advantageous in shortening the process time.

Subsequently, as shown in FIG. 5F, a product of each of numerical values A¹ (6, 1) to A¹ (9, 1) shown by oblique lines stored in memory elements in the first column of the array A¹ of the storage device 20 and the numerical value W₁¹ (2, 1) shown by oblique lines stored in the memory element in the second row and first column of the array W₁¹ of the storage device 40 is calculated, and sums of these products and the numerical values stored in the memory elements M₅ to M₈ of the storage device 50 are calculated, respectively, and newly stored in the memory elements M₅ to M₈, respectively. In detail, a product of W₁¹ (2, 1) and A¹ (6, 1) is calculated, and a sum of this product and the numerical value stored in the memory element M₅ of the storage device 50 is calculated and newly stored in the memory element M₅. Subsequently, a product of W₁¹ (2, 1) and A¹ (7, 1) is calculated, and a sum of this product and the numerical value stored in the memory element M₆ of the storage device 50 is calculated and newly stored in the memory element M₆. Subsequently, a product of W₁¹ (2, 1) and A¹ (8, 1) is calculated, and a sum of this product and the numerical value stored in the memory element M₇ of the storage device 50 is calculated and newly stored in the memory element M₇. Furthermore, a product of W₁¹ (2, 1) and A¹ (9, 1) is calculated, and a sum of this product and the numerical value stored in the memory element M₈ of the storage device 50 is calculated and newly stored in the memory element M₈. These arithmetic processes can be executed in parallel. The parallel arithmetic processing is advantageous in shortening the process time.

Subsequently, as shown in FIG. 5G, a product of each of numerical values A¹ (7, 1) to A¹ (10, 1) shown by oblique lines stored in memory elements in the first column of the array A¹ of the storage device 20 and the numerical value W₁¹ (3, 1) shown by oblique lines stored in the memory element in the third row and first column of the array W₁¹ of the storage device 40 is calculated, and sums of these products and the numerical values stored in the memory elements M₅ to M₈ of the storage device 50 are calculated, respectively, and newly stored in the memory elements M₅ to M₈, respectively. In detail, a product of W₁¹ (3, 1) and A¹ (7, 1) is calculated, and a sum of this product and the numerical value stored in the memory element M₅ of the storage device 50 is calculated and newly stored in the memory element M₅. Subsequently, a product of W₁¹ (3, 1) and A¹ (8, 1) is calculated, and a sum of this product and the numerical value stored in the memory element M₆ of the storage device 50 is calculated and newly stored in the memory element M₆. Subsequently, a product of W₁¹ (3, 1) and A¹ (9, 1) is calculated, and a sum of this product and the numerical value stored in the memory element M₇ of the storage device 50 is calculated and newly stored in the memory element M₇. Furthermore, a product of W₁¹ (3, 1) and A¹ (10, 1) is calculated, and a sum of this product and the numerical value stored in the memory element M₈ of the storage device 50 is calculated and newly stored in the memory element M₈. These arithmetic processes can be executed in parallel. The parallel arithmetic processing is advantageous in shortening the process time.

Subsequently, as shown in FIG. 5H, a product of each of numerical values A¹ (8, 1) to A¹ (11, 1) shown by oblique lines stored in memory elements in the first column of the array A¹ of the storage device 20 and the numerical value W₁¹ (4, 1) shown by oblique lines stored in the memory element in the fourth row and first column of the array W₁¹ of the storage device 40 is calculated, and sums of these products and the numerical values stored in the memory elements M₅ to M₈ of the storage device 50 are calculated, respectively, and newly stored in the memory elements M₅ to M₈, respectively. In detail, a product of W₁¹ (4, 1) and A¹ (8, 1) is calculated, and a sum of this product and the numerical value stored in the memory element M₅ of the storage device 50 is calculated and newly stored in the memory element M₅. Subsequently, a product of W₁¹ (4, 1) and A¹ (9, 1) is calculated, and a sum of this product and the numerical value stored in the memory element M₆ of the storage device 50 is calculated and newly stored in the memory element M₆. Subsequently, a product of W₁¹ (4, 1) and A¹ (10, 1) is calculated, and a sum of this product and the numerical value stored in the memory element M₇ of the storage device 50 is calculated and newly stored in the memory element M₇. Furthermore, a product of W₁¹ (4, 1) and A¹ (11, 1) is calculated, and a sum of this product and the numerical value stored in the memory element M₈ of the storage device 50 is calculated and newly stored in the memory element M₈. These arithmetic processes can be executed in parallel. The parallel arithmetic processing is advantageous in shortening the process time.

Subsequently, a convolution process using the second column of the array W₁¹ of the storage device 40 to the second column of the array A¹ of the storage device 20 will be explained with reference to FIGS. 5I to 5P.

First of all, as shown in FIG. 5I, a product of each of numerical values A¹ (1, 2) to A¹ (4, 2) shown by oblique lines stored in memory elements in the second column of the array A¹ of the storage device 20 and a numerical value W₁¹ (1, 2) shown by oblique lines stored in a memory element in the first row and second column of the array W₁¹ of the storage device 40 is calculated, and sums of these products and the numerical values stored in the memory elements M₁ to M₄ of the storage device 50 are calculated, respectively, and stored in the memory elements M₁ to M₄, respectively. In detail, a product of W₁¹ (1, 2) and A¹ (1, 2) is calculated, and a sum of this product and the numerical value stored in the memory element M₁ of the storage device 50 is calculated and stored in the memory element M₁. Subsequently, a product of W₁¹ (1, 2) and A¹ (2, 2) is calculated, and a sum of this product and the numerical value stored in the memory element M₂ of the storage device 50 is calculated and stored in the memory element M₂. Subsequently, a product of W₁¹ (1, 2) and A¹ (3, 2) is calculated, and a sum of this product and the numerical value stored in the memory element M₃ of the storage device 50 is calculated and stored in the memory element M₃. Furthermore, a product of W₁¹ (1, 2) and A¹ (4, 2) is calculated, and a sum of this product and the numerical value stored in the memory element M₄ of the storage device 50 is calculated and stored in the memory element M₄. These arithmetic processes can be executed in parallel. The parallel arithmetic processing is advantageous in shortening the process time.

Subsequently, as shown in FIG. 5J, a product of each of numerical values A¹ (2, 2) to A¹ (5, 2) shown by oblique lines stored in memory elements in the second column of the array A¹ of the storage device 20 and a numerical value W₁¹ (2, 2) shown by oblique lines stored in a memory element in the second row and second column of the array W₁¹ of the storage device 40 is calculated, and sums of these products and the numerical values stored in the memory elements M₁ to M₄ of the storage device 50 are calculated, respectively, and stored in the memory elements M₁ to M₄, respectively. In detail, a product of W₁¹ (2, 2) and A¹ (2, 2) is calculated, and a sum of this product and the numerical value stored in the memory element M₁ of the storage device 50 is calculated and stored in the memory element M₁. Subsequently, a product of W₁¹ (2, 2) and A¹ (3, 2) is calculated, and a sum of this product and the numerical value stored in the memory element M₂ of the storage device 50 is calculated and stored in the memory element M₂. Subsequently, a product of W₁¹ (2, 2) and A¹ (4, 2) is calculated, and a sum of this product and the numerical value stored in the memory element M₃ of the storage device 50 is calculated and stored in the memory element M₃. Furthermore, a product of W₁¹ (2, 2) and A¹ (5, 2) is calculated, and a sum of this product and the numerical value stored in the memory element M₄ of the storage device 50 is calculated and stored in the memory element M₄. These arithmetic processes can be executed in parallel. The parallel arithmetic processing is advantageous in shortening the process time.

Subsequently, as shown in FIG. 5K, a product of each of numerical values A¹ (3, 2) to A¹ (6, 2) shown by oblique lines stored in memory elements in the second column of the array A¹ of the storage device 20 and a numerical value W₁¹ (3, 2) shown by oblique lines stored in a memory element in the third row and second column of the array W₁¹ of the storage device 40 is calculated, and sums of these products and the numerical values stored in the memory elements M₁ to M₄ of the storage device 50 are calculated, respectively, and stored in the memory elements M₁ to M₄, respectively. In detail, a product of W₁¹ (3, 2) and A¹ (3, 2) is calculated, and a sum of this product and the numerical value stored in the memory element M₁ of the storage device 50 is calculated and stored in the memory element M₁. Subsequently, a product of W₁¹ (3, 2) and A¹ (4, 2) is calculated, and a sum of this product and the numerical value stored in the memory element M₂ of the storage device 50 is calculated and stored in the memory element M₂. Subsequently, a product of W₁¹ (3, 2) and A¹ (5, 2) is calculated, and a sum of this product and the numerical value stored in the memory element M₃ of the storage device 50 is calculated and stored in the memory element M₃. Furthermore, a product of W₁¹ (3, 2) and A¹ (6, 2) is calculated, and a sum of this product and the numerical value stored in the memory element M₄ of the storage device 50 is calculated and stored in the memory element M₄. These arithmetic processes can be executed in parallel. The parallel arithmetic processing is advantageous in shortening the process time.

Subsequently, as shown in FIG. 5L, a product of each of numerical values A¹ (4, 2) to A¹ (7, 2) shown by oblique lines stored in memory elements in the second column of the array A¹ of the storage device 20 and a numerical value W₁¹ (4, 2) shown by oblique lines stored in a memory element in the fourth row and second column of the array W₁¹ of the storage device 40 is calculated, and sums of these products and the numerical values stored in the memory elements M₁ to M₄ of the storage device 50 are calculated, respectively, and stored in the memory elements M₁ to M₄, respectively. In detail, a product of W₁¹ (4, 2) and A¹ (4, 2) is calculated, and a sum of this product and the numerical value stored in the memory element M₁ of the storage device 50 is calculated and stored in the memory element M₁. Subsequently, a product of W₁¹ (4, 2) and A¹ (5, 2) is calculated, and a sum of this product and the numerical value stored in the memory element M₂ of the storage device 50 is calculated and stored in the memory element M₂. Subsequently, a product of W₁¹ (4, 2) and A¹ (6, 2) is calculated, and a sum of this product and the numerical value stored in the memory element M₃ of the storage device 50 is calculated and stored in the memory element M₃. Furthermore, a product of W₁¹ (4, 2) and A¹ (7, 2) is calculated, and a sum of this product and the numerical value stored in the memory element M₄ of the storage device 50 is calculated and stored in the memory element M₄. These arithmetic processes can be executed in parallel. The parallel arithmetic processing is advantageous in shortening the process time.

Subsequently, as shown in FIG. 5M, a product of each of numerical values A¹ (5, 2) to A¹ (8, 2) shown by oblique lines stored in memory elements in the second column of the array A¹ of the storage device 20 and the numerical value W₁¹ (1, 2) shown by oblique lines stored in the memory element in the first row and second column of the array W₁¹ of the storage device 40 is calculated, and sums of these products and the numerical values stored in the memory elements M₅ to M₈ of the storage device 50 are calculated, respectively, and stored in the memory elements M₅ to M₈, respectively. In detail, a product of W₁¹ (1, 2) and A¹ (5, 2) is calculated, and a sum of this product and the numerical value stored in the memory element M₅ of the storage device 50 is calculated and stored in the memory element M₅. Subsequently, a product of W₁¹ (1, 2) and A¹ (6, 2) is calculated, and a sum of this product and the numerical value stored in the memory element M₆ of the storage device 50 is calculated and stored in the memory element M₆. Subsequently, a product of W₁¹ (1, 2) and A¹ (7, 2) is calculated, and a sum of this product and the numerical value stored in the memory element M₇ of the storage device 50 is calculated and stored in the memory element M₇. Furthermore, a product of W₁¹ (1, 2) and A¹ (8, 2) is calculated, and a sum of this product and the numerical value stored in the memory element M₈ of the storage device 50 is calculated and stored in the memory element M₈. These arithmetic processes can be executed in parallel. The parallel arithmetic processing is advantageous in shortening the process time.

Subsequently, as shown in FIG. 5N, a product of each of numerical values A¹ (6, 2) to A¹ (9, 2) shown by oblique lines stored in memory elements in the second column of the array A¹ of the storage device 20 and the numerical value W₁¹ (2, 2) shown by oblique lines stored in the memory element in the second row and second column of the array W₁¹ of the storage device 40 is calculated, and sums of these products and the numerical values stored in the memory elements M₅ to M₈ of the storage device 50 are calculated, respectively, and stored in the memory elements M₅ to M₈, respectively. In detail, a product of W₁¹ (2, 2) and A¹ (6, 2) is calculated, and a sum of this product and the numerical value stored in the memory element M₅ of the storage device 50 is calculated and stored in the memory element M₅. Subsequently, a product of W₁¹ (2, 2) and A¹ (7, 2) is calculated, and a sum of this product and the numerical value stored in the memory element M₆ of the storage device 50 is calculated and stored in the memory element M₆. Subsequently, a product of W₁¹ (2, 2) and A¹ (8, 2) is calculated, and a sum of this product and the numerical value stored in the memory element M₇ of the storage device 50 is calculated and stored in the memory element M₇. Furthermore, a product of W₁¹ (2, 2) and A¹ (9, 2) is calculated, and a sum of this product and the numerical value stored in the memory element M₈ of the storage device 50 is calculated and stored in the memory element M₈. These arithmetic processes can be executed in parallel. The parallel arithmetic processing is advantageous in shortening the process time.

Subsequently, as shown in FIG. 50, a product of each of numerical values A¹ (7, 2) to A¹ (10, 2) shown by oblique lines stored in memory elements in the second column of the array A¹ of the storage device 20 and the numerical value W₁¹ (3, 2) shown by oblique lines stored in the memory element in the third row and second column of the array W₁¹ of the storage device 40 is calculated, and sums of these products and the numerical values stored in the memory elements M₅ to M₈ of the storage device 50 are calculated, respectively, and stored in the memory elements M₅ to M₈, respectively. In detail, a product of W₁¹ (3, 2) and A¹ (7, 2) is calculated, and a sum of this product and the numerical value stored in the memory element M₅ of the storage device 50 is calculated and stored in the memory element M₅. Subsequently, a product of W₁¹ (3, 2) and A¹ (8, 2) is calculated, and a sum of this product and the numerical value stored in the memory element M₆ of the storage device 50 is calculated and stored in the memory element M₆. Subsequently, a product of W₁¹ (3, 2) and A¹ (9, 2) is calculated, and a sum of this product and the numerical value stored in the memory element M₇ of the storage device 50 is calculated and stored in the memory element M₇. Furthermore, a product of W₁¹ (3, 2) and A¹ (10, 2) is calculated, and a sum of this product and the numerical value stored in the memory element M₈ of the storage device 50 is calculated and stored in the memory element M₈. These arithmetic processes can be executed in parallel. The parallel arithmetic processing is advantageous in shortening the process time.

Subsequently, as shown in FIG. 5P, a product of each of numerical values A¹ (8, 2) to A¹ (11, 2) shown by oblique lines stored in memory elements in the second column of the array A¹ of the storage device 20 and the numerical value W₁¹ (4, 2) shown by oblique lines stored in the memory element in the fourth row and second column of the array W₁¹ of the storage device 40 is calculated, and sums of these products and the numerical values stored in the memory elements M₅ to M₈ of the storage device 50 are calculated, respectively, and stored in the memory elements M₅ to M₈, respectively. In detail, a product of W₁¹ (4, 2) and A¹ (8, 2) is calculated, and a sum of this product and the numerical value stored in the memory element M₅ of the storage device 50 is calculated and stored in the memory element M₅. Subsequently, a product of W₁¹ (4, 2) and A¹ (9, 2) is calculated, and a sum of this product and the numerical value stored in the memory element M₆ of the storage device 50 is calculated and stored in the memory element M₆. Subsequently, a product of W₁¹ (4, 2) and A¹ (10, 2) is calculated, and a sum of this product and the numerical value stored in the memory element M₇ of the storage device 50 is calculated and stored in the memory element M₇. Furthermore, a product of W₁¹ (4, 2) and A¹ (11, 2) is calculated, and a sum of this product and the numerical value stored in the memory element M₈ of the storage device 50 is calculated and stored in the memory element M₈. These arithmetic processes can be executed in parallel. The parallel arithmetic processing is advantageous in shortening the process time.

Subsequently, a convolution process using the third column of the array W₁¹ of the storage device 40 to the third column of the array A¹ of the storage device 20 is performed in the same manner as explained with reference to FIGS. 5I to 5P. In this case, for example, a product of each of numerical values A¹ (1, 3) to A¹ (4, 3) stored in memory elements in the third column of the array A¹ of the storage device 20 and a numerical value W₁¹ (1, 3) stored in a memory element in the first row and third column of the array W₁¹ of the storage device 40 is calculated, and sums of these products and the numerical values stored in the memory elements M₁ to M₄ of the storage device 50 are calculated, respectively, and stored in the memory elements M₁ to M₄, respectively. Moreover, for example, a product of each of numerical values A¹ (5, 3) to A¹ (8, 3) stored in memory elements in the third column of the array A¹ of the storage device 20 and the numerical value W₁¹ (1, 3) stored in the memory element in the first row and third column of the array W₁¹ of the storage device 40 is calculated, and sums of these products and the numerical values stored in the memory elements M₅ to M₈ of the storage device 50 are calculated, respectively, and stored in the memory elements M₅ to M₈, respectively.

Subsequently, a convolution process using the fourth column of the array W₁¹ of the storage device 40 to the fourth column of the array A¹ of the storage device 20 is performed in the same manner as explained with reference to FIGS. 5I to 5P. In this case, for example, a product of each of numerical values A¹ (1, 4) to A¹ (4, 4) stored in memory elements in the fourth column of the array A¹ of the storage device 20 and a numerical value W₁¹ (1, 4) stored in a memory element in the first row and fourth column of the array W₁¹ of the storage device 40 is calculated, and sums of these products and the numerical values stored in the memory elements M₁ to M₄ of the storage device 50 are calculated, respectively, and stored in the memory elements M₁ to M₄, respectively. Moreover, for example, a product of each of numerical values A¹ (5, 4) to A¹ (8, 4) stored in memory elements in the fourth column of the array A¹ of the storage device 20 and the numerical value W₁¹ (1, 4) stored in the memory element in the first row and fourth column of the array W₁¹ of the storage device 40 is calculated, and sums of these products and the numerical values stored in the memory elements M₅ to M₈ of the storage device 50 are calculated, respectively, and stored in the memory elements M₅ to M₈, respectively.

The processes described above are a convolution process using the array W₁¹ of the storage device 40 to the first to fourth columns of the array A¹ of the storage device 20.

Subsequently, a convolution process using the array W₁² of the storage device 40 to the first to fourth columns of the array A² of the storage device 20 will be explained.

First of all, a convolution process using the first column of the array W₁² of the storage device 40 to the first column of the array A² of the storage device 20 is performed in the same manner as explained with reference to FIGS. 5A to 5H. In this case, for example, as shown in FIG. 5Q, a product of each of numerical values A² (1, 1) to A² (4, 1) stored in memory elements in the first column of the array A² of the storage device 20 and a numerical value W₁² (1, 1) stored in a memory element in the first row and first column of the array W₁² of the storage device 40 is calculated, and sums of these products and the numerical values stored in the memory elements M₁ to M₄ of the storage device 50 are calculated, respectively, and stored in the memory elements M₁ to M₄, respectively. Moreover, for example, a product of each of numerical values A² (5, 1) to A² (8, 1) stored in memory elements in the first column of the array A² of the storage device 20 and the numerical value W₁² (1, 1) stored in the memory element in the first row and first column of the array W₁² of the storage device 40 is calculated, and sums of these products and the numerical values stored in the memory elements M₅ to M₈ of the storage device 50 are calculated, respectively, and stored in the memory elements M₅ to M₈, respectively.

Subsequently, a convolution process using the second column of the array W₁² of the storage device 40 to the second column of the array A² of the storage device 20 is performed in the same manner as explained with reference to FIGS. 5I to 5P. Thereafter, a convolution process using the third column of the array W₁² of the storage device 40 to the third column of the array A² of the storage device 20 is performed in the same manner as explained with reference to FIGS. 5I to 5P. Succeedingly, a convolution process using the fourth column of the array W₁² of the storage device 40 to the fourth column of the array A² of the storage device 20 is performed in the same manner as explained with reference to FIGS. 5I to 5P.

Subsequently, a convolution process using the array W₁³ of the storage device 40 to the first to fourth columns of the array A³ of the storage device 20 is performed in the same manner as the convolution process using the array W₁² of the storage device 40 to the first to fourth columns of the array A² of the storage device 20.

Subsequently, a convolution process using the array W₁⁴ of the storage device 40 to the first to fourth columns of the array A⁴ of the storage device 20 is performed in the same manner as the convolution process using the array W₁² of the storage device 40 to the first to fourth columns of the array A² of the storage device 20.

Subsequently, a convolution process using the array W₁⁵ of the storage device 40 to the first to fourth columns of the array A⁵ of the storage device 20 is performed in the same manner as the convolution process using the array W₁² of the storage device 40 to the first to fourth columns of the array A² of the storage device 20.

Subsequently, a convolution process using the array W₁⁶ of the storage device 40 to the first to fourth columns of the array A⁶ of the storage device 20 is performed in the same manner as the convolution process using the array W₁² of the storage device 40 to the first to fourth columns of the array A² of the storage device 20.

Subsequently, a convolution process using the array W₁⁷ of the storage device 40 to the first to fourth columns of the array A⁷ of the storage device 20 is performed in the same manner as the convolution process using the array W₁² of the storage device 40 to the first to fourth columns of the array A² of the storage device 20.

Succeedingly, the process layer 30 adds a bias B₁ to each numerical value stored in a memory element Mₖ (1≤k≤8), and applies an activation function process such as a rectified linear Unit (ReLU) function to the numerical value as required, and then newly stores the numerical value in the memory element Mₖ.

As described above, the first convolution process using the first kernel W₁ of four rows and four columns with a depth of 7 stored in the storage device 40 to the first to fourth columns of the arrays A¹ to A⁷ is complete.

(First Pooling Process)

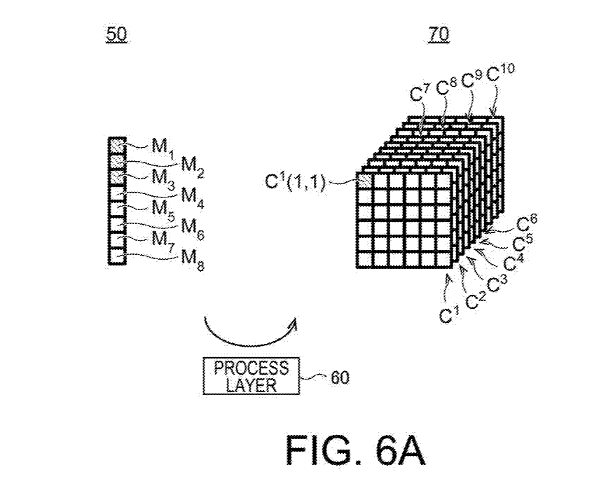

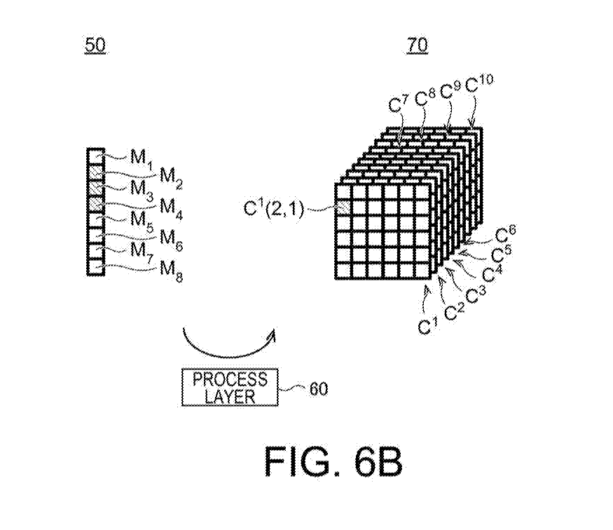

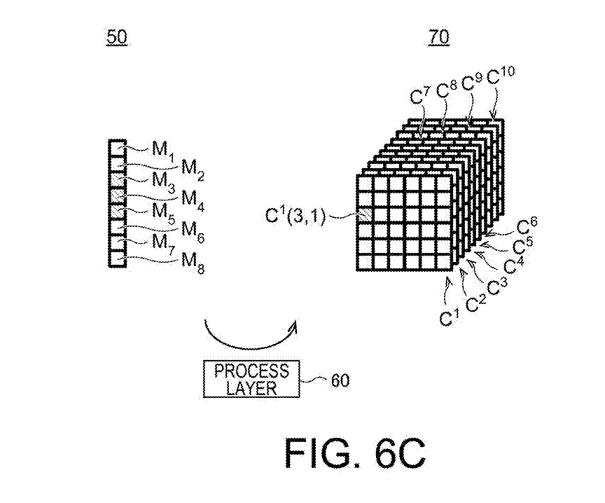

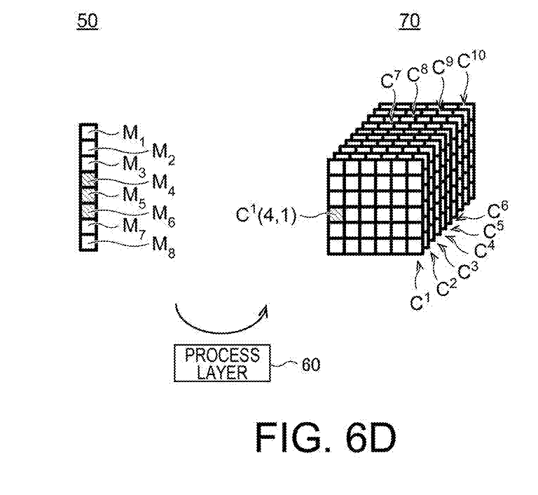

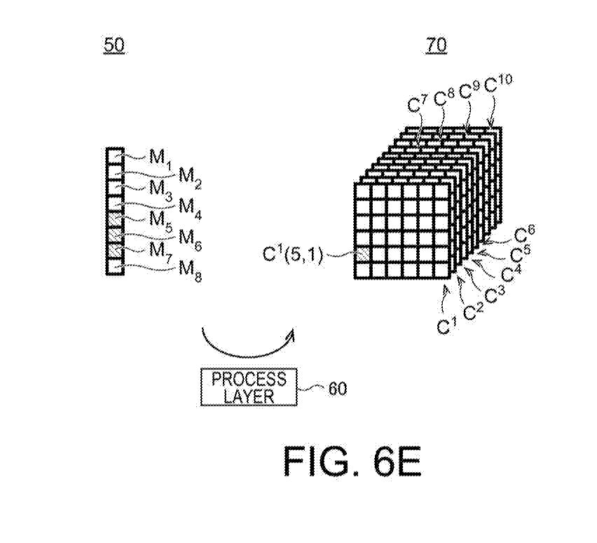

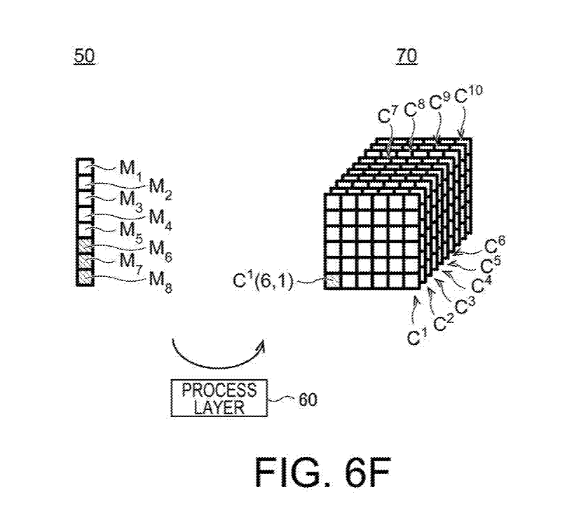

Subsequently, a first pooling process of the process layer 60 will be explained with reference to FIGS. 6A to 6F. The process layer 60, for example, performs a pooling process. The following pooling process is performed using the kernel of the array in three rows and three columns, in the same manner as explained with reference to FIG. 1. This kernel is prestored in the storage device 65.

First of all, as shown in FIG. 6A, the maximum value of the numerical values stored in the memory elements M₁, M₂ and M₃, shown by oblique lines, of the storage device 50 is stored as a representative value in a memory element C¹ (1, 1) of an array C¹ of the storage device 70. When an average value is used as the representative value in the pooling process, a sum of the numerical values stored in the memory elements M₁, M₂ and M₃ is calculated and stored in the memory element C¹ (1, 1), shown by oblique lines, of the array C¹.

Succeedingly, as shown in FIG. 6B, a representative value is calculated from the numerical values stored in the memory elements M₂, M₃ and M₄ shown by oblique lines, and this representative value is stored in a memory element C¹ (2, 1), shown by oblique lines, of the array C¹.

As shown in FIG. 6C, a representative value is calculated from the numerical values stored in the memory elements M₃, M₄ and M₅ shown by oblique lines, and this representative value is stored in a memory element C¹ (3, 1), shown by oblique lines, of the array C¹.

As shown in FIG. 6D, a representative value is calculated from the numerical values stored in the memory elements M₄, M₅ and M₆ shown by oblique lines, and this representative value is stored in a memory element C¹ (4, 1), shown by oblique lines, of the array C¹.

As shown in FIG. 6E, a representative value is calculated from the numerical values stored in the memory elements M₅, M₆ and M₇ shown by oblique lines, and this representative value is stored in a memory element C¹ (5, 1), shown by oblique lines, of the array C¹.

As shown in FIG. 6F, a representative value is calculated from the numerical values stored in the memory elements M₆, M₇ and M₈ shown by oblique lines, and this representative value is stored in a memory element C¹ (6, 1), shown by oblique lines, of the array C¹.

Through the processes described above, the first pooling process to data subjected to the convolution process using the kernel W of four rows and four columns with a depth of 7 stored in the storage device 40 to the first to fourth columns of the arrays A¹ to A⁷ of the storage device 20, is complete.

(Second Convolution Process)

Subsequently, a second convolution process using the kernel W₁ of four rows and four columns with a depth of 7 stored in the storage device 40 to the second to fifth columns of the arrays A¹ to A⁷ of the storage device 20 is performed in the same manner as the first convolution process from the process explained with reference to FIG. 5A to just before the first pooling process explained with reference to FIG. 6A.

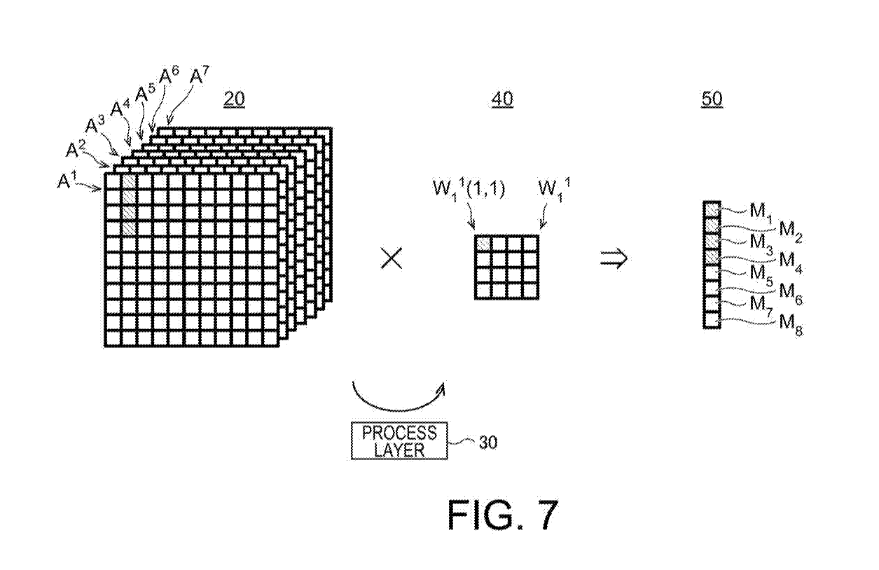

The second convolution process is performed by the process layer 30. For example, at first as shown in FIG. 7, a product of each of numerical values A¹ (1, 2) to A¹ (4, 2) shown by oblique lines stored in memory elements in the second column of the array A¹ of the storage device 20 and the numerical value W₁¹ (1, 1) shown by oblique lines stored in the memory element in the first row and first column of the array W₁¹ of the storage device 40 is calculated and results of arithmetic operation are stored in the memory elements M₁ to M₄ of the storage device 50. In detail, a product of W₁¹ (1, 1) and A¹ (1, 2) is calculated and this product is stored in the memory element M₁ of the storage device 50. Subsequently, a product of W₁¹ (1, 1) and A¹ (2, 2) is calculated and this product is stored in the memory element M₂ of the storage device 50. Subsequently, a product of W₁¹ (1, 1) and A¹ (3, 2) is calculated and this product is stored in the memory element M₃ of the storage device 50. Furthermore, a product of W₁¹ (1, 1) and A¹ (4, 2) is calculated and this product is stored in the memory element M₄ of the storage device 50. These arithmetic processes can be executed in parallel. The parallel arithmetic processing is advantageous in shortening the process time.

Hereinafter, processes in the same manner as the processes from the process explained with reference to FIG. 5B to just before the first pooling process explained with reference to FIG. 6A are performed to complete the convolution process using the first kernel W₁ of four rows and four columns with a depth of 7 stored in the storage device 40 to the second to fifth columns of the arrays A¹ to A⁷ of the storage device 20. Data for which the convolution process has been completed are stored in the memory elements M₁ to M₈ of the storage device 50.

Succeedingly, the process layer 30 adds the bias B₁ to each numerical value stored in the memory element Mₖ (1≤k≤8), and applies an activation function process such as a rectified linear Unit (ReLU) function to the numerical value as required, and then newly stores the numerical value in the memory element Mₖ.

(Second Pooling Process)

Subsequently, a second pooling process is performed to data for which the second convolution process related to the second to fifth columns of the arrays A¹ to A⁷ of the storage device 20 has been completed and which have been stored in the memory elements M₁ to M₈ of the storage device 50. The second pooling process is performed by the process layer 60.

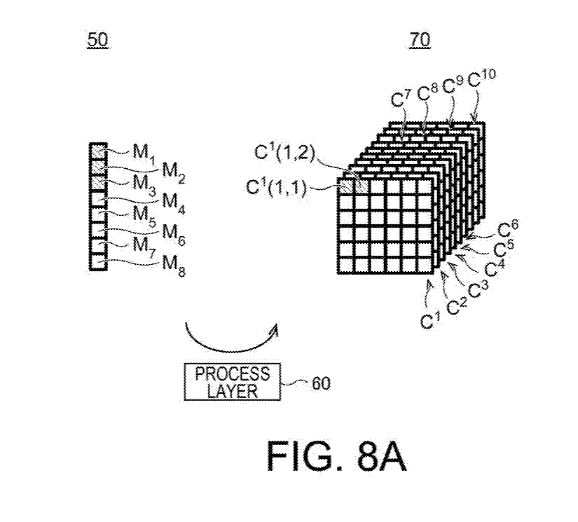

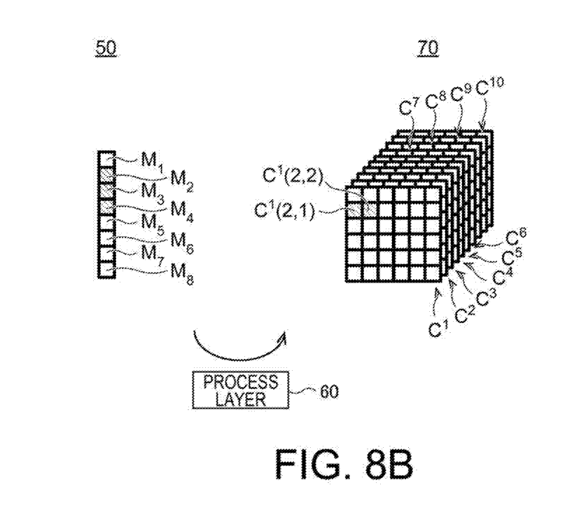

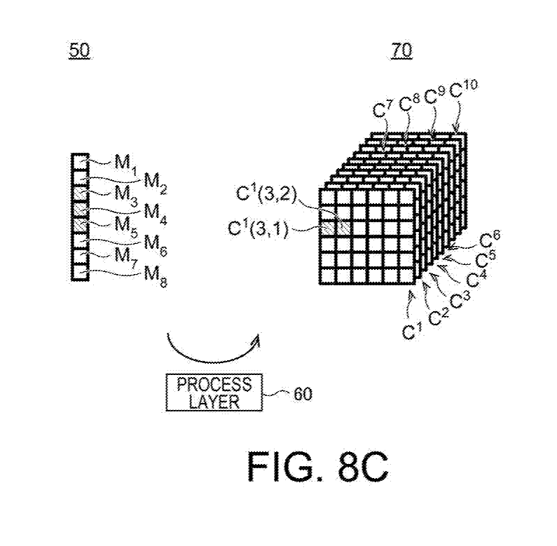

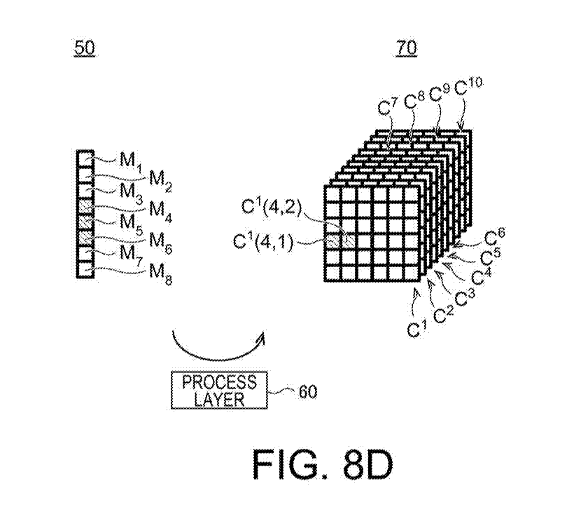

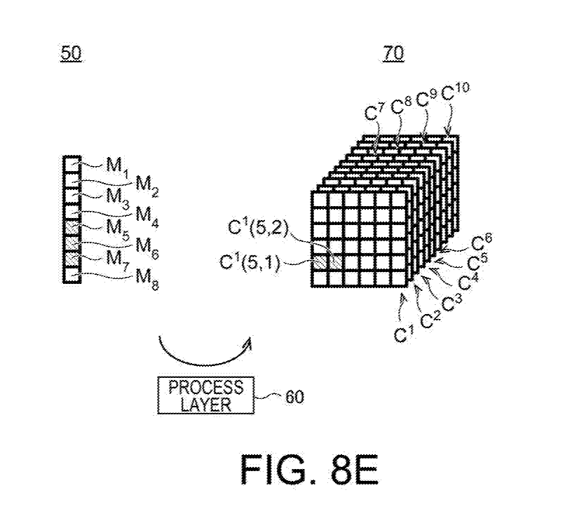

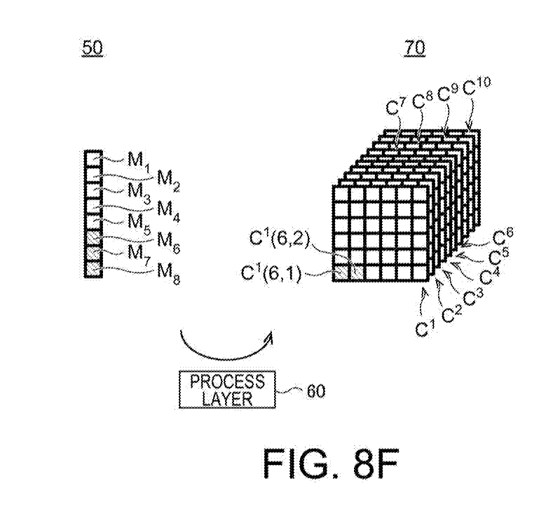

First of all, as shown in FIG. 8A, a representative value is calculated from the numerical values stored in the memory elements M₁, M₂ and M₃ of the storage device 50 and this representative value is stored in a memory element C¹ (1, 2), shown by oblique lines, of the array C¹ of the storage device 70. Thereafter, a representative value is calculated from the numerical values stored in the memory elements M₁, M₂ and M₃ of the storage device 50 and the numerical value stored in the memory element C¹ (1, 1) of the array C¹ of the storage device 70 and this representative value is newly stored in the memory element C¹ (1, 1). In this case, when an average value is used as the representative value, a sum of the numerical values stored in the memory elements M₁, M₂ and M₃, and the numerical value stored in the memory element C¹ (1, 1) is calculated and this sum is newly stored in the memory element C¹ (1, 1).

Thereafter, as shown in FIG. 8B, a representative value is calculated from the numerical values stored in the memory elements M₂, M₃ and M₄ of the storage device 50 and this representative value is stored in a memory element C¹ (2, 2), shown by oblique lines, of the array C¹ of the storage device 70. Thereafter, a representative value is calculated from the numerical values stored in the memory elements M₂, M₃ and M₄ of the storage device 50 and the numerical value stored in the memory element C¹ (2, 1) of the array C¹ and this representative value is newly stored in the memory element C¹ (2, 1) of the array C¹.

Succeedingly, as shown in FIG. 8C, a representative value is calculated from the numerical values stored in the memory elements M₃, M₄ and M₅ of the storage device 50 and this representative value is stored in a memory element C¹ (3, 2), shown by oblique lines, of the array C¹ of the storage device 70. Thereafter, a representative value is calculated from the numerical values stored in the memory elements M₃, M₄ and M₅ of the storage device 50 and the numerical value stored in the memory element C¹ (3, 1) of the array C¹ and this representative value is newly stored in the memory element C¹ (3, 1) of the array C¹.

Subsequently, as shown in FIG. 8D, a representative value is calculated from the numerical values stored in the memory elements M₄, M₅ and M₆ of the storage device 50 and this representative value is stored in a memory element C¹ (4, 2), shown by oblique lines, of the array C¹ of the storage device 70. Thereafter, a representative value is calculated from the numerical values stored in the memory elements M₄, M₅ and M₆ of the storage device 50 and the numerical value stored in the memory element C¹ (4, 1) of the array C¹ and this representative value is newly stored in the memory element C¹ (4, 1) of the array C¹.

Thereafter, as shown in FIG. 8E, a representative value is calculated from the numerical values stored in the memory elements M₅, M₆ and M₇ of the storage device 50 and this representative value is stored in a memory element C¹ (5, 2), shown by oblique lines, of the array C¹ of the storage device 70. Thereafter, a representative value is calculated from the numerical values stored in the memory elements M₅, M₆ and M₇ of the storage device 50 and the numerical value stored in the memory element C¹ (5, 1) of the array C¹ and this representative value is newly stored in the memory element C¹ (5, 1) of the array C¹.

Succeedingly, as shown in FIG. 8F, a representative value is calculated from the numerical values stored in the memory elements M₆, M₇ and M₈ of the storage device 50 and this representative value is stored in a memory element C¹ (6, 2), shown by oblique lines, of the array C¹ of the storage device 70. Thereafter, a representative value is calculated from the numerical values stored in the memory elements M₆, M₇ and M₈ of the storage device 50 and the numerical value stored in the memory element C¹ (6, 1) of the array C¹ and this representative value is newly stored in the memory element C¹ (6, 1) of the array C¹.

(Third Convolution Process)

Subsequently, the process layer 30 performs a third convolution process. The third convolution process is performed, in the same manner as the second convolution process, to the third to sixth columns of the arrays A¹ to A⁷ of the storage device 20, using the first kernel W₁ of four rows and four columns with a depth of 7 stored in the storage device 40. The third convolution process is performed by the process layer 30. Data for which the third convolution process has completed are stored in the memory elements M₁ to M₈ of the storage device 50.

Succeedingly, the process layer 30 adds the bias B₁ to each numerical value stored in the memory element Mₖ (1≤k≤8), and applies an activation function process such as a rectified linear Unit (ReLU) function to the numerical value as required, and then newly stores the numerical value in the memory element Mₖ.

(Third Pooling Process)

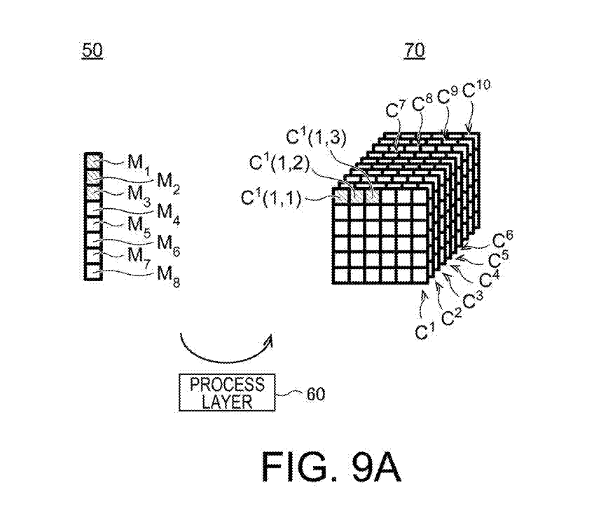

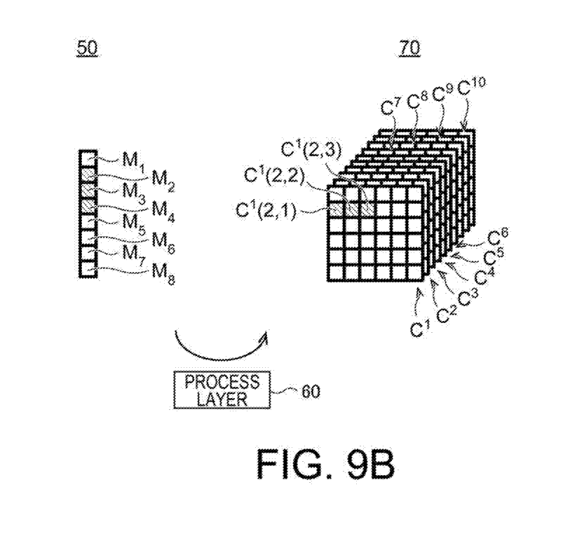

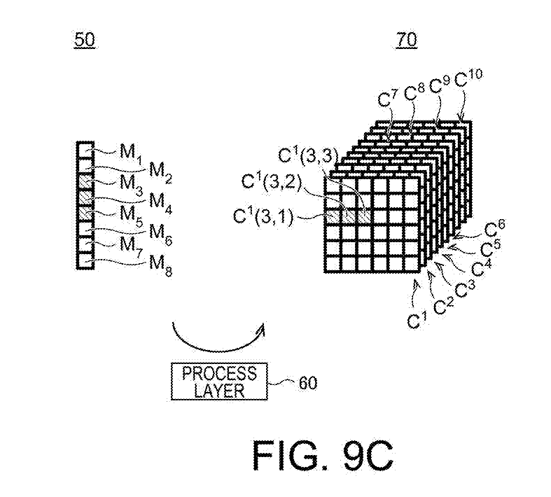

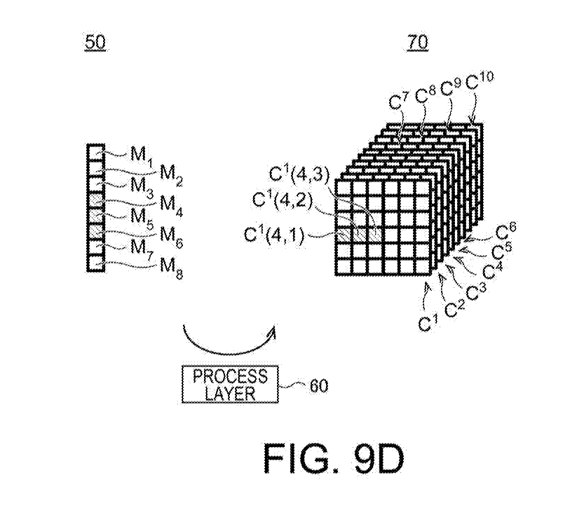

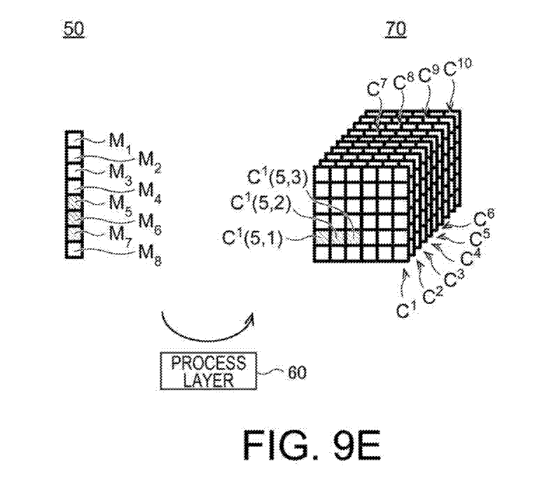

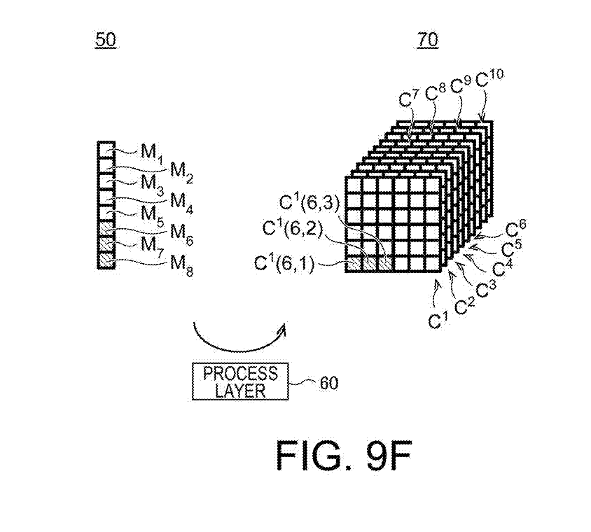

Subsequently, a third pooling process to be performed by the process layer 60 will be explained with reference to FIGS. 9A to 9F. The third pooling process is performed to data for which the third convolution process has been completed and which have been stored in the memory elements M₁ to M₈ of the storage device 50.

First of all, as shown in FIG. 9A, a representative value is calculated from the numerical values stored in the memory elements M₁, M₂ and M₃ of the storage device 50, and this representative value is stored in a memory element C¹ (1, 3), shown by oblique lines, of the array C¹ of the storage device 70. Succeedingly, a representative value is calculated from the numerical values stored in the memory elements M₁, M₂ and M₃, and a numerical value stored in the memory element C¹ (1, 2) of the array C¹ of the storage device 70, and this representative value is newly stored in the memory element C¹ (1, 2) of the array C¹. Thereafter, a representative value is calculated from the numerical values stored in the memory elements M₁, M₂ and M₃, and a numerical values stored in the memory element C¹ (1, 1) of the array C¹ of the storage device 70, and this representative value is newly stored in the memory element C¹ (1, 1) of the array C¹. In this way, a representative value obtained from the representative values calculated from the numerical values stored in the memory elements M₁, M₂ and M₃ by the first to third convolution processes, respectively, is stored in the memory element C¹ (1, 1). In detail, a representative value, calculated from a first representative value calculated from the numerical values stored in the memory elements M₁, M₂ and M₃ by the first convolution process, from a second representative value calculated from the numerical values stored in the memory elements M₁, M₂ and M₃ by the second convolution process, and from a third representative value calculated from the numerical values stored in the memory elements M₁, M₂ and M₃ by the third convolution process, is stored in the memory element C¹ (1, 1). Moreover, a representative value, obtained from the representative values calculated from the numerical values stored in the memory elements M₁, M₂ and M₃ by the second and third convolution processes, respectively, is stored in the memory element C¹ (1, 2). In detail, a representative value, calculated from the second representative value calculated from the numerical values stored in the memory elements M₁, M₂ and M₃ by the second convolution process, and from the third representative value calculated from the numerical values stored in the memory elements M₁, M₂ and M₃ by the third convolution process, is stored in the memory element C¹ (1, 2).

Succeedingly, as shown in FIG. 9B, a representative value is calculated from the numerical values stored in the memory elements M₂, M₃ and M₄ of the storage device 50, and this representative value is stored in a memory element C¹ (2, 3), shown by oblique lines, of the array C¹ of the storage device 70. Succeedingly, a representative value is calculated from the numerical values stored in the memory elements M₂, M₃ and M₄, and the numerical value stored in the memory element C¹ (2, 2) of the array C¹ of the storage device 70, and this representative value is newly stored in the memory element C¹ (2, 2) of the array C¹. Thereafter, a representative value is calculated from the numerical values stored in the memory elements M₂, M₃ and M₄, and the numerical value stored in the memory element C¹ (2, 1) of the array C¹ of the storage device 70, and this representative value is newly stored in the memory element C¹ (2, 1) of the array C¹.

Thereafter, as shown in FIG. 9C, a representative value is calculated from the numerical values stored in the memory elements M₃, M₄ and M₅ of the storage device 50, and this representative value is stored in a memory element C¹ (3, 3), shown by oblique lines, of the array C¹. Succeedingly, a representative value is calculated from the numerical values stored in the memory elements M₃, M₄ and M₅, and the numerical value stored in the memory element C¹ (3, 2) of the array C¹ of the storage device 70, and this representative value is newly stored in the memory element C¹ (3, 2) of the array C¹. Thereafter, a representative value is calculated from the numerical values stored in the memory elements M₃, M₄ and M₅, and the numerical value stored in the memory element C¹ (3, 1) of the array C¹ of the storage device 70, and this representative value is newly stored in the memory element C¹ (3, 1) of the array C¹.

Subsequently, as shown in FIG. 9D, a representative value is calculated from the numerical values stored in the memory elements M₄, M₅ and M₆ of the storage device 50, and this representative value is stored in a memory element C¹ (4, 3), shown by oblique lines, of the array C¹. Succeedingly, a representative value is calculated from the numerical values stored in the memory elements M₄, M₅ and M₆, and the numerical value stored in the memory element C¹ (4, 2) of the array C¹ of the storage device 70, and this representative value is newly stored in the memory element C¹ (4, 2) of the array C¹. Thereafter, a representative value is calculated from the numerical values stored in the memory elements M₄, M₅ and M₆, and the numerical value stored in the memory element C¹ (4, 1) of the array C¹ of the storage device 70, and this representative value is newly stored in the memory element C¹ (4, 1) of the array C¹.

Succeedingly, as shown in FIG. 9E, a representative value is calculated from the numerical values stored in the memory elements M₅, M₆ and M₇ of the storage device 50, and this representative value is stored in a memory element C¹ (5, 3), shown by oblique lines, of the array C¹. Succeedingly, a representative value is calculated from the numerical values stored in the memory elements M₅, M₆ and M₇, and the numerical value stored in the memory element C¹ (5, 2) of the array C¹ of the storage device 70, and this representative value is newly stored in the memory element C¹ (5, 2) of the array C¹. Thereafter, a representative value is calculated from the numerical values stored in the memory elements M₅, M₆ and M₇, and the numerical value stored in the memory element C¹ (5, 1) of the array C¹ of the storage device 70, and this representative value is newly stored in the memory element C¹ (5, 1) of the array C¹.

Thereafter, as shown in FIG. 9F, a representative value is calculated from the numerical values stored in the memory elements M₆, M₇ and M₈ of the storage device 50, and this representative value is stored in a memory element C¹ (6, 3), shown by oblique lines, of the array C¹. Succeedingly, a representative value is calculated from the numerical values stored in the memory elements M₆, M₇ and M₈, and the numerical value stored in the memory element C¹ (6, 2) of the array C¹ of the storage device 70, and this representative value is newly stored in the memory element C¹ (6, 2). Thereafter, a representative value is calculated from the numerical values stored in the memory elements M₆, M₇ and M₈, and the numerical value stored in the memory element C¹ (6, 1) of the array C¹ of the storage device 70, and this representative value is newly stored in the memory element C¹ (6, 1) of the array C¹.

Through the processes described above, the third pooling process is complete. When the third pooling process is complete, the third representative value, calculated from data obtained by the third convolution process and stored in the storage device 50, is stored in the third column of the array C¹ of the storage device 70. Moreover, a new second representative value, calculated from the second representative value, which has been calculated from data obtained by the second convolution process, and also from the third representative value, is stored in the second column of the array C¹ of the storage device 70. The new second representative value is calculated from the second and third representative values in the same row. Furthermore, a new first representative value, calculated from the first representative value which has been calculated from data obtained by the first convolution process, from the second representative value which has been calculated from data obtained by the second convolution process, and also from the third representative value, is stored in the first column of the array C¹ of the storage device 70.

(Fourth Convolution Process)

Subsequently, the process layer 30 performs a fourth convolution process. The fourth convolution process is performed, in the same manner as the third convolution process, to the fourth to seventh columns of the arrays A¹ to A⁷ of the storage device 20, using the first kernel W₁ of four rows and four columns with a depth of 7 stored in the storage device 40. The fourth convolution process is performed by the process layer 30. Data for which the fourth convolution process has been completed are stored in the memory elements M₁ to M₈ of the storage device 50.

Suceedingly, the process layer 30 adds the bias B₁ to each numerical value stored in the memory element Mₖ (1≤k≤8), and applies an activation function process such as a rectified linear Unit (ReLU) function to the numerical value as required, and then newly stores the numerical value in the memory element Mₖ.

(Fourth Pooling Process)

Subsequently, the process layer 60 performs a fourth pooling process. The fourth pooling process is performed in the same manner as the above-described third pooling process. In the fourth pooling process, a fourth representative value, calculated from data obtained by the fourth convolution process and stored in the storage device 50, is stored in the fourth column of the array C¹ of the storage device 70. Moreover, a new third representative value, calculated from the third representative value which has been calculated from data obtained by the third convolution process, and also from the fourth representative value, is stored in the third column of the array C¹ of the storage device 70. Furthermore, a new second representative value, calculated from the second representative value which has been calculated from data obtained by the second convolution process, from the third representative value calculated from data obtained by the third convolution process, and also from the fourth representative value, is stored in the second column of the array C¹ of the storage device 70.

(Fifth Convolution Process)

Subsequently, the process layer 30 performs a fifth convolution process. The fifth convolution process is performed, in the same manner as the fourth convolution process, to the fifth to eighth columns of the arrays A¹ to A⁷ of the storage device 20, using the first kernel W₁ of four rows and four columns with a depth of 7 stored in the storage device 40. The fifth convolution process is performed by the process layer 30. Data for which the fifth convolution process has been completed are stored in the memory elements M₁ to M₈ of the storage device 50.

Succeedingly, the process layer 30 adds the bias B₁ to each numerical value stored in the memory element Mₖ (1≤k≤8), and applies an activation function process such as a rectified linear Unit (ReLU) function to the numerical value as required, and then newly stores the numerical value in the memory element Mₖ.

(Fifth Pooling Process)

Subsequently, the process layer 60 performs a fifth pooling process. The fifth pooling process is performed in the same manner as the above-described fourth pooling process. In the fifth pooling process, a fifth representative value, calculated from data obtained by the fifth convolution process and stored in the storage device 50, is stored in the fifth column of the array C¹ of the storage device 70. Moreover, a new fourth representative value, calculated from the fourth representative value which has been calculated from data obtained by the fourth convolution process, and also from the fifth representative value, is stored in the fourth column of the array C¹ of the storage device 70. Furthermore, a new third representative value, calculated from the third representative value which has been calculated from data obtained by the third convolution process, from the fourth representative value calculated from data obtained by the fourth convolution process, and also from the fifth representative value, is stored in the third column of the array C¹ of the storage device 70.

(Sixth Convolution Process)

Subsequently, the process layer 30 performs a sixth convolution process. The sixth convolution process is performed, in the same manner as the fifth convolution process, to the sixth to ninth columns of the arrays A¹ to A⁷ of the storage device 20, using the first kernel W₁ of four rows and four columns with a depth of 7 stored in the storage device 40. The sixth convolution process is performed by the process layer 30. Data for which the sixth convolution process has been completed are stored in the memory elements M₁ to M₈ of the storage device 50.

Succeedingly, the process layer 30 adds the bias B₁ to each numerical value stored in the memory element Mₖ (1≤k≤8), and applies an activation function process such as a rectified linear Unit (ReLU) function to the numerical value as required, and then newly stores the numerical value in the memory element Mₖ.

(Sixth Pooling Process)

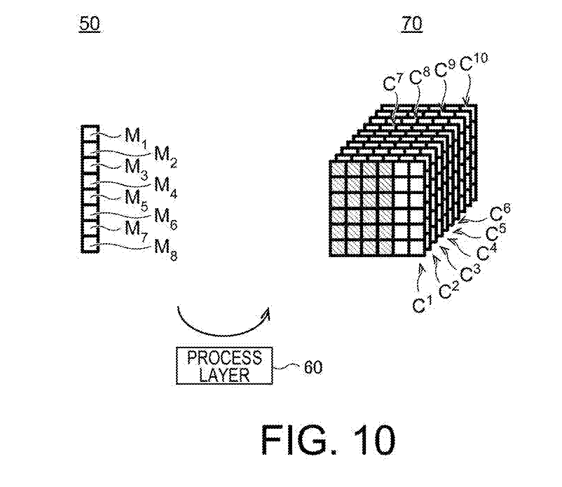

Subsequently, the process layer 60 performs a sixth pooling process. In the sixth pooling process, a sixth representative value, calculated from data obtained by the sixth convolution process and stored in the storage device 50, is stored in the sixth column of the array C¹ of the storage device 70. Moreover, a new fifth representative value, calculated from the fifth representative value which has been calculated from data obtained by the fifth convolution process, and also from the sixth representative value, is stored in the fifth column of the array C¹ of the storage device 70. Furthermore, a new fourth representative value, calculated from the fourth representative value which has been calculated from data obtained by the fourth convolution process, from the fifth representative value calculated from data obtained by the fifth convolution process, and also from the sixth representative value, is stored in the fourth column of the array C¹ of the storage device 70. The above state is shown in FIG. 10. FIG. 10 shows that the first to fourth columns, shown by oblique lines, of the array C1 are in a state where the pooling processes are all complete whereas the fifth and sixth columns are in a state where the pooling processes are not complete yet.

(Seventh Convolution Process)

Subsequently, the process layer 30 performs a seventh convolution process. The seventh convolution process is performed, in the same manner as the sixth convolution process, to the seventh to tenth columns of the arrays A¹ to A⁷ of the storage device 20, using the first kernel W₁ of four rows and four columns with a depth of 7 stored in the storage device 40. The seventh convolution process is performed by the process layer 30. Data for which the seventh convolution process has been completed are stored in the memory elements M₁ to M₈ of the storage device 50.

Succeedingly, the process layer 30 adds the bias B₁ to each numerical value stored in the memory element Mₖ (1≤k≤8), and applies an activation function process such as a rectified linear Unit (ReLU) function to the numerical value as required, and then newly stores the numerical value in the memory element Mₖ.

(Seventh Pooling Process)

Subsequently, the process layer 60 performs a seventh pooling process. The seventh pooling process is a little bit different from the sixth pooling process in order to save the capacity of the array C¹ of the storage device 70. In the seventh pooling process, a new seventh representative value, calculated from a seventh representative value obtained by the seventh convolution process, from the fifth representative value calculated from data obtained by the fifth convolution process, and also from the sixth representative value obtained by the sixth convolution process, is stored in the fifth column of the array C¹ of the storage device 70. Moreover, a new sixth representative value, calculated from the seventh representative value obtained by the seventh convolution process and from the sixth representative value obtained by the sixth convolution process, is stored in the sixth column of the array C¹ of the storage device 70. When the seventh pooling process is complete, in the storage device 70, the fifth column of the array C¹ is in a state where the pooling processes are all complete whereas the sixth column is in a state where the pooling processes are not complete yet.

(Eighth Convolution Process)

Subsequently, the process layer 30 performs an eighth convolution process. The eighth convolution process is performed, in the same manner as the seventh convolution process, to the eighth to eleventh columns of the arrays A¹ to A⁷ of the storage device 20, using the first kernel W₁ of four rows and four columns with a depth of 7 stored in the storage device 40. The eighth convolution process is performed by the process layer 30. Data for which the eighth convolution process has been completed are stored in the memory elements M₁ to M₈ of the storage device 50.

Succeedingly, the process layer 30 adds the bias B₁ to each numerical value stored in the memory element Mₖ (1≤k≤8), and applies an activation function process such as a rectified linear Unit (ReLU) function to the numerical value as required, and then newly stores the numerical value in the memory element Mₖ.

(Eighth Pooling Process)

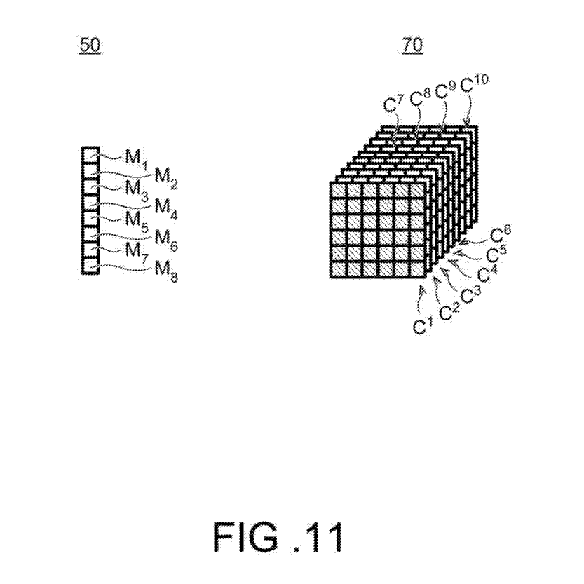

Subsequently, the process layer 60 performs an eighth pooling process. The eighth pooling process is a little bit different from the sixth pooling process, in order to save the capacity of the array C¹ of the storage device 70. In the eighth pooling process, a new sixth representative value, calculated from an eighth representative value obtained by the eighth convolution process, from the seventh representative value obtained by the seventh convolution process, and also from the sixth representative value calculated from data obtained by the sixth convolution process, is stored in the sixth column of the array C¹ of the storage device 70. Through the above processes, the sixth column of the array C1 of the storage device 70 is in a state where the pooling processes are all complete. This state is shown in FIG. 11 in which the first to sixth columns of the array C¹ of the storage device 70 are shown by oblique lines. In the state where the eighth pooling process is complete, when a maximum value is used as the representative value, the convolution processes using the first kernel W₁ and the pooling processes are all complete. However, when an average value is used as the representative value, a value obtained by dividing the numerical value stored in each memory element of the array C¹ by the number of memory elements included in the kernel used for the pooling processes is newly stored in each memory element of the array C¹. In other words, in the present embodiment, since the kernel used for the pooling processes is the array in three rows and three columns, a value obtained by dividing the numerical value stored in each memory element of the array C¹ by nine is newly stored in each memory element of the array C¹.

Through the processes described above, the convolution processes using the first kernel W₁ to the arrays A¹ and A⁷, and the pooling processes following to the convolution processes are complete. The data for which the processes have been completed is stored in the array C¹ of the storage device 70. In the present embodiment, the process to add the bias B₁ to the numerical value stored in the memory element Mₖ (1≤k≤8) and the activation function process such as a rectified linear Unit (ReLU) function are performed just after the completion of each convolution process. However, these processes may be performed after the completion of the process shown in FIG. 11 in the case where the activation function process is the rectified linear Unit (ReLU) function and a maximum value is used as the representative value in the pooling processes.

Subsequently, convolution processes using an i-th kernel Wᵢ (i=2, . . . , 10) to the arrays A¹ to A⁷ and a pooling process following to each convolution process are performed in the same manner as the processes using the first kernel W₁. Data for which the above processes have been completed are stored in an array Cⁱ of the storage device 70. When the data are stored, each convolution process is complete, and before the pooling process corresponding to this convolution process is performed, the process layer 30 adds a bias Bᵢ (i=2, . . . , 10) to each numerical value stored in the memory element Mₖ (1≤k≤8), and applies an activation function process such as a rectified linear Unit (ReLU) function to the numerical value as required, and then newly stores the numerical value in the memory element Mₖ.

Through the processes described above, the convolution processes using the first to tenth kernels W₁ to W₁₀ to the arrays A¹ and A⁷, and the pooling process following to each of the convolution processes are complete, to realize a convolutional neural network. Accordingly, in the present embodiment, it is enough for the storage device 50 to have a memory element of eight rows and one column in capacity, and hence an arithmetic processing device of a small occupied area can be provided.

The convolution processes can be executed in parallel to shorten the process time.

The convolution processes using the first to tenth kernels W₁ to W₁₀ can be executed in parallel, with the storage device 50 of eight rows and ten columns in capacity, to shorten the process time.

As explained above, according to the first embodiment, the storage device 50 can have a smaller capacity than conventional ones, and hence an arithmetic processing device of a small occupied area can be provided.

### Second Embodiment

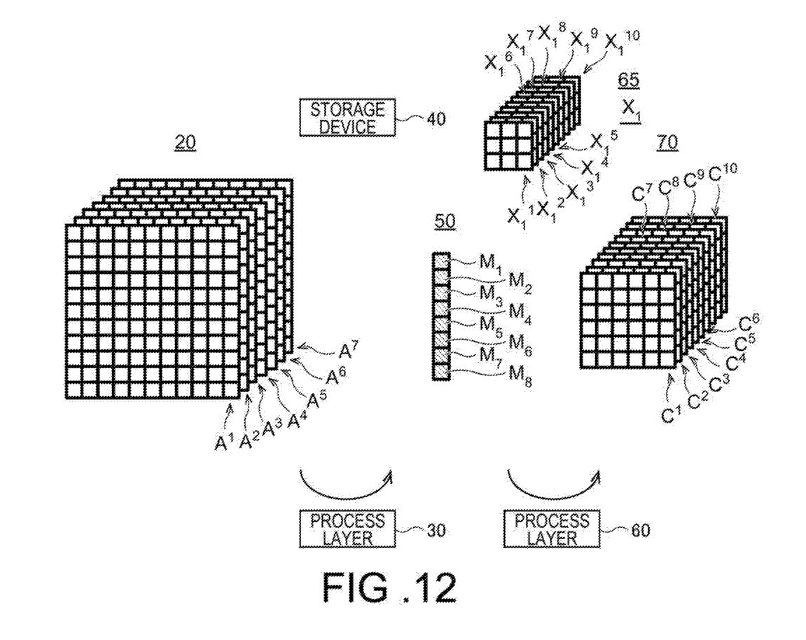

Subsequently, an arithmetic processing device according to a second embodiment will be explained with reference to FIGS. 12 to 14M. In the first embodiment, the process layer 60 performs the pooling process. The process to be performed by the process layer 60 is not limited to the pooling process, which may, for example, be the convolution process which gives the same effect as the pooling process. The second embodiment will be explained on condition that the process layer 60 performs the convolution process.

FIG. 12 shows the arithmetic processing device of the second embodiment. The arithmetic processing device of the second embodiment has the same configuration as that of the first embodiment except that the storage device 65 stores kernels to be used for the convolution process. In the arithmetic processing device of the second embodiment, the process layer 60 performs the convolution process using first to tenth kernels X₁ to X₁₀ stored in the storage device 65, as shown in FIG. 12, each kernel Xᵢ (i=1, . . . , 10) having ten arrays X₁¹ to X₁¹⁰ of three rows and three columns. FIG. 12 only shows the first kernel X₁. A memory element in an m-th (m=1, . . . , 3) row and an n-th (n=1, . . . , 3) column of an array Xᵢ^{j} (i=1, . . . , 10, j=1, . . . , 10) is expressed as Xᵢ^{j} (m, n), with a numerical value stored in this memory element also being expressed as Xᵢ^{j} (m, n).

Hereinafter, an operation of the arithmetic processing device of the second embodiment will be explained.

(First Convolution Process by Process Layer 30)

First of all, the process layer 30 performs the first convolution process explained in the first embodiment. In detail, the process layer 30 uses the first kernel W₁ stored in the storage device 40 shown in FIG. 4 to perform the convolution process to the first to fourth columns of the arrays A¹ to A⁷ stored in the storage device 20 and stores a result of process in the memory elements M₁ to M₈ of the storage device 50.

Succeedingly, the process layer 30 adds the bias B₁ to each numerical value stored in the memory element Mₖ (1≤k≤8), and applies an activation function process such as a rectified linear Unit (ReLU) function to the numerical value as required, and then newly stores the numerical value in the memory element Mₖ.

(First Convolution Process by Process Layer 60)

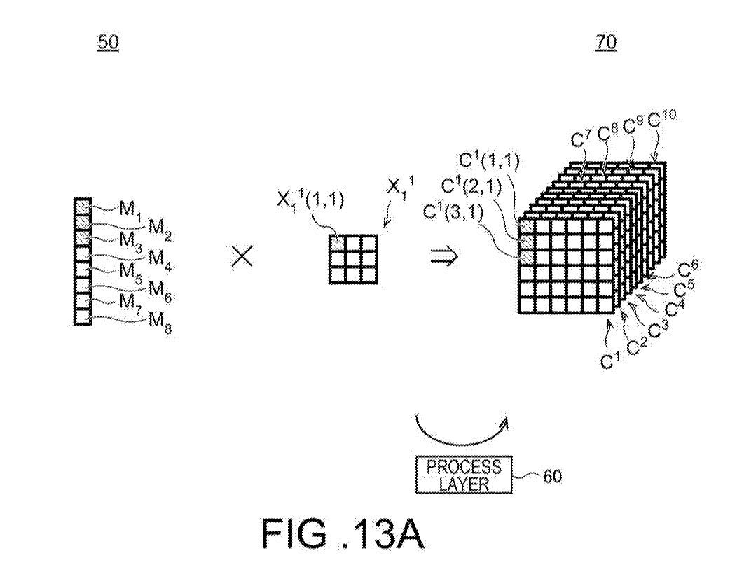

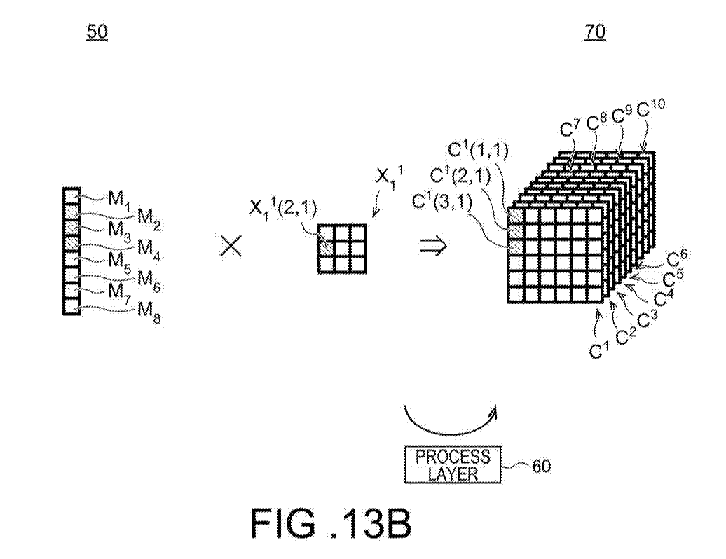

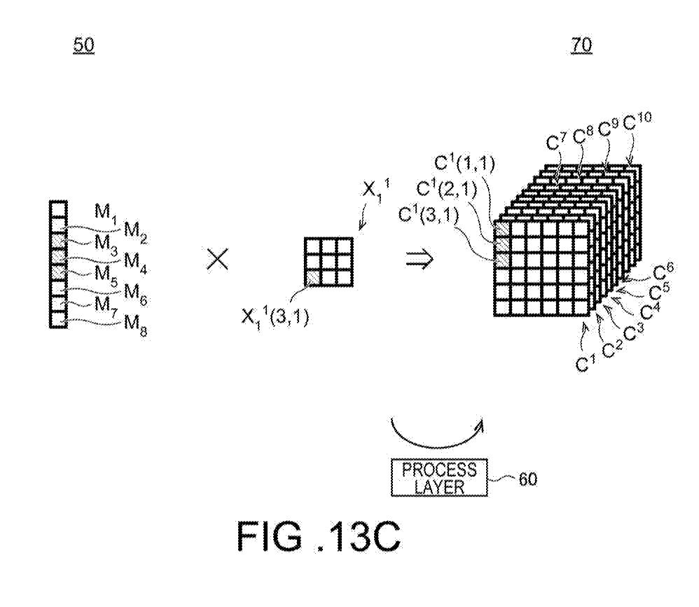

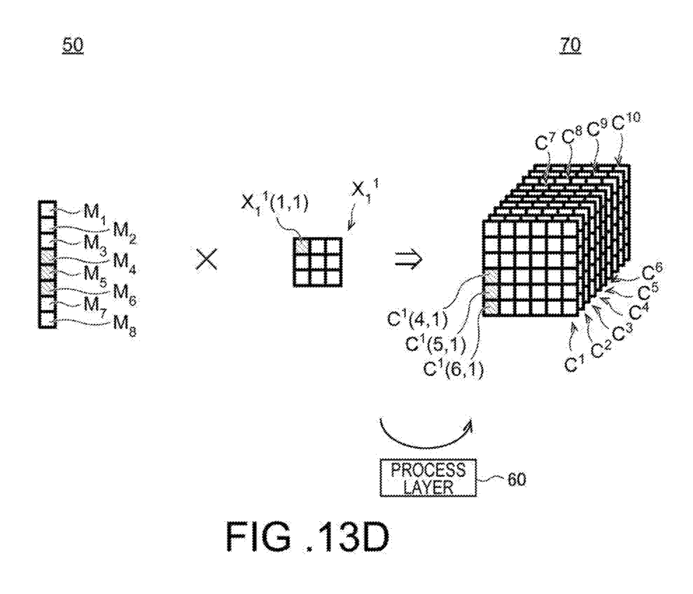

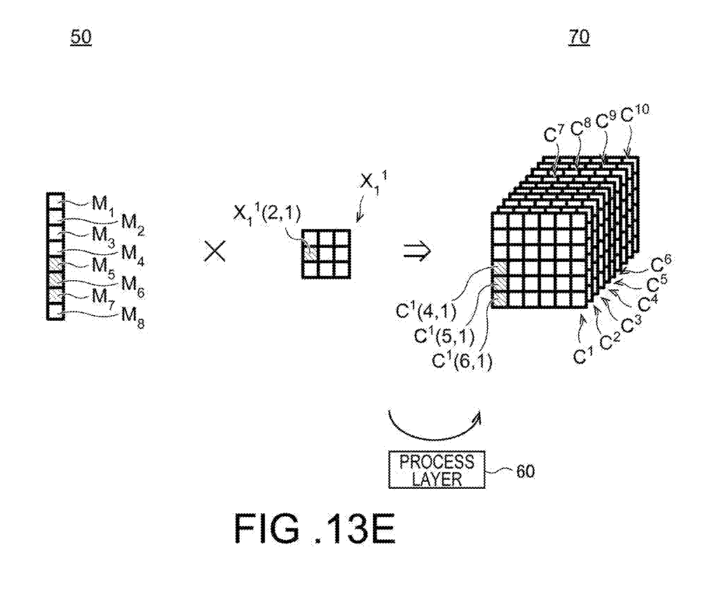

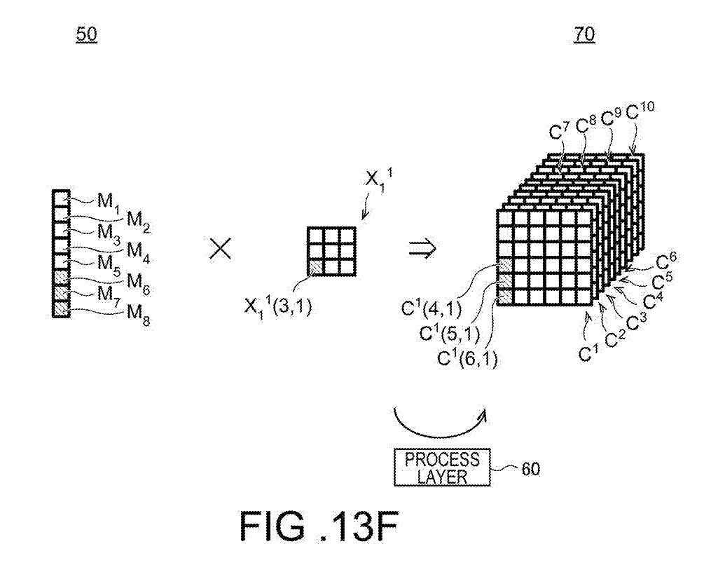

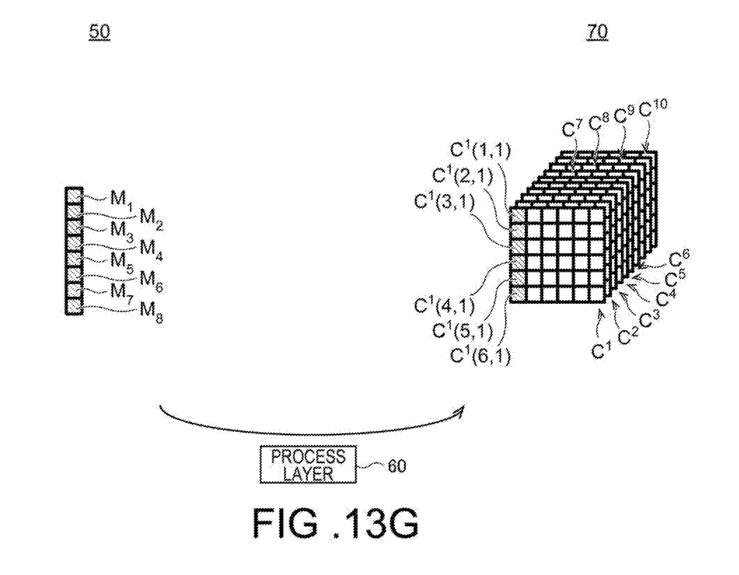

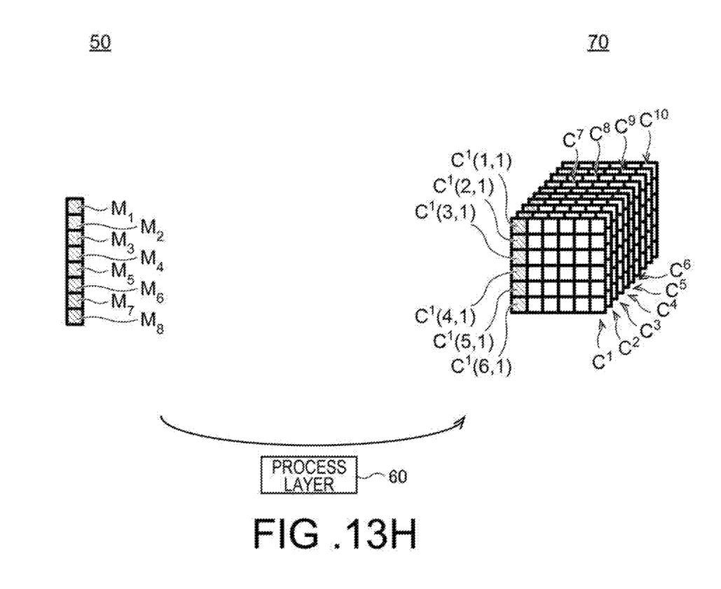

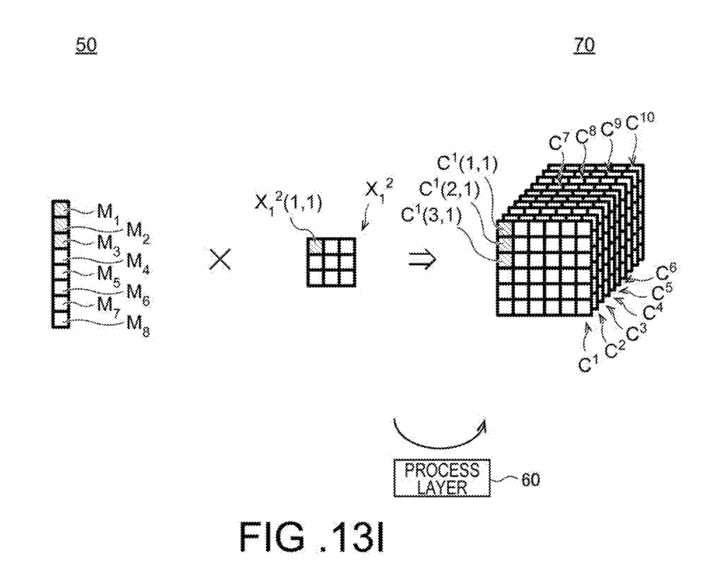

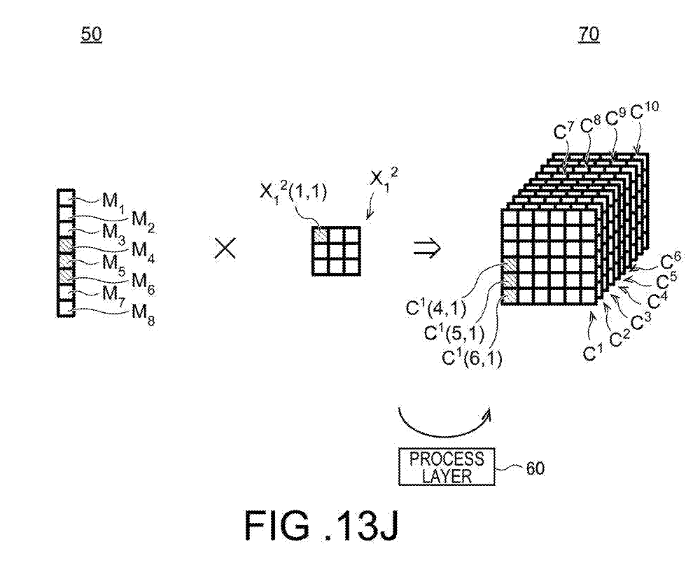

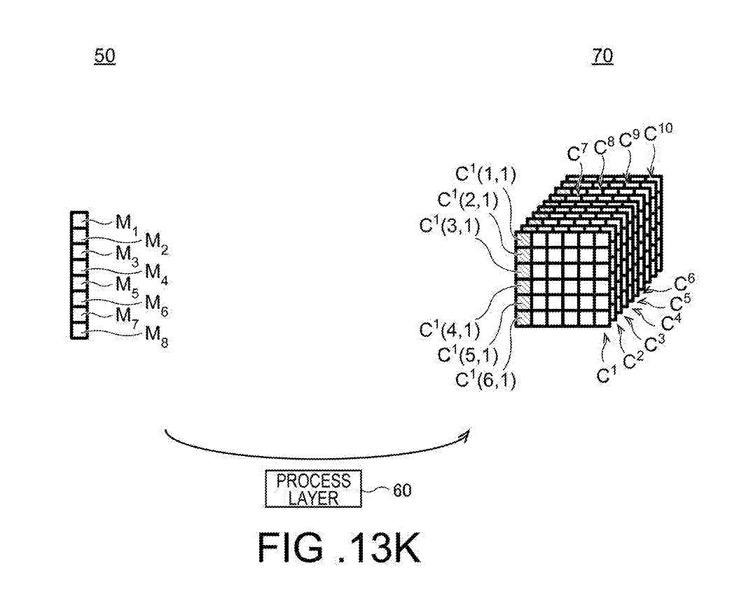

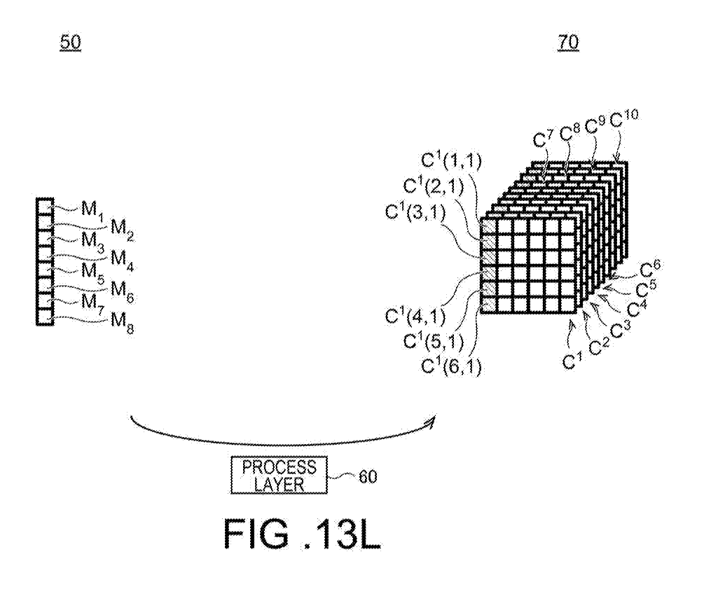

Subsequently, as shown in FIG. 13A, a product of a numerical value X₁¹ (1, 1) stored in a memory element in the first row and first column of the array X₁¹ of the first kernel X₁ and a numerical value stored in the memory element M₁ is stored in a memory element C¹ (1, 1) in the first row and first column of the array C¹ of the storage device 70. Succeedingly, a product of the numerical value X₁¹ (1, 1) and a numerical value stored in the memory element M₂ is stored in a memory element C¹ (2, 1) of the array C¹. Thereafter, a product of the numerical value X₁¹ (1, 1) and a numerical value stored in the memory element M₃ is stored in a memory element C¹ (3, 1) of the array C¹. These processes can be executed in parallel. The parallel processing is advantageous in shortening the process time.

Subsequently, as shown in FIG. 13B, a product of a numerical value X₁¹ (2, 1) stored in a memory element in the second row and first column of the array X₁¹ and the numerical value stored in the memory element M₂ is calculated, and a sum of this product and the numerical value stored in the memory element C¹ (1, 1) of the array C¹ of the storage device 70 is calculated and newly stored in the memory element C¹ (1, 1). Succeedingly, a product of the numerical value X₁¹ (2, 1) and a numerical value stored in the memory element M₃ is calculated, and a sum of this product and a numerical value stored in a memory element C¹ (2, 1) of the array C¹ of the storage device 70 is calculated and newly stored in the memory element C¹ (2, 1). Thereafter, a product of the numerical value X₁¹ (2, 1) and a numerical value stored in the memory element M₄ is calculated, and a sum of this product and the numerical value stored in the memory element C¹ (3, 1) of the array C¹ is calculated and newly stored in the memory element C¹ (3, 1). These processes can be executed in parallel. The parallel processing is advantageous in shortening the process time.

Subsequently, as shown in FIG. 13C, a product of a numerical value X₁¹ (3, 1) stored in a memory element in third row and first column of the array X₁¹ and the numerical value stored in the memory element M₃ is calculated, and a sum of this product and the numerical value stored in the memory element C¹ (1, 1) of the array C¹ is calculated and newly stored in the memory element C¹ (1, 1). Succeedingly, a product of the numerical value X₁¹ (3, 1) and a numerical value stored in the memory element M₄ is calculated, and a sum of this product and the numerical value stored in the memory element C¹ (2, 1) of the array C¹ of the storage device 70 is calculated and newly stored in the memory element C¹ (2, 1). Thereafter, a product of the numerical value X₁¹ (3, 1) and a numerical value stored in the memory element M₅ is calculated, and a sum of this product and the numerical value stored in the memory element C¹ (3, 1) of the array C¹ is calculated and newly stored in the memory element C¹ (3, 1). These processes can be executed in parallel. The parallel processing is advantageous in shortening the process time.

Subsequently, as shown in FIG. 13D, a product of the numerical value X₁¹ (1, 1) stored in the memory element in the first row and first column of the array X₁¹ and the numerical value stored in the memory element M₄ is calculated and stored in a memory element C¹ (4, 1). Succeedingly, a product of the numerical value X₁¹ (1, 1) and the numerical value stored in the memory element M₅ is calculated and stored in a memory element C¹ (5, 1). Thereafter, a product of the numerical value X₁¹ (1, 1) and a numerical value stored in the memory element M₆ is calculated and stored in a memory element C¹ (6, 1). These processes can be executed in parallel. The parallel processing is advantageous in shortening the process time.

Subsequently, as shown in FIG. 13E, a product of the numerical value X₁¹ (2, 1) stored in the memory element in the second row and first column of the array X₁¹ and the numerical value stored in the memory element M₅ is calculated, and a sum of this product and the numerical value stored in the memory element C¹ (4, 1) of the array C¹ is newly stored in the memory element C¹ (4, 1). Succeedingly, a product of the numerical value X₁¹ (2, 1) and the numerical value stored in the memory element M₆ is calculated, and a sum of this product and the numerical value stored in the memory element C¹ (5, 1) of the array C¹ is newly stored in the memory element C¹ (5, 1). Thereafter, a product of the numerical value X₁¹ (2, 1) and a numerical value stored in the memory element M₇ is calculated, and a sum of this product and the numerical value stored in the memory element C¹ (6, 1) of the array C¹ is newly stored in the memory element C¹ (6, 1). These processes can be executed in parallel. The parallel processing is advantageous in shortening the process time.

Subsequently, as shown in FIG. 13F, a product of the numerical value X₁¹ (3, 1) stored in the memory element in third row and first column of the array X₁¹ and the numerical value stored in the memory element M₆ is calculated, and a sum of this product and the numerical value stored in the memory element C¹ (4, 1) of the array C¹ is newly stored in the memory element C¹ (4, 1). Succeedingly, a product of the numerical value X₁¹ (3, 1) and the numerical value stored in the memory element M₇ is calculated, and a sum of this product and the numerical value stored in the memory element C¹ (5, 1) of the array C¹ is newly stored in the memory element C¹ (5, 1). Thereafter, a product of the numerical value X₁¹ (3, 1) and a numerical value stored in the memory element M₈ is calculated, and a sum of this product and the numerical value stored in the memory element C¹ (6, 1) of the array C¹ is newly stored in the memory element C¹ (6, 1). These processes can be executed in parallel. The parallel processing is advantageous in shortening the process time.

Through the processes described above, as shown in FIG. 13G, the convolution processes using the first column of the array X₁¹ of the first kernel X₁ to the memory elements M₁ to M₈ of the storage device 50 are complete. The result of this process is stored in the memory elements C¹ (1, 1) to C¹ (6, 1) of the first column of the array C¹ of the storage device 70.

Subsequently, the convolution processes using the first column of an array X₂¹ of a second kernel X₂, instead of the array X₁¹ of the first kernel X₁, are performed to the memory elements M₁ to M₈ of the storage device 50. The result of process is stored in memory elements C² (1, 1) to C² (6, 1) of the first column of an array C² of the storage device 70. The convolution processes are performed, in the same manner as explained with reference to FIGS. 13A to 13G, using the first column of each of arrays X₂¹ to X₂¹⁰ of the second kernel X₂, instead of the first column of the arrays X₁¹ to X₁¹⁰ of the first kernel X₁.

Hereinafter, in the same manner as described above, the convolution processes to the memory elements M₁ to M₈ of the storage device 50 are performed with an i-th kernel Xᵢ (i=3, . . . , 10) instead of the first kernel X₁. The result of process is stored in memory elements Cⁱ (1, 1) to Cⁱ (6, 1) of the first column of an array Cⁱ of the storage device 70.

Through the processes described above, the convolution processes by the process layer 30 using the first kernel W₁ related to the first to fourth columns of the arrays A₁ to A₇ and the convolution processes by the process layer 60 using the column of each of the first to tenth kernels X₁ to X₁₀ to the memory elements M₁ to M₈ are complete. The result of process is stored in the first column of each of the arrays C¹ to C¹⁰ of the storage device 70. This state is shown in FIG. 13H.

In the processes explained with reference to FIGS. 13A to 13H, the processes to different kernels Xₘ (m=1, . . . , 10) can be executed in parallel. The parallel processing is advantageous in shortening the process time.

(Second Convolution Process by Process Layer 30)

Subsequently, the convolution process by the process layer 30 using the second kernel W₂ related to the first to fourth columns of the arrays A¹ to A⁷ is performed in the same manner as explained with reference to FIG. 12. The result of this convolution process is stored in the memory elements M₁ to M₈ of the storage device 50. This convolution process is performed in the same manner as the convolution process explained with reference to FIG. 12, with the kernel W₂ instead of the kernel W₁.

Succeedingly, the process layer 30 adds a bias B₂ to each numerical value stored in the memory element Mₖ (1≤k≤8), and applies an activation function process such as a rectified linear Unit (ReLU) function to the numerical value as required, and then newly stores the numerical value in the memory element Mₖ.

(Second Convolution Process by Process Layer 60)

Subsequently, the second convolution process is performed, using the first to tenth kernels X₁ to X₁₀, to a result of the convolution process related to the first to fourth columns of the arrays A¹ to A⁷ using the second kernel W₂.

First of all, as shown in FIG. 13I, a product of a numerical value X₁² (1, 1) stored in the first row and first column of an array X₁² of the first kernel X₁ stored in the storage device 65 and the numerical value stored in the memory element M₁ is calculated, and a sum of this product and the numerical value stored in the memory element C¹ (1, 1) of the array C¹ of the storage device 70 is calculated and newly stored in the memory element C¹ (1, 1). Succeedingly, a product of the numerical value X₁² (1, 1) and the numerical value stored in the memory element M₂ is calculated, and a sum of this product and the numerical value stored in the memory element C¹ (2, 1) of the array C¹ of the storage device 70 is calculated and newly stored in the memory element C¹ (2, 1). Thereafter, a product of the numerical value X₁² (1, 1) and the numerical value stored in the memory element M₃ is calculated, and a sum of this product and the numerical value stored in the memory element C¹ (3, 1) of the array C¹ of the storage device 70 is calculated and newly stored in the memory element C¹ (3, 1). These processes can be executed in parallel. The parallel processing is advantageous in shortening the process time.

Succeedingly, the process explained with reference to FIG. 13B is performed with a numerical value X₁² (2, 1) instead of the numerical value X₁¹ (2, 1). In detail, a product of the numerical value X₁² (2, 1) stored in the second row and first column of the array X₁² and the numerical value stored in the memory element M₂ is calculated, and a sum of this product and the numerical value stored in the memory element C¹ (1, 1) of the array C¹ of the storage device 70 is calculated and newly stored in the memory element C¹ (1, 1). Succeedingly, a product of the numerical value X₁² (2, 1) and the numerical value stored in the memory element M₃ is calculated, and a sum of this product and the numerical value stored in the memory element C¹ (2, 1) of the array C¹ of the storage device 70 is calculated and newly stored in the memory element C¹ (2, 1). Thereafter, a product of the numerical value X₁² (2, 1) and the numerical value stored in the memory element M₄ is calculated, and a sum of this product and the numerical value stored in the memory element C¹ (3, 1) of the array C¹ of the storage device 70 is calculated and newly stored in the memory element C¹ (3, 1).

Thereafter, the process explained with reference to FIG. 13C is performed with a numerical value X₁² (3, 1) instead of the numerical value X₁¹ (3, 1).

Succeedingly, the process explained with reference to FIG. 13D is performed with a numerical value X₁² (1, 1) instead of the numerical value X₁¹ (1, 1). In detail, as shown in FIG. 13J, a product of the numerical value X₁² (1, 1) and the numerical value stored in the memory element M₄ is calculated, and a sum of this product and the numerical value stored in the memory element C¹ (4, 1) of the array C¹ of the storage device 70 is calculated and newly stored in the memory element C¹ (4, 1). Succeedingly, a product of the numerical value X₁² (1, 1) and the numerical value stored in the memory element M₅ is calculated, and a sum of this product and the numerical value stored in the memory element C¹ (5, 1) of the array C¹ of the storage device 70 is calculated and newly stored in the memory element C¹ (5, 1). Thereafter, a product of the numerical value X₁² (1, 1) and the numerical value stored in the memory element M₆ is calculated, and a sum of this product and the numerical value stored in the memory element C¹ (6, 1) of the array C¹ of the storage device 70 is calculated and newly stored in the memory element C¹ (6, 1). These processes can be executed in parallel. The parallel processing is advantageous in shortening the process time.

Succeedingly, the process explained with reference to FIG. 13E is performed with a numerical value X₁² (2, 1) instead of the numerical value X₁¹ (2, 1).

Thereafter, the process explained with reference to FIG. 13F is performed with a numerical value X₁² (3, 1) instead of the numerical value X₁¹ (3, 1).

Through the processes described above, the convolution processes using the first column of the array X₁² of the kernel X₁ to the memory elements M₁ to M₈ are complete.

Subsequently, the convolution processes using the first column of an array Xₘ² of an m-th (m=2, . . . , 10) kernel Xₘ to the memory elements M₁ to M₈ are performed in the same manner as explained with reference to FIGS. 13A to 13H.

The result of the processes described above is stored in memory elements Cⁱ (1, 1) to Cⁱ (6, 1)(i=1, . . . , 10) of the first column of the array Cⁱ (i=1, . . . , 10) of the storage device 70. Accordingly, the convolution processes by the process layer 30 using the second kernel W₂ related to the first to fourth columns of the arrays A₁ to A₇, and the convolution processes by the process layer 60 using the first column of each of the arrays X₁² to X₁₀² of the first to tenth kernels X₁ to X₁₀ to the memory elements M₁ to M₈ are complete. The result of process is stored in the memory elements Cⁱ (1, 1) to Cⁱ (6, 1) (i=1, . . . , 10) of the first column of the array Cⁱ (i=1, . . . , 10) of the storage device 70.

In the processes described above, the convolution processes using different arrays Xₘ² (m=1, . . . , 10) can be executed in parallel. The parallel processing is advantageous in shortening the process time.

(Third Convolution Process by Process Layer 30)

Subsequently, a convolution process by the process layer 30 using the third kernel W₃ related to the first to fourth columns of the arrays A¹ to A⁷ is performed in the same manner as explained with reference to FIG. 12. The result of this convolution process is stored in the memory elements M₁ to M₈ of the storage device 50. This convolution process is performed in the same manner as the convolution process explained with reference to FIG. 12, but with the kernel W₃ instead of the kernel W₁.

Succeedingly, the process layer 30 adds a bias B₃ to each numerical value stored in the memory element Mₖ (1≤k≤8), and applies an activation function process such as a rectified linear Unit (ReLU) function to the numerical value as required, and then newly stores the numerical value in the memory element Mₖ.

(Third Convolution Process by Process Layer 60)

Subsequently, the third convolution process, using the first column of each of the arrays X₁³ to X₁₀³ of the first to tenth kernels X₁ to X₁₀, to a result of the convolution process related to the first to fourth columns of the arrays A¹ to A⁷ using the third kernel W₃, is performed in the same manner as the second convolution process by the process layer 60 explained with reference to FIGS. 13I and 13J.

The convolution processes by the process layer 30 using the third kernel W₃ related to the first to fourth columns of the arrays A₁ to A₇, and the convolution processes by the process layer 60 using the first column of each of the arrays X₁³ to X₁₀³ of the first to tenth kernels X₁ to X₁₀ to the memory elements M₁ to M₃ are complete. The result of the convolution processes is stored in the memory elements Cᵢ (1, 1) to Cᵢ (6, 1) (i=1, . . . , 10) of the first column of the array Cⁱ (i=1, . . . , 10) of the storage device 70, as shown in FIG. 13K.

(Convolution processes by Process Layers 30 and 60)

The convolution process by the process layer 30 using an i-th kernel Wᵢ (i=4, . . . , 10) related to the first to fourth columns of the arrays A¹ to A⁷ is performed in the same manner as explained with reference to FIG. 12. The result of this convolution process is stored in the memory elements M₁ to M₈. Along with this, the process layer 30 adds a bias Bᵢ (i=1, . . . , 10) to each numerical value stored in the memory element Mₖ (1≤k≤8), and applies an activation function process such as a rectified linear Unit (ReLU) function to the numerical value as required, and then newly stores the numerical value in the memory element Mₖ.

Subsequently, the fourth convolution process, using the first column of each of arrays X₁ⁱ to X₁₀ⁱ of the first to tenth kernels X₁ to X₁₀ to the memory elements M₁ to M₈ is performed in the same manner as the second convolution process by the process layer 60 explained with reference to FIGS. 13I and 13J.

These processes are performed in order for each i=4, . . . , 10.

Through the processes described above, the convolution processes by the process layer 30 using the i-th kernel Wᵢ (i=4, . . . , 10) related to the first to fourth columns of the arrays A₁ to A₇, and the convolution processes by the process layer 60, to each of the above-described convolution processes, using the first column of each of the arrays X₁ⁱ to X₁₀ⁱ of the first to tenth kernels X₁ to X₁₀ to the memory elements M₁ to M₈ are complete. The result of process is stored in the first column of each of the memory elements C¹ to C¹⁰ of the storage device 70, as shown in FIG. 13L.

(Convolution Process by Process Layer 30)

Subsequently, a convolution process of memory elements in the second to fifth columns of the arrays A¹ to A⁷ of the storage device 20 is performed by the process layer 30 using the first kernel W₁ stored in the storage device 40 shown in FIG. 4. The result of process is stored in the memory elements M₁ to M₈ of the storage device 50.

Succeedingly, the process layer 30 adds the bias B₁ to each numerical value stored in the memory element Mₖ (1≤k≤8), and applies an activation function process such as a rectified linear Unit (ReLU) function to the numerical value as required, and then newly stores the numerical value in the memory element Mₖ.

(Convolution Process by Process Layer 60)

Subsequently, a convolution processes by the process layer 60 using the memory elements X₁¹ (i, 1)(i=1, . . . , 6) of the array X₁¹ of the kernel X₁ is performed in the same manner as explained with reference to FIGS. 13A to 13F. The result of process is stored in each of memory elements C¹ (1, 2) to C¹ (6, 2) of the second column of the array C¹ of the storage device 70. Succeedingly, a convolution processes by the process layer 60 using X₁¹ (i, 2)(i=1, . . . , 6) is performed in the same manner as explained with reference to FIGS. 13A to 13F. The result of process is added to a numerical value stored in a memory element C¹ (i, 1) and then the numerical value thus added is newly stored in the memory element C¹ (i, 1).

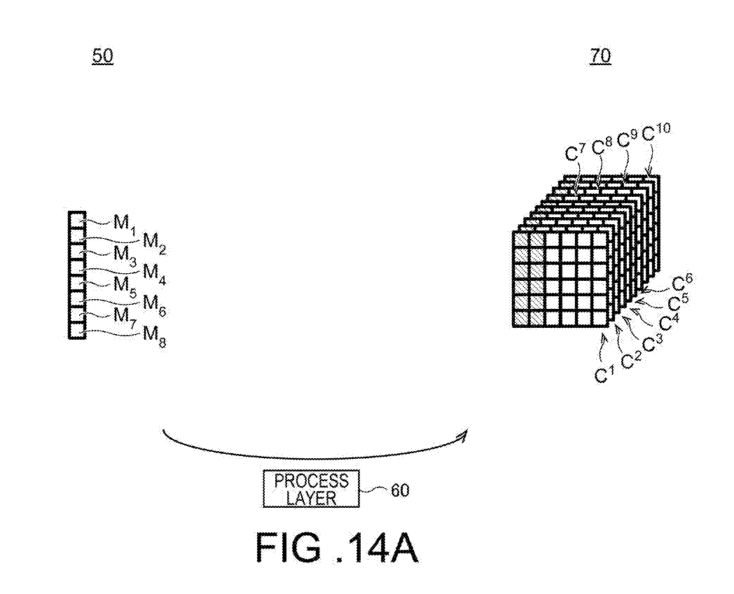

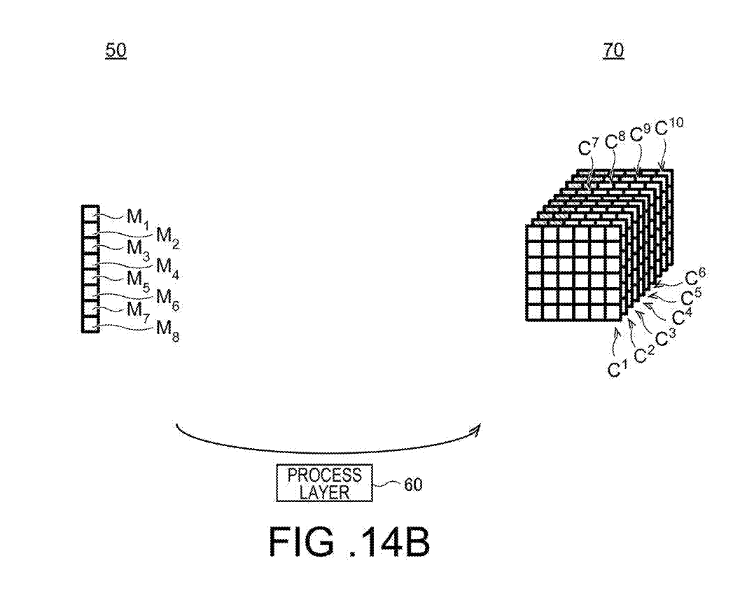

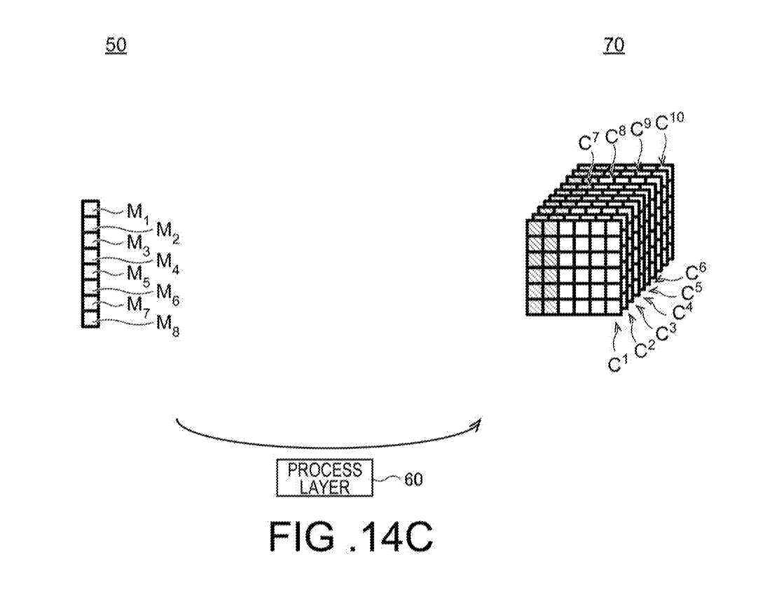

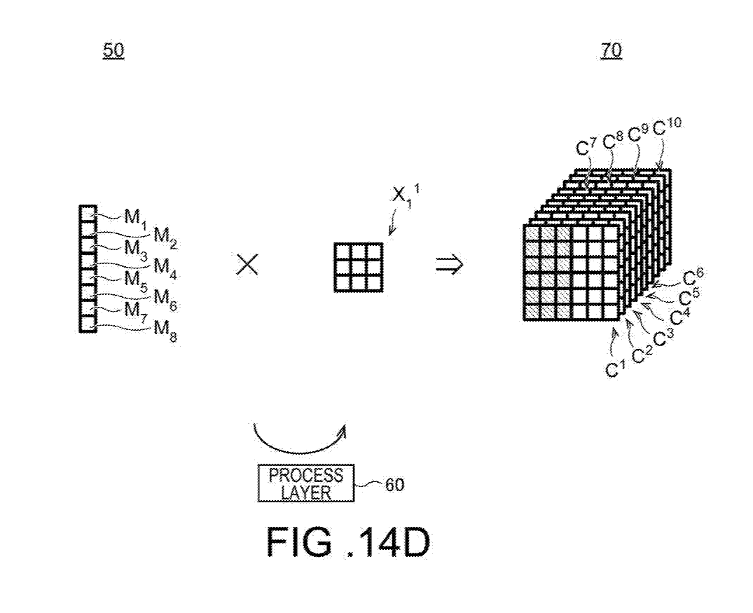

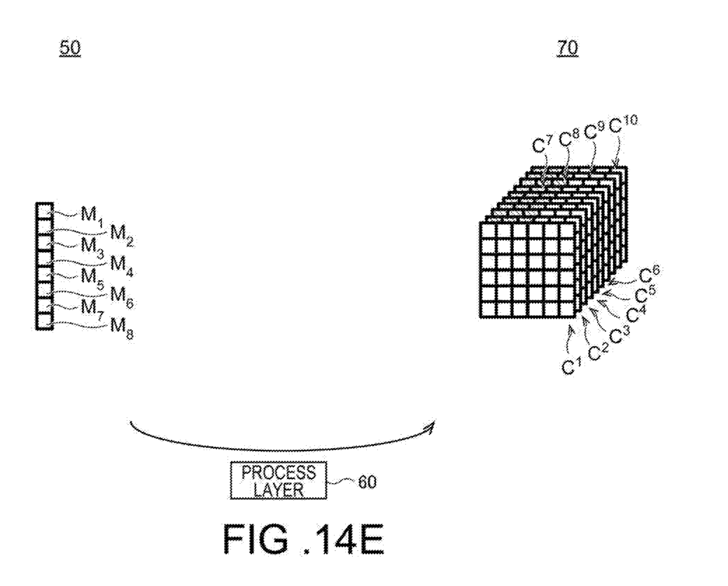

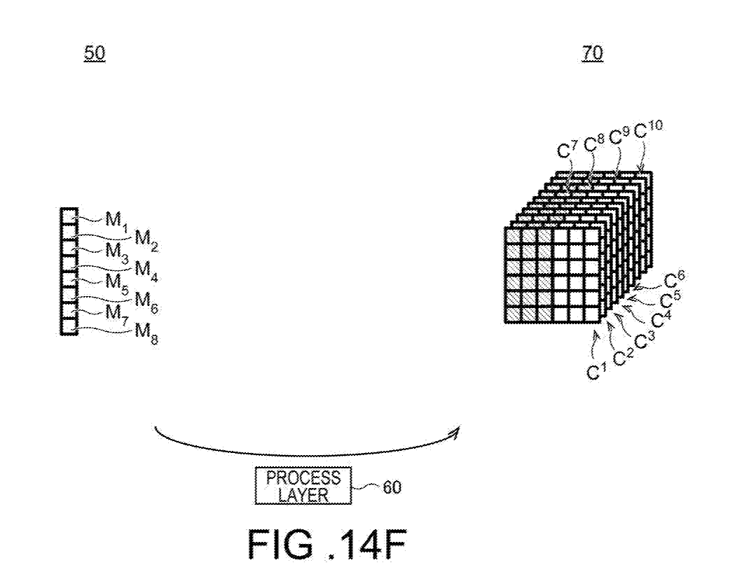

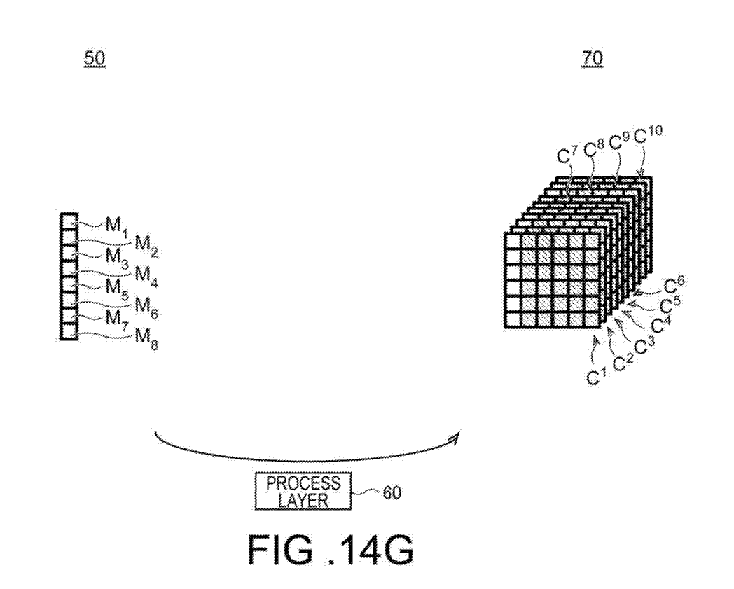

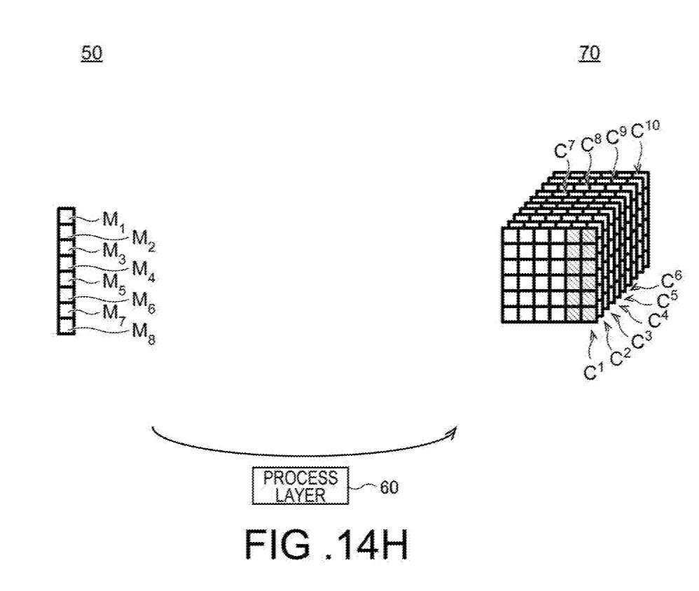

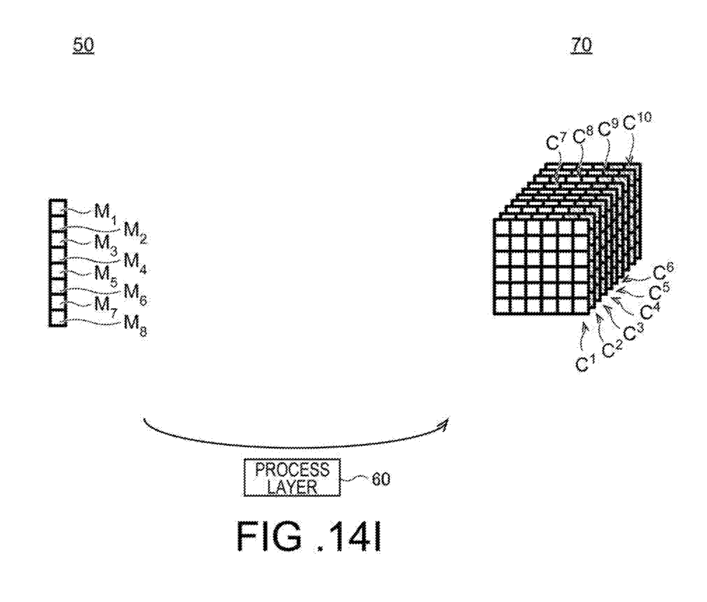

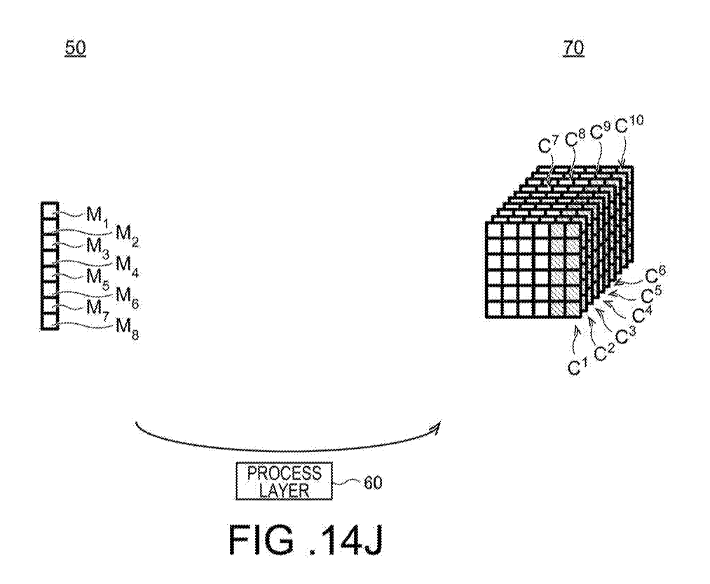

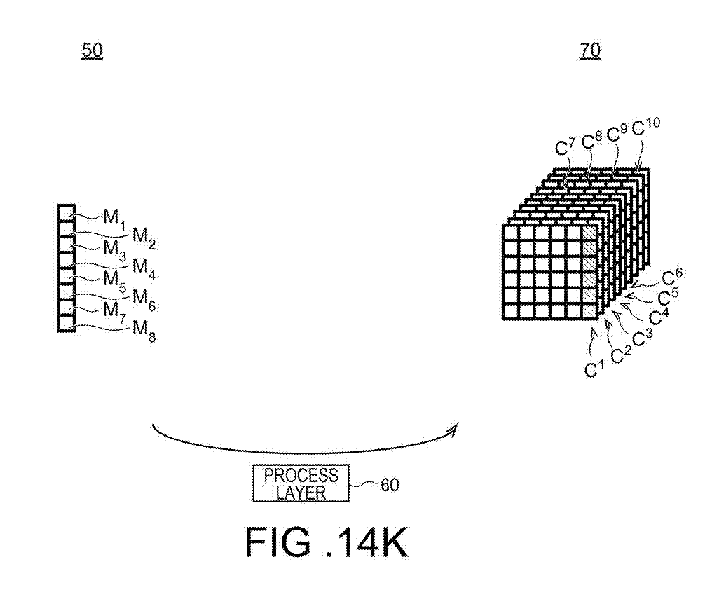

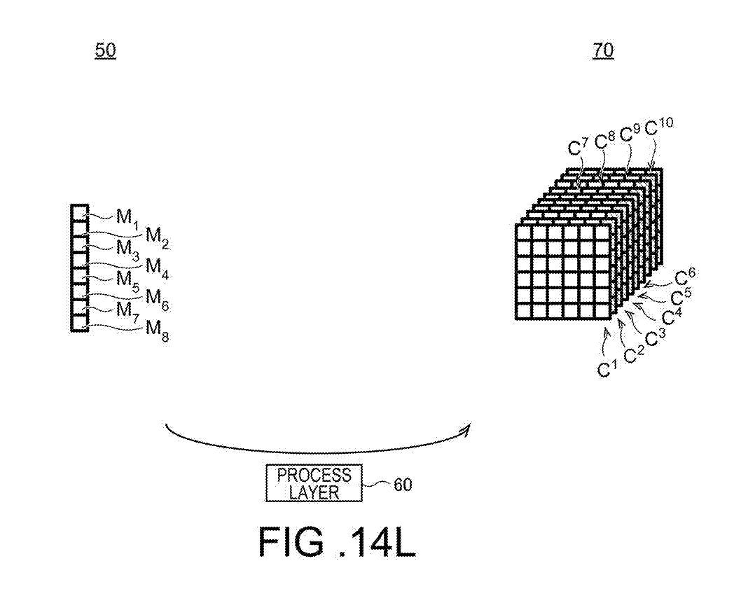

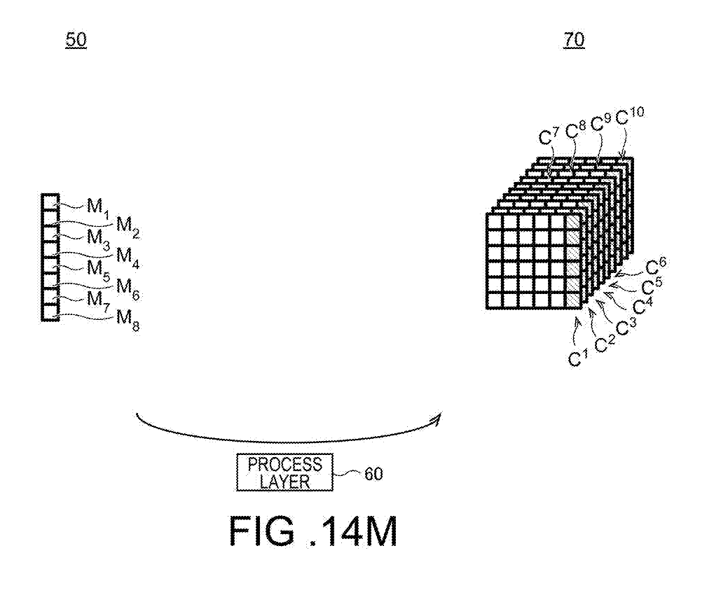

Through the processes described above, the convolution processes using the second column of the array X₁¹ of the first kernel W₁ to the memory elements M₁ to M₈ are complete. The result of process is shown in FIG. 14A.

Subsequently, a convolution process using the second column of an array Xᵢ¹ of an i-th (i=2, . . . , 10) kernel Xᵢ is performed in the same manner as explained using the second column of the array X₁¹. The result of process is added to each of the numerical values stored in memory elements Cⁱ (1, 1) to Cⁱ (6, 1) of the first column of the array Cⁱ of the storage device 70 and then the sums are newly stored in the memory elements C¹ (1, 1) to C¹ (6, 1). Then, a convolution process using the first column of the array Xᵢ¹ is performed in the same manner as explained using the first column of the array X₁¹. The result of process is stored in memory elements Cⁱ (1, 2) to Cⁱ (6, 2) of the second column of the array Cᵢ of the storage device 70. The result of process is shown in FIG. 14B. FIG. 14B shows a result of the convolution process using the kernel W₁ related to the second to fifth columns of the arrays A¹ to A⁷ and then the convolution process using the first and second columns of the array Xᵢ¹ of the kernel Xᵢ (i=2, . . . , 10) to the above-described convolution process. The processes to the different kernels explained with reference to FIGS. 14A and 14B can be executed in parallel. The parallel processing is advantageous in shortening the process time.

(Convolution Process by Process Layer 30)

Subsequently, the process layer 30 performs a convolution process using the second kernel W₂ to the memory elements in the second to fifth columns of the arrays A¹ to A⁷ in the storage device 20. The result of process is stored in the memory elements M₁ to M₈ of the storage device 50. Succeedingly, the process layer 30 adds the bias B₂ to each numerical value stored in the memory element Mₖ (1≤k≤8), and applies an activation function process such as a rectified linear Unit (ReLU) function to the numerical value as required, and then newly stores the numerical value in the memory element Mₖ.

(Convolution Process by Process Layer 60)

Subsequently, a convolution processes using the first column of the array X₁² of the first kernel X₁ is performed to the memory elements M₁ to M₈. The result of process is added to each of the numerical values stored in the memory elements (1, 2) to C¹ (6, 2) of the second column of the array C¹ of the storage device 70 and then the sums are newly stored in the memory elements C¹ (1, 2) to C¹ (6, 2). Succeedingly, a convolution processes using the second column of the kernel X₁² is performed to the memory elements M₁ to M₈. The result of process is added to the numerical values stored in the corresponding memory elements in the first column of the array C¹ and then the sums are newly stored in the corresponding memory elements in the first column of the array C¹.

In the same manner, a convolution process using the first and second columns of the array Xᵢ² of the i-th (i=2, . . . , 10) kernel Xᵢ is performed to the memory elements M₁ to M₈. The result of the above process is added to each of the numerical values stored in the memory elements Cⁱ (1, 2) to Cⁱ (6, 2) in the second column of the array Cⁱ and then the sums are newly stored in the corresponding memory elements in the second column of the array Cⁱ. Moreover, the result of the above process is added to each of the numerical values stored in the memory elements Cⁱ (1, 1) to Cⁱ (6, 1) in the first column of the array Cⁱ and then the sums are newly stored in the corresponding memory elements in the first column of the array Cⁱ.

Through the processes described above, the result of the convolution process using the first kernel W₁ to the memory elements in the second to fifth columns of the arrays A¹ to A⁷ is stored in the memory elements M₁ to M₈. Accordingly, the convolution process using the first and second columns of the array X₁² of the i-th (i=2, . . . , 10) kernel Xᵢ to the memory elements M₁ to M₈ is complete.

(Convolution Processes by Process Layers 30 and 60)

Subsequently, in the same manner, convolution processes using an i-th (i=2, . . . , 10) kernel Wᵢ are performed to the memory elements in the second to fifth columns of the arrays A¹ to A⁷. To each of the convolution processes, the process layer 60 performs a convolution process using the first and second columns of an array Xⱼⁱ of a j-th (j=1, . . . , 10) kernel Xⱼ. The result of these processes are stored in the first and second columns of the array Cⁱ of the storage device 70. The result of the processes is shown in FIG. 14C.

(Convolution Process by Process Layer 30)

Subsequently, a convolution process to memory elements in the third to sixth columns of the arrays A¹ to A⁷ stored in the storage device 20 is performed by the process layer 30 using the first kernel W₁ stored in the storage device 40 shown in FIG. 4. The result of process is stored in the memory elements M₁ to M₈ of the storage device 50.

Succeedingly, the process layer 30 adds the bias B₁ to each numerical value stored in the memory element Mₖ (1≤k≤8), and applies an activation function process such as a rectified linear Unit (ReLU) function to the numerical value as required, and then newly stores the numerical value in the memory element Mₖ.

(Convolution Process by Process Layer 60)

Subsequently, a convolution processes using the third column of the array X₁¹ of the first kernel X₁ is performed to the memory elements M₁ to M₈ in the same manner as explained with reference to FIGS. 13A to 13F. The result of process is, as shown in FIG. 14D, stored in the third, second and first columns of the array C¹ stored in the storage device 70. In detail, the result of the convolution process using the first column of the array X₁¹ of the first kernel X₁ is stored in the third column of the array C¹. A sum of the numerical values stored in the memory elements C¹ (1, 2) to C¹ (6, 2) in the second column and the result of the convolution process using the second column of the array X₁¹ of the first kernel X₁ is newly stored in the memory elements C¹ (1, 2) to C¹ (6, 2) of the second column. Moreover, a sum of the numerical values stored in the memory elements C¹ (1, 3) to C¹ (6, 3) in the third column of the array C¹ and the result of the convolution process using the third column of the array X₁¹ of the first kernel X₁ is newly stored in the memory elements C¹ (1, 3) to C¹ (6, 3) of the third column.

Subsequently, a convolution process using the first to third column of the array Xᵢ¹ of an i-th (i=2, . . . , 10) kernel Xᵢ, instead of the array X₁¹ of the first kernel X₁, to the memory elements M₁ to M₈ is performed in the same manner as explained with reference to FIG. 14D. The result of process is shown in FIG. 14E. The processes to the different arrays Xₘ¹ (m=2, . . . , 10) explained with reference to FIGS. 14D and 14E can be executed in parallel. The parallel processing is advantageous in shortening the process time.

(Convolution by Process Layers 30 and 60)

Subsequently, the process layer 30 performs a convolution process using an i-th (i=2, . . . , 10) kernel Wᵢ stored in the storage device 40 to the memory elements in the third to sixth columns of the arrays A¹ to A⁷ stored in the storage device 20. The result of process is stored in the memory elements M₁ to M₈ of the storage device 50. Succeedingly, the process layer 30 adds the bias Bᵢ to each numerical value stored in the memory element Mₖ (1≤k≤8), and applies an activation function process such as a rectified linear Unit (ReLU) function to the numerical value as required, and then newly stores the numerical value in the memory element Mₖ. Subsequently, a convolution process using the first to third columns of an array Xⱼⁱ of a j-th (j=2, . . . , 10) kernel Xⱼ to each of the result of the convolution processes using the i-th (i=2, . . . , 10) kernel Wᵢ is performed in the same manner as explained with reference to FIGS. 14D and 14E. The result of process is stored in the third, second and first columns of the array C¹. The result of this process is shown in FIG. 14F. Along with this, a bias value Yᵢ is added to each of memory elements Cⁱ (1, 1) to Cⁱ (6, 1) in the first column of the array Cⁱ (i=1, . . . , 10), and then the numerical values applied with an activation function process as required are newly stored in Cⁱ (1, 1) to Cⁱ (6, 1).

Through the processes described above, the convolution process using the first to third columns of the array Xⱼⁱ of the j-th (j=1, . . . , 10) kernel Xⱼ to each of the convolution processes using the i-th (i=1, . . . , 10) kernel Wᵢ is performed in the same manner as explained with reference to FIGS. 14D and 14E. The result of process is stored in the third, second and first columns of the array Cⁱ.

Subsequently, a convolution process to memory elements in the fourth to seventh columns of the arrays A¹ to A⁷ stored in the storage device 20 is performed by the process layer 30 using the the i-th (i=1, . . . , 10) kernel Wᵢ stored in the storage device 40. The result of process is stored in the memory elements M₁ to M₈ of the storage device 50. Succeedingly, the process layer 30 adds the bias Bᵢ to each numerical value stored in the memory element Mₖ (1≤k≤8), and applies an activation function process such as a rectified linear Unit (ReLU) function to the numerical value as required, and then newly stores the numerical value in the memory element Mₖ. Thereafter, in the same manner as explained with reference to FIGS. 14D to 14F, a convolution process, to each of the results of the convolution processes using the i-th (i=1, . . . , 10) kernel Wᵢ to the memory elements in the fourth to seventh columns of the arrays A¹ to A⁷, is performed by the process layer 60 using the j-th (j=1, . . . , 10) kernel Xⱼ. The result of these processes is stored in the fourth, third and second columns of the array Cⁱ of the storage device 70.

Subsequently, a convolution process to memory elements in the fifth to eighth columns of the arrays A¹ to A⁷ stored in the storage device 20 is performed by the process layer 30 using the i-th (i=1, . . . , 10) kernel Wᵢ stored in the storage device 40. The result of process is stored in the memory elements M₁ to M₈ of the storage device 50. Succeedingly, the process layer 30 adds the bias Bᵢ to each numerical value stored in the memory element Mₖ (1≤k≤8), and applies an activation function process such as a rectified linear Unit (ReLU) function to the numerical value as required, and then newly stores the numerical value in the memory element Mₖ. Thereafter, in the same manner as explained with reference to FIGS. 14D to 14F, a convolution process, to each of the results of the convolution processes using the i-th (i=1, . . . , 10) kernel Wᵢ to the memory elements in the fifth to eighth columns of the arrays A¹ to A⁷, is performed by the process layer 60 using the j-th (j=1, . . . , 10) kernel Xⱼ. The result of these processes is stored in the fifth, fourth and third columns of the array C³ of the storage device 70.

Subsequently, a convolution process to memory elements in the sixth to ninth columns of the arrays A¹ to A⁷ stored in the storage device 20 is performed by the process layer 30 using the i-th (i=1, . . . , 10) kernel Wᵢ stored in the storage device 40. The result of process is stored in the memory elements M₁ to M₈ of the storage device 50. Succeedingly, the process layer 30 adds the bias B, to each numerical value stored in the memory element Mₖ (1≤k≤8), and applies an activation function process such as a rectified linear Unit (ReLU) function to the numerical value as required, and then newly stores the numerical value in the memory element Mₖ. Thereafter, in the same manner as explained with reference to FIGS. 14D to 14F, a convolution process, to each of the results of the convolution processes using the i-th (i=1, . . . , 10) kernel Wᵢ to the memory elements in the sixth to ninth columns of the arrays A¹ to A⁷, is performed by the process layer 60 using the j-th (j=1, . . . , 10) kernel Xⱼ. The result of these processes is stored in the sixth, fifth and fourth columns of the array C^{j} of the storage device 70. The result of processes so far is shown in FIG. 14G.

Subsequently, a convolution process to memory elements in the seventh to tenth columns of the arrays A¹ to A⁷ stored in the storage device 20 is performed by the process layer 30 using the i-th (i=1, . . . , 10) kernel Wᵢ stored in the storage device 40. The result of process is stored in the memory elements M₁ to M₈ of the storage device 50. Succeedingly, the process layer 30 adds the bias Bᵢ to each numerical value stored in the memory element Mₖ (1≤k≤8), and applies an activation function process such as a rectified linear Unit (ReLU) function to the numerical value as required, and then newly stores the numerical value in the memory element Mₖ. Thereafter, in the same manner as explained with reference to FIGS. 14D to 14F, a convolution process, to each of the results of the convolution processes to the memory elements in the seventh to tenth columns of the arrays A¹ to A⁷, is performed by the process layer 60 using the j-th (j=1, . . . , 10) kernel Xⱼ. The result of these processes is stored in the sixth and fifth columns of the array C^{j} of the storage device 70. Along with this, the result of the convolution process by the process layer 60 is added to each of the sixth and fifth columns of the array C^{j}. The result of the addition is newly stored in the sixth and fifth columns of the array C^{j}. The result of process is shown in FIG. 14H.

Subsequently, a convolution process is performed in the same manner as explained with reference to FIG. 14H, using an i-th (i=2, . . . , 10) kernel Xᵢ replaced for the first kernel X₁. The result of this process is shown in FIG. 14I. In detail, new numerical values are stored in the fifth and sixth columns of an array C^{m} (m=2, . . . , 10). In the processes explained with reference to FIGS. 14H and 14I, the processes to the different kernels Xᵢ (i=1, . . . , 10) can be executed in parallel. The parallel processing is advantageous in shortening the process time.

Through the processes described above, as shown in FIG. 14J, new numerical values are stored in the fifth and sixth columns of the array Cⁱ (i=1, . . . , 10).

Subsequently, a convolution process to memory elements in the eighth to eleventh columns of the arrays A¹ to A⁷ stored in the storage device 20 is performed by the process layer 30 using the i-th (i=1, . . . , 10) kernel Wᵢ stored in the storage device 40. The result of process is stored in the memory elements M₁ to M₈ of the storage device 50. Succeedingly, the process layer 30 adds the bias Bᵢ to each numerical value stored in the memory element Mₖ (1≤k≤8), and applies an activation function process such as a rectified linear Unit (ReLU) function to the numerical value as required, and then newly stores the numerical value in the memory element Mₖ. Thereafter, to each of the result of the convolution processes using the i-th (i=1, . . . , 10) kernel Wᵢ to the eighth to eleventh memory elements of the arrays A¹ to A⁷, a convolution processes is performed in the same manner as explained with reference to FIGS. 13A to 13F, using an array X₁ⁱ of the first kernel X₁ replaced for the array X₁¹ of the first kernel X₁. The result of this convolution process is added to the numerical value stored in the memory element of the sixth column of the array C₁ and then the sum is newly stored in the memory element of the sixth column of the array C₁. The result of this process is shown in FIG. 14K.

Subsequently, a convolution process is performed in the same manner as explained with reference to FIG. 14K, using the third column of an array Xₘⁱ of an m-th (m=2, . . . , 10) kernel Xₘ replaced for the third column of the array X₁ⁱ (i=1, . . . , 10) of the first kernel X₁. The result of process is added to the numerical value stored in the memory element of the sixth column of the array C₁ of the sixth column of the array Cₘ and then the sum is newly stored in the memory element of the sixth column of the array C₁. The result of this process is shown in FIG. 14L.

In the processes explained with reference to FIGS. 14K and 14L, the processes to the different kernels Xᵢ (i=1, . . . , 10) can be executed in parallel. The parallel processing is advantageous in shortening the process time.

Subsequently, convolution processes are performed in the same manner as the process following to the process explained with reference to FIG. 14J, using an array Wₙ^{h} of an n-th (n=2, . . . , 10) kernel Wₙ replaced for an array W₁^{h} (h=1, . . . , 10) of the first kernel W₁. To each of the convolution processes, the process layer 60 performs a convolution process using an array Xₘⁿ of an m-th kernel Xₘ. The result of process is added to the numerical value stored in the memory element of the sixth column of an array C^{m} (m=2, . . . , 10) and then the sum is newly stored in the memory element of the sixth column of the array C^{m} (m=2, . . . , 10). Then, a bias value Yₘ is added to the numerical value stored in the memory element of the sixth column of the array C^{m} (m=1, . . . , 10), and then the numerical value applied with an activation function process such as Rectified Linear Unit as required is newly stored in the memory element of the sixth column of the array C^{m} (m=1, . . . , 10). The result of this process is shown in FIG. 14M.

Through the processes described above, the numerical values applied with the convolution processes by the process layer 30 and also applied with the convolution process by the process layer 60 to each of the convolution processes are stored in memory elements C^{m} (i, j) (i, j=1, . . . , 6) of the array C^{m} (m=1, . . . , 10).

The first or the second embodiment is explained with the example of the arrays to be applied with the convolution process having a size of 11×11 and a depth of 7, with the arrays of the kernels in the convolution process having a size of 4×4, and with the arrays of the kernels to be used for the succeeding pooling or convolution process having a size of 3×3. However, there is no necessity of the above sizes. It is a matter of course that any sizes other than the above sizes give the same effect. The same is applied to the depth of kernels in the convolution process.

The first or the second embodiment is explained with the example of a stride of kernels for applying the convolution and pooling processes, the stride being taken by one numerical, that is a stride of one. However, there is no necessity of the stride of 1. It is a matter of course that the same effect is given in the case of a stride of two or more.

Moreover, in the first or the second embodiment, the activation function process is performed immediately before the process explained with reference to FIG. 6A. However, it is a matter of course that the activation function process even performed after the pooling process gives the same effect when the activation function process gives the equivalent effect even performed after the pooling process in such a case that the activation function process is the rectified linear Unit process and the pooling process is maximum-value extraction.

Furthermore, the first or the second embodiment is explained with the rectified linear Unit process as the example of the activation function process. However, the activation function process is not limited to the rectified linear Unit process. It is a matter of course that the same effect is given when another process such as a sigmoid function process is performed.

Moreover, the first or the second embodiment does not refer to a padding process, that is, a process of padding zeros around the existing numerical values. However, it is a matter of course that the same effect is given when the padding process is performed.

Furthermore, the first or the second embodiment is explained with the example of the number of storage devices (arrays) to store the output of a specific layer, the number being equal to the number of outputs (arrays) of one column of the specific layer. However, the number is not limited to the number of outputs (arrays) of one column of the specific layer. It is a matter of course that the same effect is given with any number equal to or larger than the number of outputs of one column of the specific layer. Nevertheless, the number equal to the number of outputs of one column of the specific layer gives the maximum effect on decrease in the number of storage devices.

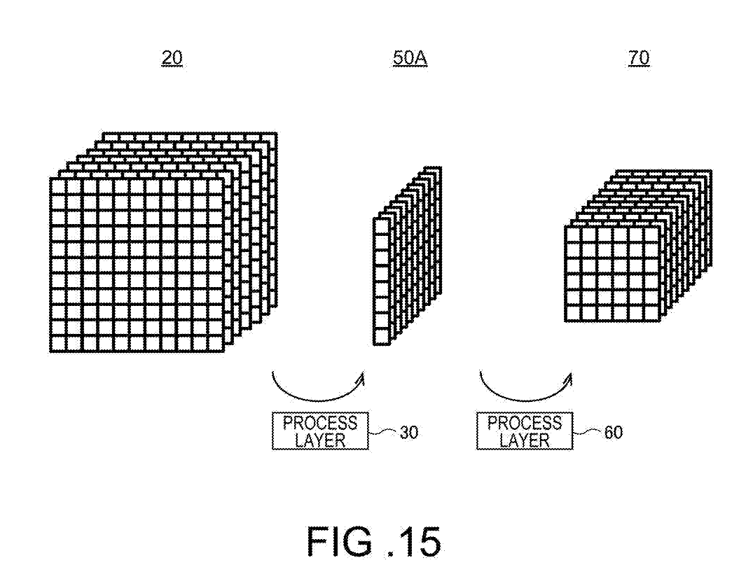

Moreover, the first or the second embodiment has a precondition that a storage device, which has a specific number of arrays that store the outputs of one column of the process layer 30, is provided as the storage device to store the outputs of the process layer 30. However, for example, as shown in FIG. 15, a storage device 50A having another specific number of arrays may be provided, the other specific number being obtained by multiplying the number of outputs (arrays) of one column of the process layer 30 by an integer of two or more. Having this arrangement, in the second embodiment and in the process explained before the process explained with reference to FIG. 6A, with or without necessary replacement, or in the processes in the second embodiment, which have different kernels, a specific number of processes up to an integer number can be executed in parallel, the integer being used in the above multiplication. The parallel processing is advantageous in shortening the process time.

FIG. 15 shows an example of the integer for the above multiplication, which is the number of outputs (arrays) of the process layer 30. However, there is no necessity of the number of outputs (arrays) of the process layer 30, as the integer for the above multiplication. It is matter of course that the same effect is given with any integer other than that number. Nevertheless, an integer equal to or larger than the number of outputs (arrays) of the process layer 30, as the integer for the above multiplication, allows parallel processing through all depths, and hence is preferable in shortening the process time. Moreover, an integer equal to or larger than a divisor of the number of outputs (arrays) of the process layer 30, as the integer for the above multiplication, allows parallel processing to be performed by a specific number of times, the specific number being obtained by dividing the above number by the divisor, with no meaningless processes over the entire parallel processing, hence preferable.

Furthermore, the first or the second embodiment is explained with the example of a size of the arrays of a kernel, the size being a divisor of the size of arrays of a layer that outputs a result of process to the layer (arrays). However, there is no necessity of the divisor as the size. It is a matter of course that the same effect is given even in the case where the size of the arrays of a kernel is not a multiple or divisor of the size of arrays of a layer that outputs a result of process to the layer.

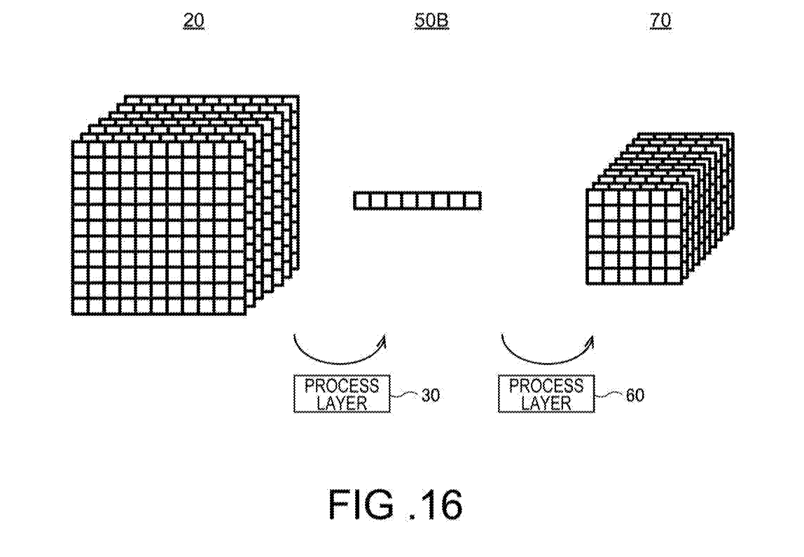

Moreover, the first or the second embodiment has a precondition that the number of storage devices that store the outputs of the process layer 30 is equal to the number of outputs of one column of the process layer 30, the storage devices being aligned in the vertical direction in the drawings. However, there is no necessity of this arrangement. It is a matter of course that the same effect is given even using storage devices 50B aligned in the lateral direction as shown in FIG. 16. In this case, the processes explained with reference to FIGS. 5A to 14M may be executed, with the row and column directions being exchanged in the drawings.

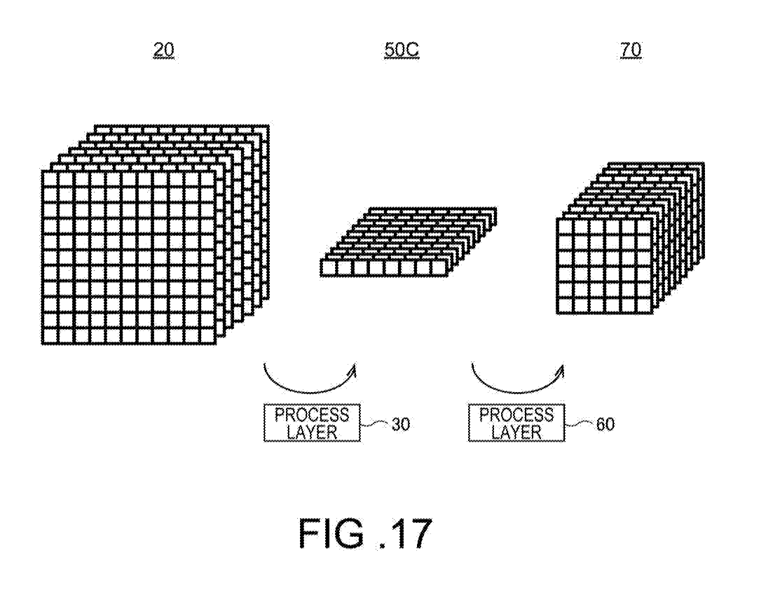

In FIG. 15, although the storage device 50A having one column of arrays aligned vertically that the arrays is aligned in the depth direction in the drawing is used, it is a matter of course that the same effect is given with a storage device 50C having arrays aligned laterally as shown in FIG. 17.

As explained above, according to the second embodiment, the storage device 50 can have a smaller capacity than conventional ones, and hence an arithmetic processing device of a small occupied area can be provided.

### Third Embodiment

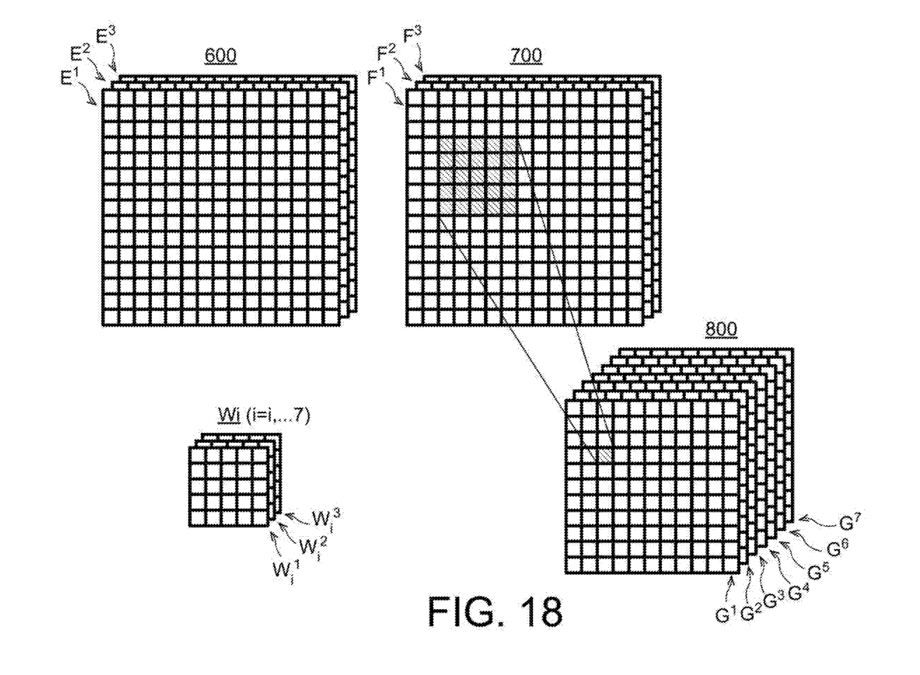

FIG. 18 shows an arithmetic processing device according to a third embodiment. The arithmetic processing device of the third embodiment reads out data from an external storage device 600 and stores the data in a storage device 700 built in the arithmetic processing device. The convolution process explained in the first embodiment is performed to data (numerical values) stored in the storage device 700 and then a result of process is stored in a storage device 800 built in the arithmetic processing device. Accordingly, the arithmetic processing device of the third embodiment has the same configuration as that in the first or the second embodiment, except for the storage device 800 replaced for the storage device 20 in the first or the second embodiment.

The external storage device 600 is provided, as shown in FIG. 18, with arrays E¹ to E³, each array Eⁱ (i=1, 2, 3) having memory elements of 15 rows and 15 columns. A kernel Wᵢ (i=1, . . . , 7) to be used for a convolution process has arrays Wᵢ¹ to Wᵢ³, each array Wᵢ^{j} (j=1, 2, 3) having memory elements of five rows and five columns.

The storage device 700 has arrays F¹ to F³ of the same size as those of the external storage device 600, each array Fⁱ (i=1, 2, 3) having memory elements of 15 rows and 15 columns. The storage device 800 has arrays G¹ to G⁷, each array Gⁱ (i=1, . . . , 7) having memory elements of 11 rows and 11 columns.

When the conventional convolution process explained with reference to FIG. 2 is performed using the kernel W to the arrangement of the external storage device 600 having the arrays E¹ to E³, it is required to read out the arrangement of numerical values stored in the external storage device 600 by seven times.

Different from the above, in the third embodiment, the arrangement of numerical values stored in the external storage device 600 is stored in the storage device 700, as the arrays F¹ to F³, and then the convolution process to store the arrangement of numerical values in the storage device 800 having the arrays G¹ to G⁷ is performed to the arrays F¹ to F³ stored in the storage device 700. Therefore, the 7-time reading to the arrangement of numerical values is performed to the arrays F¹ to F³ stored in the storage device 700.

In general, a read time from an internal storage device is shorter than a read time from an external storage device. Therefore, in the third embodiment, the read time is shortened compared with conventional ones, and as a result, a high speed operation is achieved.

In the third embodiment, the storage device 700, for newly storing the arrays E¹ to E³ of the numerical values stored in the external storage device 600, has the same size as the arrays E¹ to E³. However, the storage device 700 may have a different size from the arrays E¹ to E³. It is a matter of course that the same effect is given with the storage device 700 having a size equal to or larger than the size of the arrays E¹ to E³. Nevertheless, the storage device 700 having the same size as the arrays E¹ to E³ gives another advantage of a smaller storage-device capacity.

(First Modification)

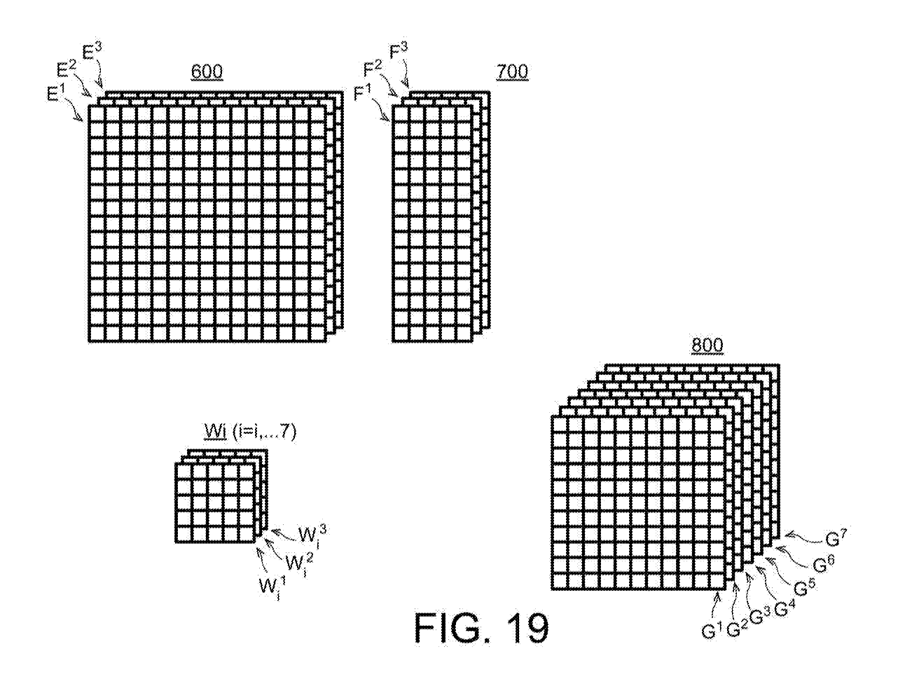

FIG. 19 shows an arithmetic processing device according to a first modification. The arithmetic processing device of the first modification has the same configuration as the arithmetic processing device of the third embodiment shown in FIG. 18, except that each array Fⁱ (i=1, 2, 3) has memory elements of 15 rows and 5 columns, in the arrays F¹ to F³ of the storage device 700. The kernel to be used for a convolution process has first to seventh kernels W₁ to W₇. An i-th (i=1, . . . , 7) kernel Wᵢ has arrays Wᵢ¹, Wᵢ² and Wᵢ³, each array Wᵢ^{j} (j=1, , . . . , 3) having memory elements of five rows and five columns. Especially, as shown in FIG. 19, the storage device 700 may have the same size or depth in the row or depth direction as that (3 in FIG. 19) of the arrays E¹ to E³ and the same size in the column direction as that of the kernels to be used for convolution process. This configuration gives another advantage of a smaller circuit area because of a decreased number of storage devices.

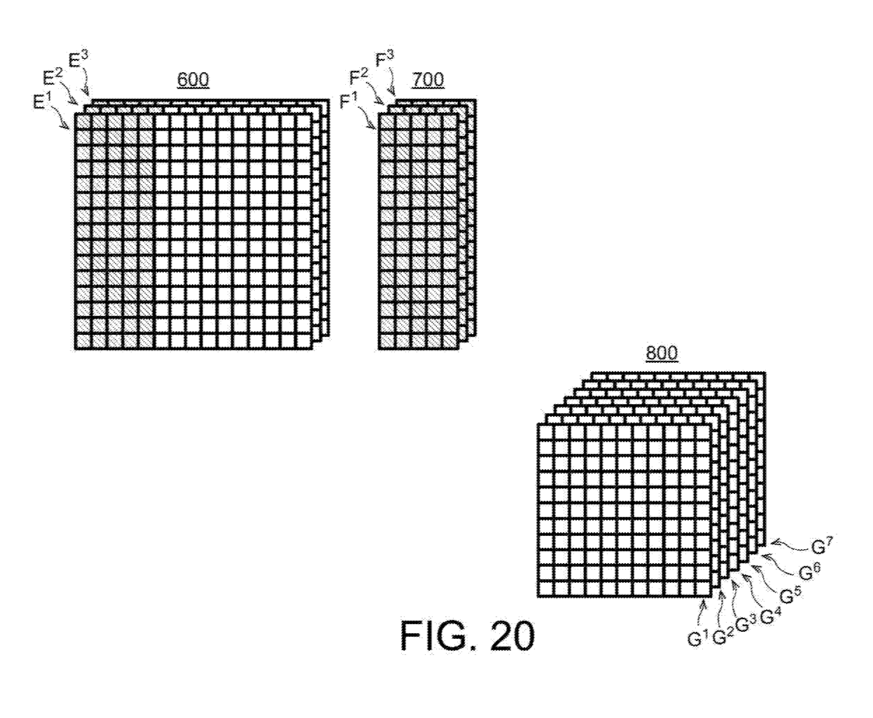

Subsequently, an operation of the arithmetic processing device of the first modification in the convolution process will be explained with reference to FIGS. 20 to FIG. 22K. In the following explanation, a memory element of an m-th row and n-th column of each array Eⁱ (i=1, 2, 3) is expressed as Eⁱ (m, n). A memory element of the m-th row and n-th column of each array Fⁱ (i=1, 2, 3) is expressed as Fⁱ (m, n). A memory element of the m-th row and n-th column of each array Gⁱ (i=1, 2, 3) is expressed as Gⁱ (m, n). An i-th (i=1, . . . , 7) kernel Wᵢ has arrays Wᵢ¹ to Wᵢ³. A memory element of the m-th row and n-th column of each array Wᵢ^{j} (j=1, 2, 3) is expressed as Wᵢ^{j} (m, n).

First of all, as shown in FIG. 20, numerical values stored in memory elements Eⁱ (1, 1) to Eⁱ (15, 1), Eⁱ (1, 2) to Eⁱ (15, 2), Eⁱ (1, 3) to Eⁱ (15, 3), Eⁱ (1, 4) to Eⁱ (15, 4) and Eⁱ (1, 5) to Eⁱ (15, 5) of the first to fifteenth rows and the first to fifth columns of the array Eⁱ (i=1, 2, 3) of the external storage device 600 are read out and then stored in memory elements Fⁱ (1, 1) to Fⁱ (15, 1), Fⁱ (1, 2) to Fⁱ (15, 2), Fⁱ (1, 3) to Fⁱ (15, 3), Fⁱ (1, 4) to Fⁱ (15, 4) and Fⁱ (1, 5) to Fⁱ (15, 5) of the first to fifteenth rows and the first to fifth columns of the array Fⁱ of the storage device 700, respectively. In the following explanation, the sign Eⁱ (1, 1) given to a memory element also expresses a numerical value stored in this memory element, the same being applied to other signs given to other memory elements.

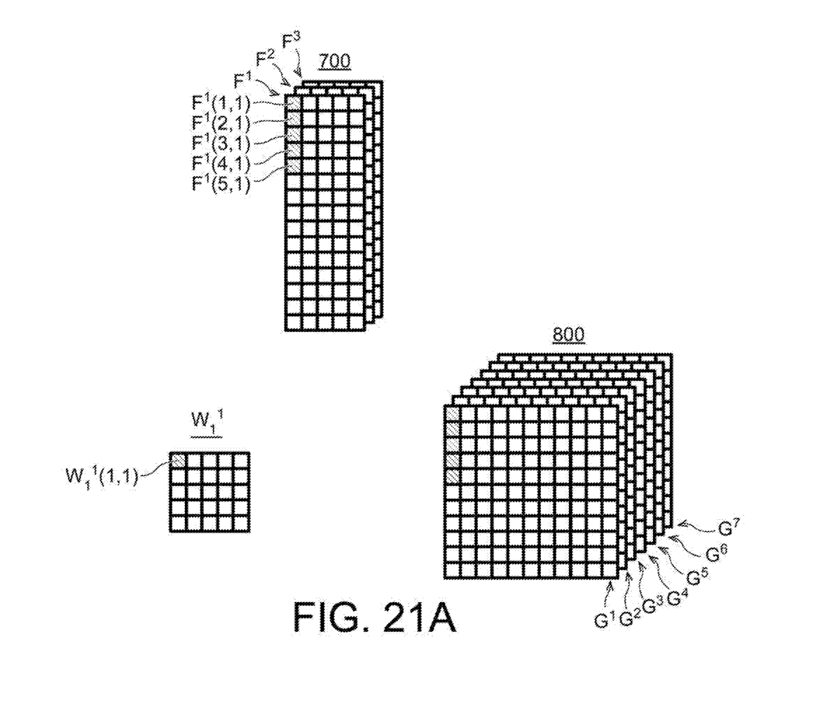

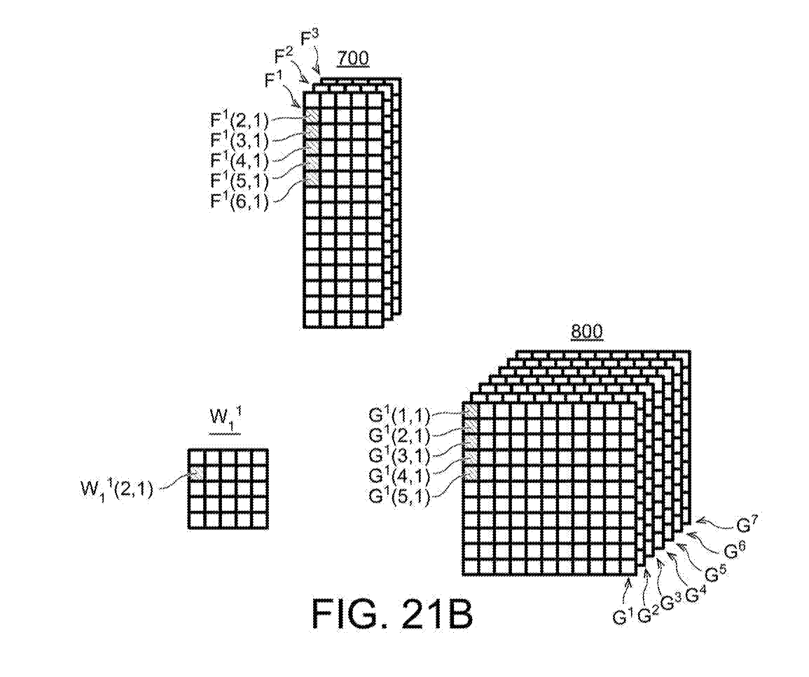

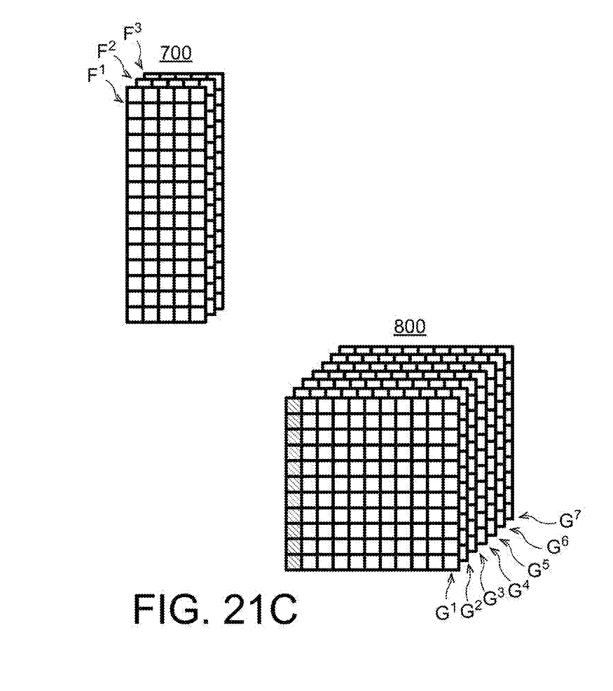

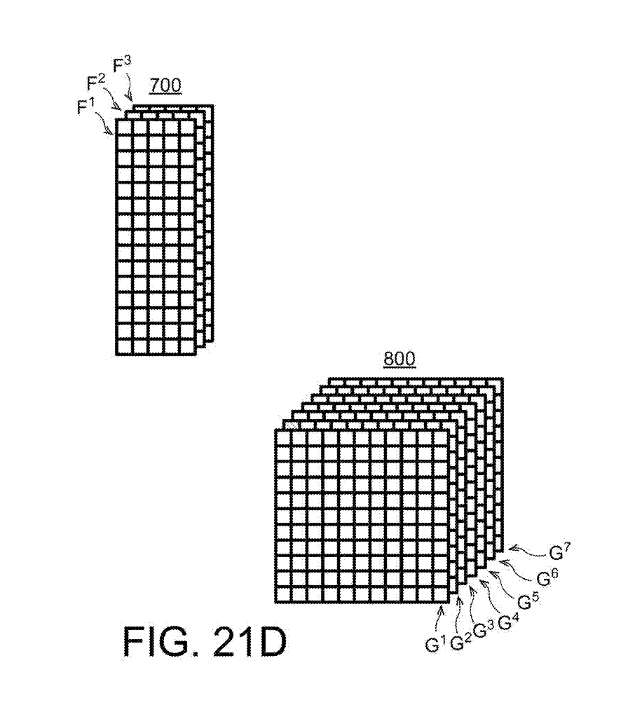

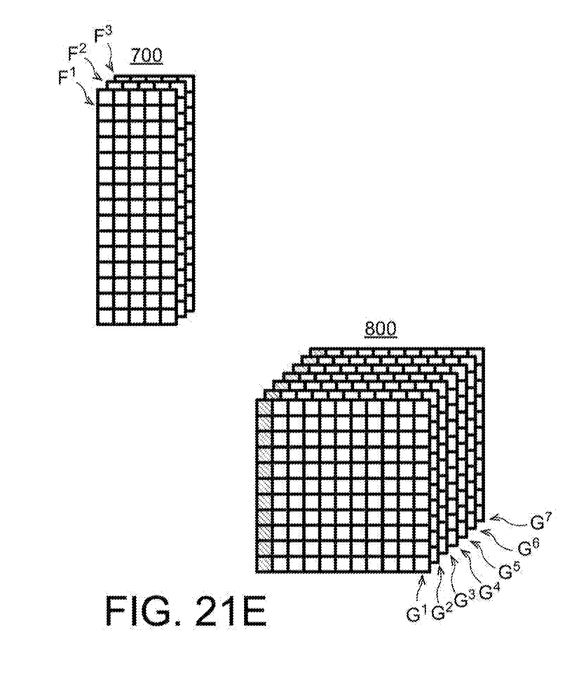

Subsequently, as shown in FIG. 21A, a product of a numerical value stored in a memory element W₁¹ (1, 1) in the first row and first column of an array W₁¹ of a first kernel W₁ and a numerical value stored in a memory element F₁¹ (1, 1) in the first row and first column of an array F¹ of the storage device 700 is calculated and this product is stored in a memory element G₁¹ (1, 1) in the first row and first column of an array G¹ of the storage device 800. Succeedingly, a product of the numerical value stored in the memory element W₁¹ (1, 1) of the array W₁¹ and a numerical value stored in a memory element F₁¹ (2, 1) in the second row and first column of the array F¹ is calculated and this product is stored in a memory element G₁¹ (2, 1) in the second row and first column of the array G¹. Succeedingly, a product of the numerical value stored in the memory element W₁¹ (1, 1) of the array W₁¹ and a numerical value stored in a memory element F₁¹ (3, 1) in the third row and first column of the array F¹ is calculated and this product is stored in a memory element G₁¹ (3, 1) in the third row and first column of the array G¹. Moreover, a product of the numerical value stored in the memory element W₁¹ (1, 1) of the array W₁¹ and a numerical value stored in a memory element F₁¹ (4, 1) in the fourth row and first column of the array F¹ is calculated and this product is stored in a memory element G₁¹ (4, 1) in the fourth row and first column of the array G¹. Succeedingly, a product of the numerical value stored in the memory element W₁¹ (1, 1) of the array W₁¹ and a numerical value stored in a memory element F₁¹ (5, 1) in the fifth row and first column of the array F¹ is calculated and this product is stored in a memory element G₁¹ (5, 1) in the fifth row and first column of the array G¹. The above processes can be executed in parallel. The parallel processing is advantageous in shortening the process time.

Subsequently, as shown in FIG. 21B, a product of a numerical value stored in a memory element W₁¹ (2, 1) in the second row and first column of the array W₁¹ of the kernel W₁ and the numerical value stored in the memory element F₁¹ (2, 1) in the second row and first column of the array F¹ of the storage device 700 is calculated. A sum of the above product and the numerical value stored in the memory element G₁¹ (1, 1) in the first row and first column of the array G¹ of the storage device 800 is calculated and the sum is newly stored in the memory element G₁¹ (1, 1). Subsequently, a product of the numerical value stored in the memory element W₁¹ (2, 1) of the array W₁¹ and the numerical value stored in the memory element F₁¹ (3, 1) in the third row and first column of the array F¹ is calculated. A sum of the above product and the numerical value stored in the memory element G₁¹ (2, 1) in the second row and first column of the array G¹ of the storage device 800 is calculated and the sum is newly stored in the memory element G₁¹ (2, 1). Thereafter, a product of the numerical value stored in the memory element W₁¹ (2, 1) in the second row and first column of the array W₁¹ and the numerical value stored in the memory element F₁¹ (4, 1) in the fourth row and first column of the array F¹ is calculated. A sum of the above product and the numerical value stored in the memory element G₁¹ (3, 1) in the third row and first column of the array G¹ of the storage device 800 is calculated and the sum is newly stored in the memory element G₁¹ (3, 1). Moreover, a product of the numerical value stored in the memory element W₁¹ (2, 1) in the second row and first column of the array W₁¹ and the numerical value stored in the memory element F₁¹ (5, 1) in the fifth row and first column of the array F¹ is calculated. A sum of the above product and the numerical value stored in the memory element G₁¹ (4, 1) in the fourth row and first column of the array G¹ of the storage device 800 is calculated and the sum is newly stored in the memory element G₁¹ (4, 1). Succeedingly, a product of the numerical value stored in the memory element W₁¹ (2, 1) in the second row and first column of the array W₁¹ and a numerical value stored in a memory element F₁¹ (6, 1) in the sixth row and first column of the array F¹ is calculated. A sum of the above product and the numerical value stored in the memory element G₁¹ (5, 1) in the fifth row and first column of the array G¹ of the storage device 800 is calculated and the sum is newly stored in the memory element G₁¹ (5, 1). The above processes can be executed in parallel. The parallel processing is advantageous in shortening the process time.

Thereafter, in the same manner as explained in the first embodiment with reference to FIGS. 5A to 5Q, a convolution process using the arrays W₁¹ to W₁³ of the first kernel W₁ to the arrays F¹ to F³ of the storage device 700 is performed. Thereafter, a bias value B₁ is added to each of the numerical values stored in memory elements G¹ (1, 1) to G¹ (11, 1) of the first column of the array G¹ and an activation function process such as a rectified linear Unit (ReLU) function is applied to the numerical values as required, and then the numerical values are newly stored in the memory elements G¹ (1, 1) to G¹ (11, 1) of the first column of the array G¹. In this way, as shown in FIG. 21C, data, for which the convolution process using the first kernel W₁ to the first to fifth columns of the arrays E¹ to E³ of the external storage device 600 has been completed, are stored in the memory elements G¹ (1, 1) to G¹ (11, 1) of the first column of the array G¹ of the storage device 800.

Subsequently, a convolution process is performed in the same manner as explained with reference to FIGS. 21A to 21C, using the second kernel W₂ replaced for the first kernel W₁. The result of convolution process is stored in memory elements G² (1, 1) to G² (11, 1) of the first column of an array G² of the storage device 800. Thereafter, a bias value B₂ is added to each of the numerical values stored in the memory elements G² (1, 1) to G² (11, 1) of the first column of the array G² and an activation function process such as a rectified linear Unit (ReLU) function is applied to the numerical values as required, and then the numerical values are newly stored in the memory elements G² (1, 1) to G² (11, 1) of the first column of the array G². In this way, as shown in FIG. 21D, data, for which the convolution process using the second kernel W₂ to the first to fifth columns of the arrays E¹ to E³ of the external storage device 600 has been completed, are stored in the memory elements G² (1, 1) to G² (11, 1) of the first column of the array G² of the storage device 800.

Subsequently, a convolution process is performed in the same manner as explained with reference to FIGS. 21A to 21C, using an i-th (i=3, . . . , 7) kernel Wᵢ replaced for the first kernel W₁. The result of convolution process is stored in memory elements Gⁱ (1, 1) to Gⁱ (11, 1) of the first column of an i-th (i=3, . . . , 7) array Gⁱ of the storage device 800. Thereafter, a bias value Bᵢ is added to each of the numerical values stored in the memory elements Gⁱ (1, 1) to Gⁱ (11, 1) of the first column of the array Gⁱ and an activation function process such as a rectified linear Unit (ReLU) function is applied to the numerical values as required, and then the numerical values are newly stored in the memory elements Gⁱ (1, 1) to Gⁱ (11, 1) of the first column of the array Gⁱ. In this way, as shown in FIG. 21E, data, for which the convolution process using the first to seventh kernels W₁ to W₇ to the first to fifth columns of the arrays E¹ to E³ of the external storage device 600 has been completed, are stored in the memory elements Gⁱ (1, 1) to Gⁱ (11, 1) of the first column of the i-th (i=1, . . . , 7) array Gⁱ of the storage device 800.

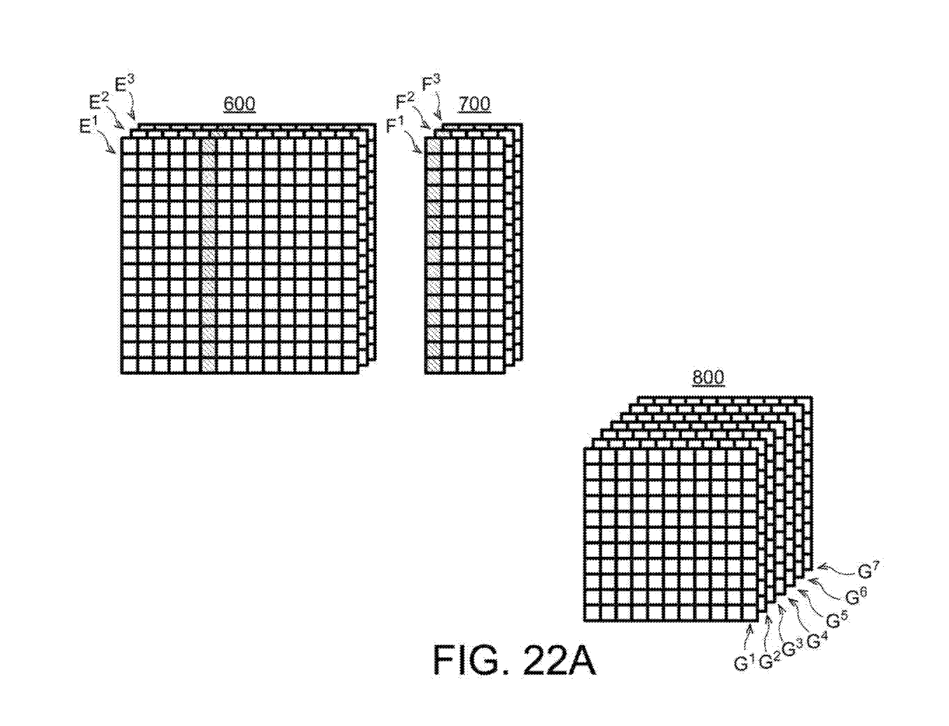

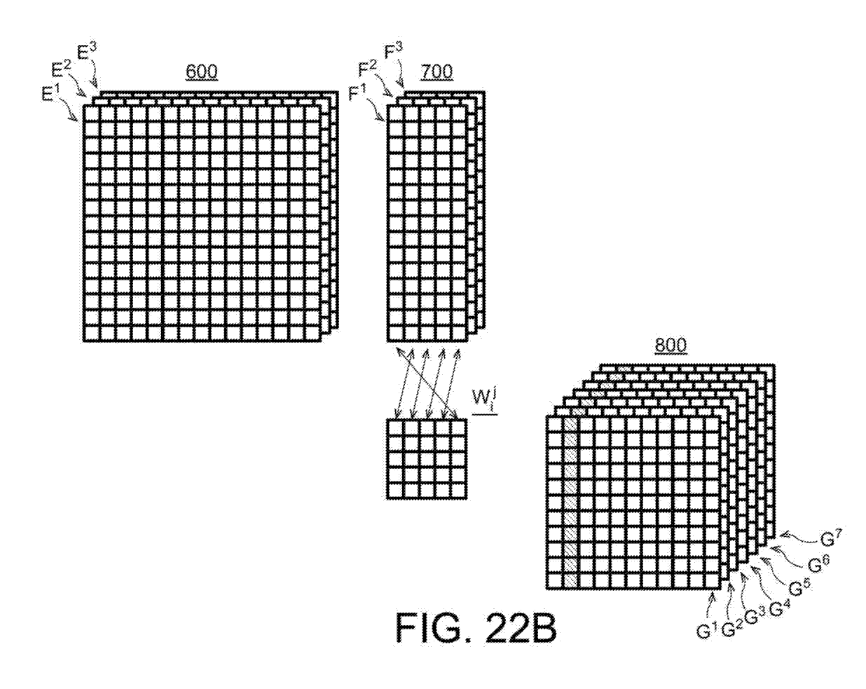

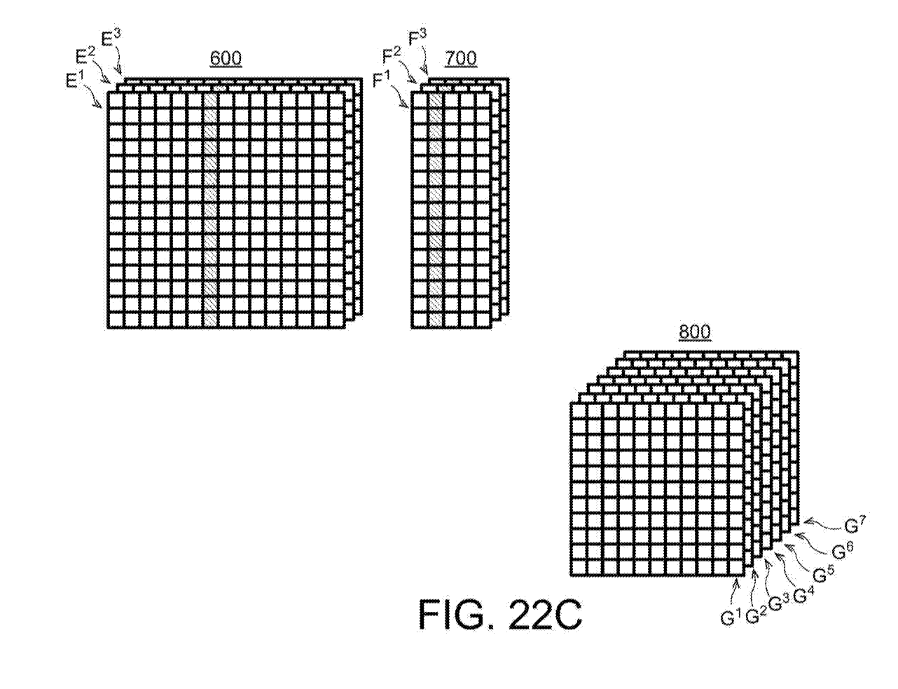

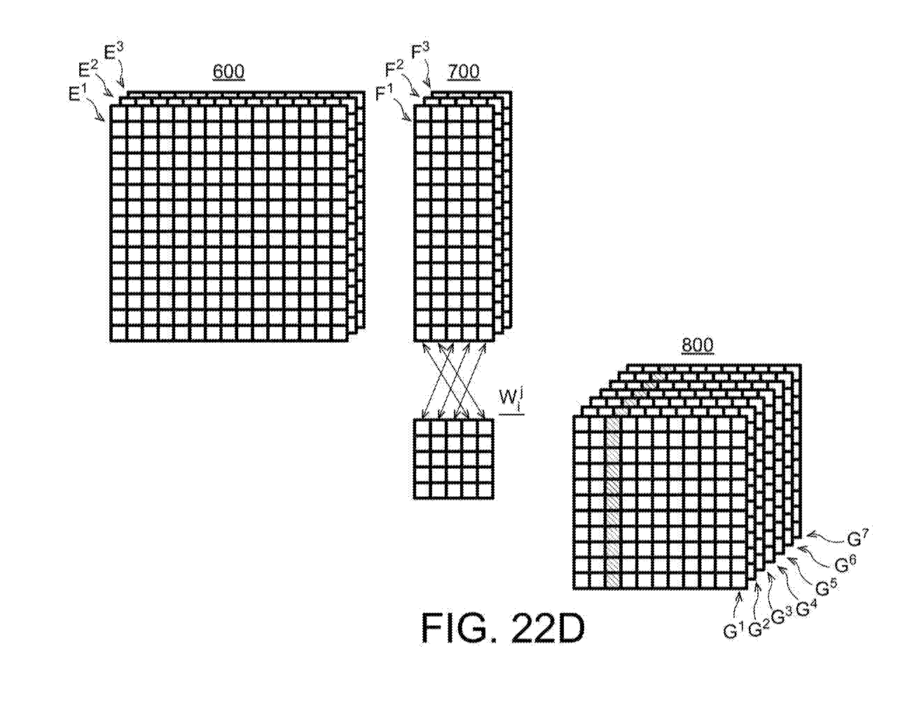

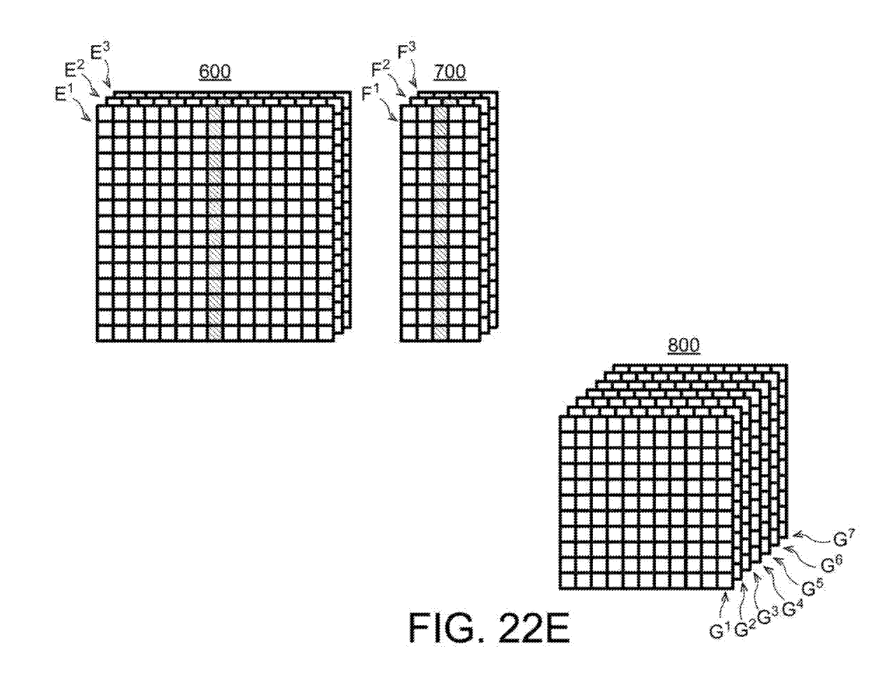

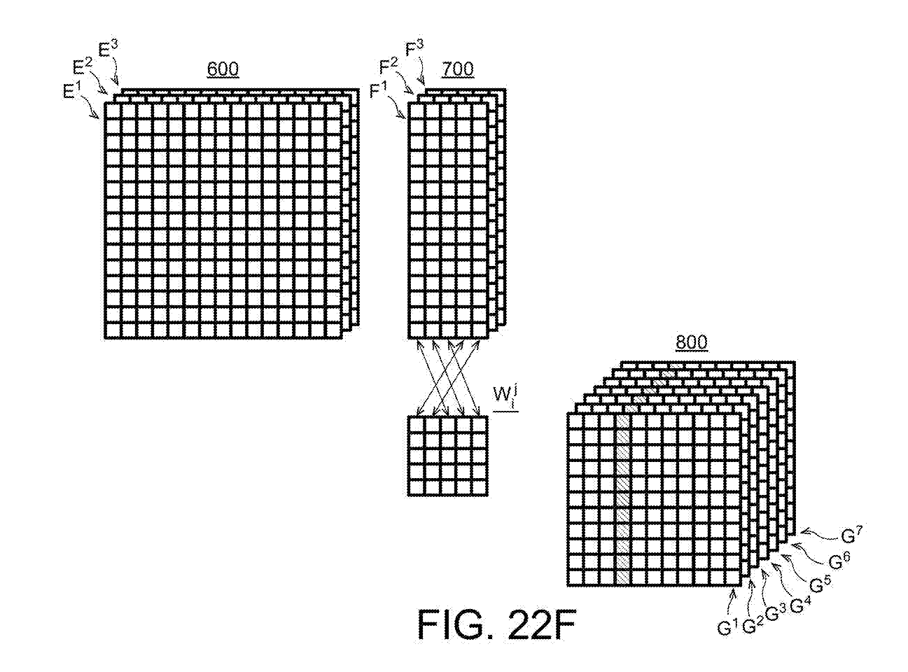

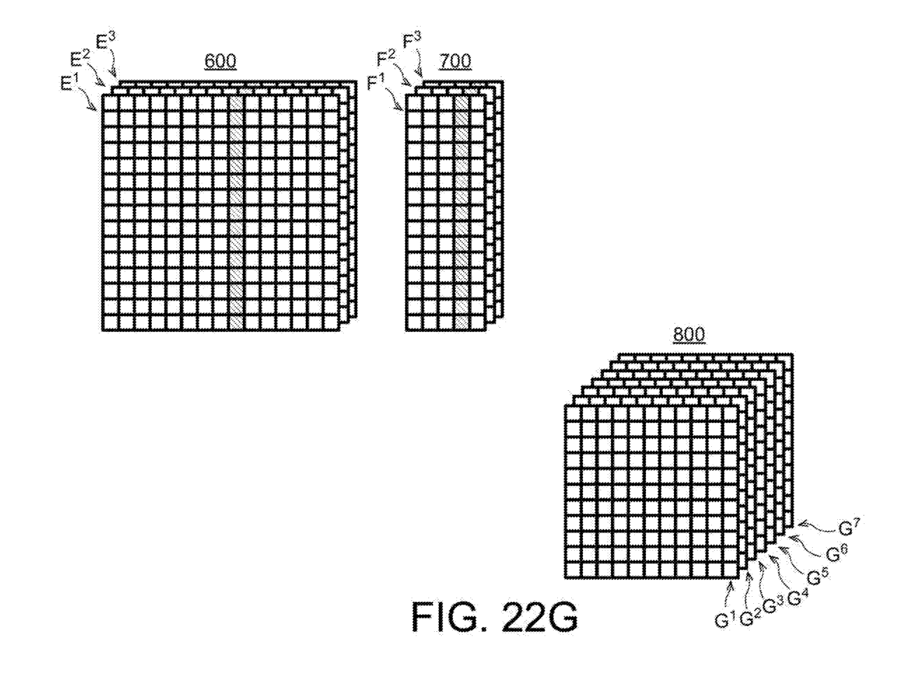

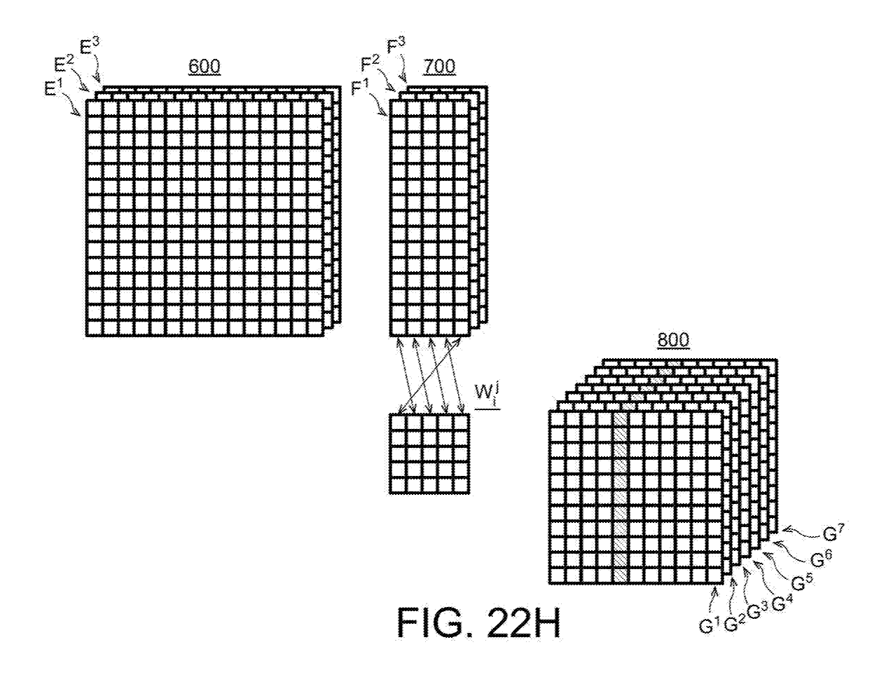

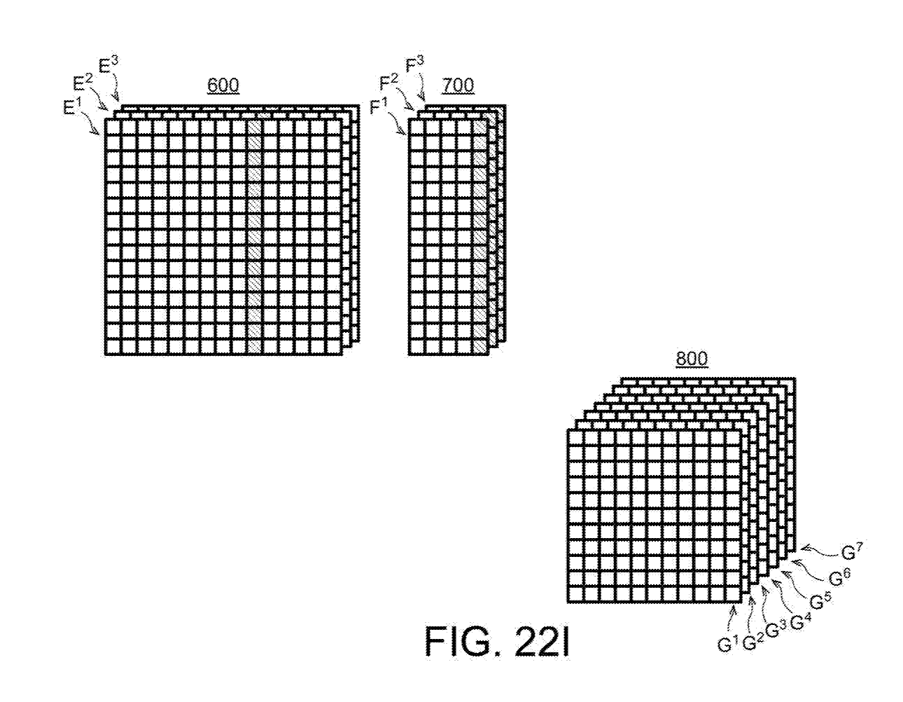

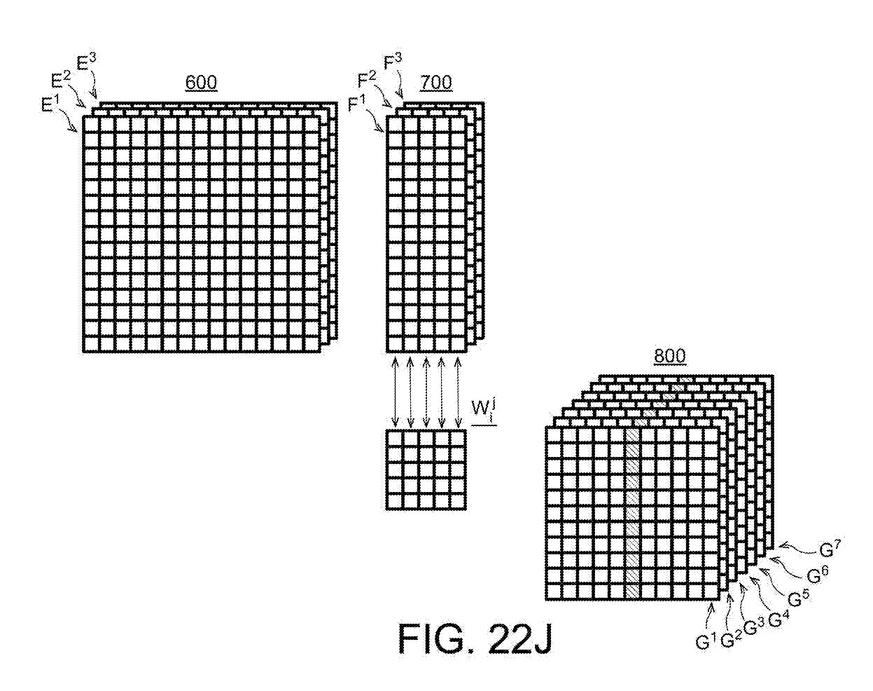

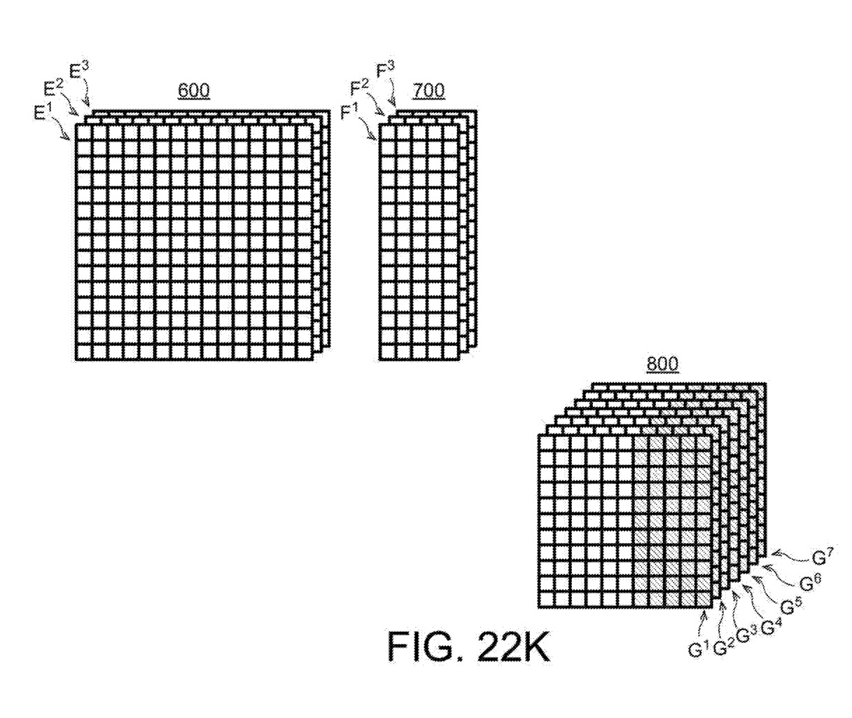

Subsequently, as shown in FIG. 22A, data of the sixth column of each of the arrays E¹ to E³ of the external storage device 600 is read out and replaced for the data stored in the memory element of the first column of each of the arrays F¹ to F³ of the storage device 700. At the time of this data replacement, the data read out of the second to fifth columns of the arrays E¹ to E³ of the external storage device 600 in the previous process have been stored in the memory elements in the second to fifth columns of the arrays F¹ to F³ of the storage device 700.

Subsequently, a convolution process is performed in the same manner as explained with reference to FIGS. 21A to 21D, using the first to seventh kernels W₁ to W₇ to the data of each of the arrays F¹ to F³. The result of process is stored in memory elements of the second column of the arrays G¹ to G⁷ of the storage device 800. In the convolution process, as shown in FIG. 22B, the product-to-sum is calculated between the memory elements in the first column of the array Wᵢ^{j} (j=1, 2, 3) of the i-th (i=1, . . . , 7) kernel and the corresponding memory elements in the second column of the array F^{j} of the storage medium 700, between the memory elements in the second column of the array Wᵢ^{j} (j=1, 2, 3) and the corresponding memory elements in the third column of the array F^{j} of the storage medium 700, between the memory elements in the third column of the array Wᵢ^{j} (j=1, 2, 3) and the corresponding memory elements in the fourth column of the array F^{j} of the storage medium 700, between the memory elements in the fourth column of the array Wᵢ^{j} (j=1, 2, 3) and the corresponding memory elements in the fifth column of the array F^{j} of the storage medium 700, and between the memory elements in the fifth column of the array Wᵢ^{j} (j=1, 2, 3) and the corresponding memory elements in the first column of the array F^{j} of the storage medium 700. The product-to-sum between the i-th (i=1, . . . , 7) kernel Wᵢ and the array F^{j} (j=1, 2, 3) of the storage device 700 is stored in the memory elements in the second column of the array Gⁱ of the storage device 800.

Thereafter, the bias value Bᵢ is added to each of the numerical values stored in the memory elements Gⁱ (1, 2) to Gⁱ (11, 2) of the second column of each array Gⁱ (i=1, . . . , 7) and an activation function process such as a rectified linear Unit (ReLU) function is applied to the numerical values as required, and then the numerical values are newly stored in the memory elements Gⁱ (1, 2) to Gⁱ (11, 1) of the second column of the array Gⁱ. In this way, as shown in FIG. 22B, data, for which the convolution process using the first to seventh kernels W₁ to W₇ to the second to sixth columns of the arrays E¹ to E³ of the external storage device 600 has been completed, are stored in the memory elements Gⁱ (1, 1) to Gⁱ (11, 1) of the second column of the i-th (i=1, . . . , 7) array Gⁱ of the storage device 800.

Subsequently, as shown in FIG. 22C, data of the seventh column of each of the arrays E¹ to E³ of the external storage device 600 is read out and replaced for the data stored in the memory elements of the second column of each of the arrays F¹ to F³ of the storage device 700. In detail, data read from the third to fifth columns of the arrays E¹ to E³ of the external storage device 600 are stored in the memory elements of the third to fifth columns of the arrays F¹ to F³ of the storage device 700 while data read from the sixth and seventh columns of the arrays E¹ to E³ of the external storage device 600 are stored in the memory elements of the first and second columns column of the arrays F¹ to F³ of the storage device 700.

Subsequently, a convolution process is performed in the same manner as explained with reference to FIGS. 21A to 21D, using the first to seventh kernels W₁ to W₇ to the data of each of the arrays F¹ to F³. The result of process is stored in memory elements of the third column of the arrays G¹ to G⁷ of the storage device 800. In this convolution process, as shown in FIG. 22D, the product-to-sum is calculated between the memory elements in the first column of the array Wᵢ^{j} (j=1, 2, 3) of the i-th (i=1, . . . , 7) kernel Wᵢ and the corresponding memory elements in the third column of the array F^{j} of the storage medium 700, between the memory elements in the second column of the array Wᵢ^{j} (j=1, 2, 3) and the corresponding memory elements in the fourth column of the array F^{j} of the storage medium 700, between the memory elements in the third column of the array Wᵢ^{j} (j=1, 2, 3) and the corresponding memory elements in the fifth column of the array F^{j} of the storage medium 700, between the memory elements in the fourth column of the array Wᵢ^{j} (j=1, 2, 3) and the corresponding memory elements in the first column of the array F^{j} of the storage medium 700, and between the memory elements in the fifth column of the array Wᵢ^{j} (j=1, 2, 3) and the corresponding memory elements in the second column of the array F^{j} of the storage medium 700. The product-to-sum between the i-th (i=1, . . . , 7) kernel Wᵢ and the arrays F^{j} (j=1, 2, 3) of the storage device 700 are stored in the memory elements in the third column of the array Gⁱ of the storage device 800.

Thereafter, the bias value Bᵢ is added to each of the numerical values stored in the memory elements Gⁱ (1, 3) to Gⁱ (11, 3) of the third column of each array Gⁱ (i=1, . . . , 7) and an activation function process such as a rectified linear Unit (ReLU) function is applied to the numerical values as required, and then the numerical values are newly stored in the memory elements Gⁱ (1, 3) to Gⁱ (11, 3) of the third column of the array Gⁱ. In this way, as shown in FIG. 22D, data, for which the convolution process using the first to seventh kernels W₁ to W₇ to the third to seventh columns of the arrays E¹ to E³ of the external storage device 600 has been completed, are stored in the memory elements Gⁱ (1, 3) to Gⁱ (11, 3) of the third column of the i-th (i=1, . . . , 7) array Gⁱ of the storage device 800.

Subsequently, as shown in FIG. 22E, data of the eighth column of each of the arrays E¹ to E³ of the external storage device 600 is read out and replaced for the data stored in the memory elements of the third column of each of the arrays F¹ to F³ of the storage device 700. In detail, data read from the fourth and fifth columns of the arrays E¹ to E³ of the external storage device 600 are stored in the memory elements of the fourth and fifth columns column of the arrays F¹ to F³ of the storage device 700 while data read from the sixth to eighth columns of the arrays E¹ to E³ of the external storage device 600 are stored in the memory elements of the first to third columns of the arrays F¹ to F³ of the storage device 700.

Subsequently, a convolution process is performed in the same manner as explained with reference to FIGS. 21A to 21D, using the first to seventh kernels W₁ to W₇ to data of each of the arrays F¹ to F³. The result of process is stored in memory elements of the fourth column of the arrays G¹ to G⁷ of the storage device 800. In this convolution process, as shown in FIG. 22F, the product-to-sum is calculated between the memory elements in the first column of the array Wᵢ^{j} (j=1, 2, 3) of the i-th (i=1, . . . , 7) kernel Wᵢ and the corresponding memory elements in the fourth column of the array F^{j} of the storage medium 700, between the memory elements in the second column of the array Wᵢ^{j} (j=1, 2, 3) and the corresponding memory elements in the fifth column of the array F^{j} of the storage medium 700, between the memory elements in the third column of the array Wᵢ^{j} (j=1, 2, 3) and the corresponding memory elements in the first column of the array F^{j} of the storage medium 700, between the memory elements in the fourth column of the array Wᵢ^{j} (j=1, 2, 3) and the corresponding memory elements in the second column of the array F^{j} of the storage medium 700, and between the memory elements in the fifth column of the array Wᵢ^{j} (j=1, 2, 3) and the corresponding memory elements in the third column of the array F^{j} of the storage medium 700. The product-to-sum between the i-th (i=1, . . . , 7) kernel Wᵢ and the arrays F^{j} (j=1, 2, 3) of the storage device 700 are stored in the memory elements in the fourth column of the array Gⁱ of the storage device 800.

Thereafter, the bias value Bᵢ is added to each of the numerical values stored in the memory elements Gⁱ (1, 4) to Gⁱ (11, 4) of the fourth column of each array Gⁱ (i=1, . . . , 7) and an activation function process such as a rectified linear Unit (ReLU) function is applied to the numerical values as required, and then the numerical values are newly stored in the memory elements Gⁱ (1, 4) to Gⁱ (11, 4) of the fourth column of the array Gⁱ. In this way, as shown in FIG. 22F, data, for which the convolution process using the first to seventh kernels W₁ to W₇ to the fourth to eighth columns of the arrays E¹ to E³ of the external storage device 600 has been completed, are stored in the memory elements Gⁱ (1, 4) to Gⁱ (11, 4) of the fourth column of the i-th (i=1, . . . , 7) array Gⁱ of the storage device 800.

Subsequently, as shown in FIG. 22G, data of the ninth column of each of the arrays E¹ to E³ of the external storage device 600 is read out and replaced for the data stored in the memory element of the fourth column of each of the arrays F¹ to F³ of the storage device 700. In detail, data read from the fifth column of the arrays E¹ to E³ of the external storage device 600 are stored in the memory elements of the fifth column of the arrays F¹ to F³ of the storage device 700 while data read from the sixth to ninth columns of the arrays E¹ to E³ of the external storage device 600 are stored in the memory elements of the first to fourth columns column of the arrays F¹ to F³ of the storage device 700.

Subsequently, a convolution process is performed in the same manner as explained with reference to FIGS. 21A to 21D, using the first to seventh kernels W₁ to W₇ to data of each of the arrays F¹ to F³. The result of process is stored in memory elements of the fifth column of the arrays G¹ to G⁷ of the storage device 800. In this convolution process, as shown in FIG. 22H, the product-to-sum is calculated between the memory elements in the first column of the array Wᵢ^{j} (j=1, 2, 3) of the i-th (i=1, . . . , 7) kernel and the corresponding memory elements in the fifth column of the array F^{j} of the storage medium 700, between the memory elements in the second column of the array Wᵢ^{j} (j=1, 2, 3) and the corresponding memory elements in the first column of the array F^{j} of the storage medium 700, between the memory elements in the third column of the array Wᵢ^{j} (j=1, 2, 3) and the corresponding memory elements in the second column of the array F^{j} of the storage medium 700, between the memory elements in the fourth column of the array Wᵢ^{j} (j=1, 2, 3) and the corresponding memory elements in the third column of the array F^{j} of the storage medium 700, and between the memory elements in the fifth column of the array Wᵢ^{j} (j=1, 2, 3) and the corresponding memory elements in the fourth column of the array F^{j} of the storage medium 700. The product-to-sum between the i-th (i=1, . . . , 7) kernel Wᵢ and the arrays F^{j} (j=1, 2, 3) of the storage device 700 are stored in the memory elements in the fifth column of the array Gⁱ of the storage device 800.

Thereafter, the bias value Bᵢ is added to each of the numerical values stored in the memory elements Gⁱ (1, 5) to Gⁱ (11, 5) of the fifth column of each array Gⁱ (i=1, . . . , 7) and an activation function process such as a rectified linear Unit (ReLU) function is applied to the numerical values as required, and then the numerical values are newly stored in the memory elements Gⁱ (1, 5) to Gⁱ (11, 5) of the fifth column of the array Gⁱ. In this way, as shown in FIG. 22H, data, for which the convolution process using the first to seventh kernels W₁ to W₇ to the fifth to ninth columns of the arrays E¹ to E³ of the external storage device 600 has been completed, are stored in the memory elements Gⁱ (1, 5) to Gⁱ (11, 5) of the fifth column of the i-th (i=1, . . . , 7) array Gⁱ of the storage device 800.

Subsequently, as shown in FIG. 22I, data of the tenth column of each of the arrays E¹ to E³ of the external storage device 600 is read out and replaced for the data stored in the memory element of the fifth column of each of the arrays F¹ to F³ of the storage device 700. In detail, data read from the sixth to ninth columns of the arrays E¹ to E³ of the external storage device 600 are stored in the memory elements of the first to fourth columns of the arrays F¹ to F³ of the storage device 700.

Subsequently, a convolution process is performed in the same manner as explained with reference to FIGS. 21A to 21D, using the first to seventh kernels W₁ to W₇ to data of each of the arrays F¹ to F³. The result of process is stored in memory elements of the sixth column of the arrays G¹ to G⁷ of the storage device 800. In this convolution process, as shown in FIG. 22J, the product-to-sum is calculated between the memory elements in the first column of the array Wᵢ^{j} (j=1, 2, 3) of the i-th (i=1, . . . , 7) kernel and the corresponding memory elements in the first column of the array F^{j} of the storage medium 700, between the memory elements in the second column of the array Wᵢ^{j} (j=1, 2, 3) and the corresponding memory elements in the second column of the array F^{j} of the storage medium 700, between the memory elements in the third column of the array Wᵢ^{j} (j=1, 2, 3) and the corresponding memory elements in the third column of the array F^{j} of the storage medium 700, between the memory elements in the fourth column of the array Wᵢ^{j} (j=1, 2, 3) and the corresponding memory elements in the fourth column of the array F^{j} of the storage medium 700, and between the memory elements in the fifth column of the array Wᵢ^{j} (j=1, 2, 3) and the corresponding memory elements in the fifth column of the array F^{j} of the storage medium 700. The product-to-sum between the i-th (i=1, . . . , 7) kernel Wᵢ and the arrays F^{j} (j=1, 2, 3) of the storage device 700 are stored in the memory elements in the sixth column of the array Gⁱ of the storage device 800.

Thereafter, the bias value Bᵢ is added to each of the numerical values stored in the memory elements Gⁱ (1, 6) to Gⁱ (11, 6) of the sixth column of each array Gⁱ (i=1, . . . , 7) and an activation function process such as a rectified linear Unit (ReLU) function is applied to the numerical values as required, and then the numerical values are newly stored in the memory elements Gⁱ (1, 6) to Gⁱ (11, 6) of the sixth column of the array Gⁱ. In this way, as shown in FIG. 22J, data, for which the convolution process using the first to seventh kernels W₁ to W₇ to the sixth to tenth columns of the arrays E¹ to E³ of the external storage device 600 has been completed, are stored in the memory elements Gⁱ (1, 6) to Gⁱ (11, 6) of the sixth column of the i-th (i=1, . . . , 7) array Gⁱ of the storage device 800.

Subsequently, in the same manner as explained with reference to FIG. 22A, data of memory elements in the eleventh column of the arrays E¹ to E³ of the external storage device 600 is read out and stored in the memory elements of the first column of the arrays F¹ to F³ of the storage device 700. Thereafter, a convolution process in the same manner as explained with reference to FIG. 22B is performed and the result of this convolution process is stored in memory elements of the seventh column of the array Gⁱ (i=1, . . . , 7) of the storage device 800.

Subsequently, in the same manner as explained with reference to FIG. 22C, data of memory elements in the twelfth column of the arrays E¹ to E³ of the external storage device 600 is read out and stored in the memory elements of the second column of the arrays F¹ to F³ of the storage device 700. Thereafter, a convolution process in the same manner as explained with reference to FIG. 22D is performed and the result of this convolution process is stored in memory elements of the eighth column of the array Gⁱ (i=1, . . . , 7) of the storage device 800.

Subsequently, in the same manner as explained with reference to FIG. 22E, data of memory elements in the thirteenth column of the arrays E¹ to E³ of the external storage device 600 is read out and stored in the memory elements of the third column of the arrays F¹ to F³ of the storage device 700. Thereafter, a convolution process in the same manner as explained with reference to FIG. 22F is performed and the result of this convolution process is stored in memory elements of the ninth column of the array Gⁱ (i=1, . . . , 7) of the storage device 800.

Subsequently, in the same manner as explained with reference to FIG. 22G, data of memory elements in the fourteenth column of the arrays E¹ to E³ of the external storage device 600 is read out and stored in the memory elements of the fourth column of the arrays F¹ to F³ of the storage device 700. Thereafter, a convolution process in the same manner as explained with reference to FIG. 22H is performed and the result of this convolution process is stored in memory elements of the tenth column of the array Gⁱ (i=1, . . . , 7) of the storage device 800.

Subsequently, in the same manner as explained with reference to FIG. 22I, data of memory elements in the fifteenth column of the arrays E¹ to E³ of the external storage device 600 is read out and stored in the memory elements of the fifth column of the arrays F¹ to F³ of the storage device 700. Thereafter, a convolution process in the same manner as explained with reference to FIG. 22J is performed and the result of this convolution process is stored in memory elements of the eleventh column of the array Gⁱ (i=1, . . . , 7) of the storage device 800.

Subsequently, the bias value Bᵢ is added to the numerical value stored in each memory element of each array Gⁱ (i=1, . . . , 7) and an activation function process such as a rectified linear Unit (ReLU) function is applied to the numerical value as required, and then the numerical value is newly stored in each memory element of the array Gⁱ. In this way, as shown in FIG. 22K, data, for which the convolution process using the first to seventh kernels W₁ to W₇ to the seventh to fifteenth columns of the arrays E¹ to E³ of the external storage device 600 has been completed, are stored in the memory elements of the seventh to eleventh columns of the arrays G¹ to G⁷ of the storage device 800.

Through the procedure described above, the result of the convolution processes using the first to seventh kernels W₁ to W₇ to the memory elements of the arrays E¹ to E³ of the external storage device 600 is stored in the memory elements of the arrays G¹ to G⁷ that configure the storage device 800. In the process to store data (numerical values) in the memory elements of the arrays G¹ to G⁷ of the storage device 800 in the above process, the processes to different arrays G^{m} (m=1, . . . , 7) can be executed in parallel. The parallel processing is advantageous in shortening the process time.

The first modification uses the storage device having the same size and depth as the arrays E¹ to E³ in the row and depth directions. Not only limited to this storage device, the same effect is given with a storage device having a different size or depth from the arrays E¹ to E³ in the row or depth direction. Especially, a kernel having the same size and depth as the arrays E¹ to E³ in the row and depth directions gives the maximum effect on decrease in capacity of the storage device 700.

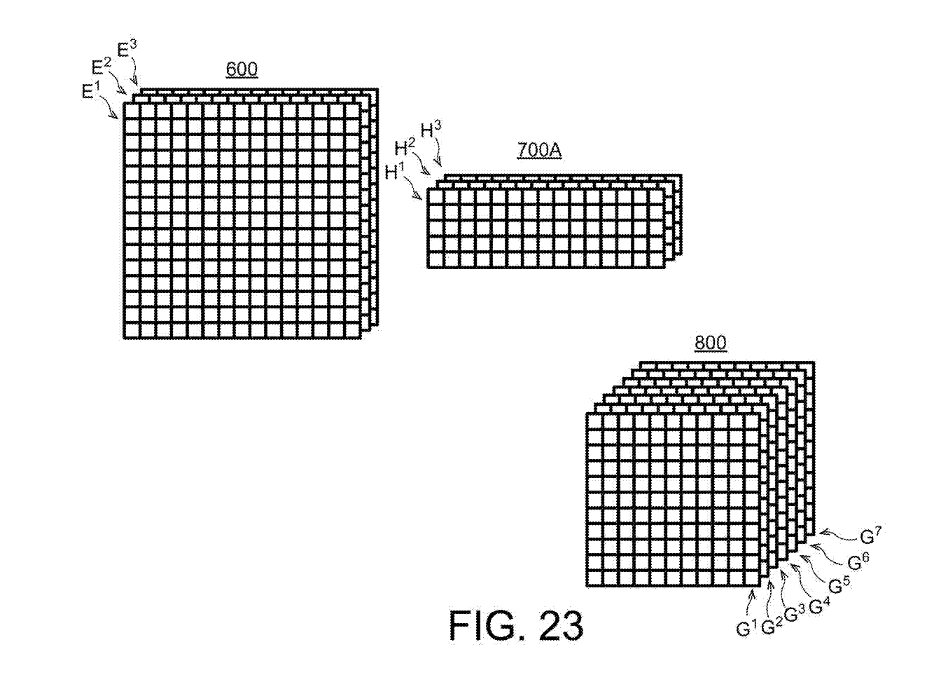

The arithmetic processing device according to the first modification uses the same storage device as the arrays E¹ to E³ of the external storage device 600 in the row and depth directions as shown in FIG. 19. However, the same effect is given, for example, as shown in FIG. 23, with a storage device 700A having arrays H¹ to H³, which are the same as the arrays E¹ to E³ in the depth and column directions, and have the same rows as the kernels in the row direction. In this case, through the processes explained with reference to FIGS. 20 to 22K, with exchanged coordinates between the column and row directions in the drawings, numerical values applied with necessary processes are stored in all of the storage devices that configure the storage device 800. It is so far specified that a storage device is provided to have the same size or depth in the in-plane direction in the drawings as the size or depth of the arrays of the external storage device in the depth or column direction in the drawings and, in the column direction, to have the same size as the size of the kernels to be used in the convolution processes in the in-plane direction in the drawings. Not only limited to this, the same effect is given with the depth or size in the in-plane direction equal to or larger than the depth or size of the external storage device 600 in the depth or column direction in the drawings and, in the row direction, with the size equal to or larger than the size of the kernels to be used in the convolution processes in the in-plane direction. Especially, the same size or depth in the in-plane direction in the drawings as the size or depth of the arrays of the external storage device in the depth or column direction in the drawings and, in the column direction, the same size as the size of the kernels to be used in the convolution processes in the in-plane direction in the drawings, give the maximum effect on decrease in the number of storage devices.

(Second Modification)

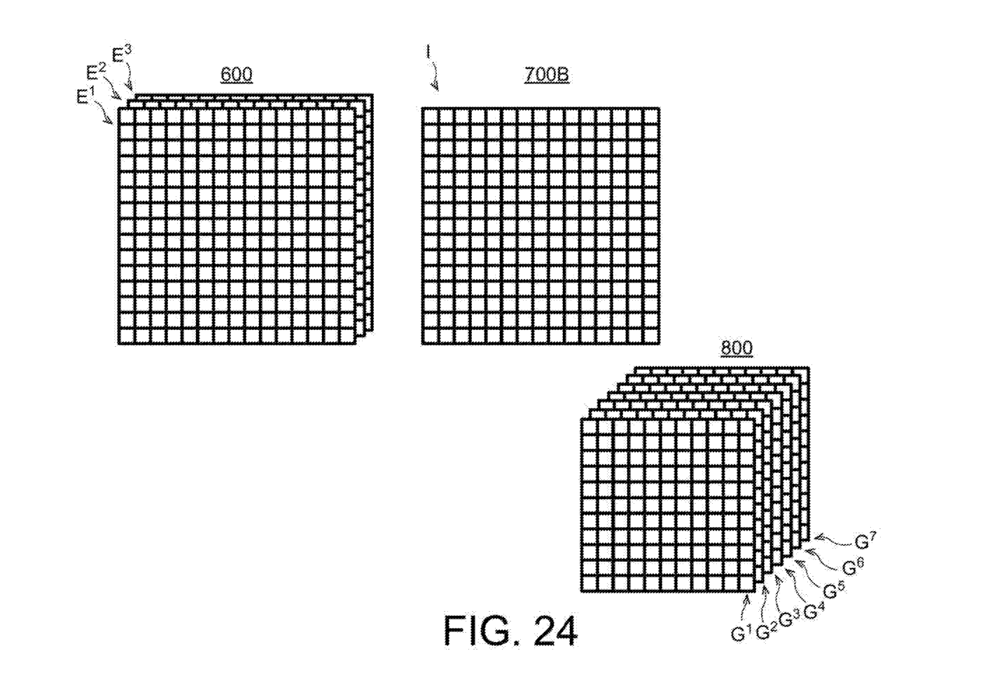

Subsequently, FIG. 24 shows an arithmetic processing device according to a second modification of the third embodiment. The arithmetic processing device of the second modification includes the same configuration as the arithmetic processing device of the third embodiment shown in FIG. 18, except for a storage device 700B replaced for the storage device 700.

The storage device 700B includes a single array I having the same size as each of the arrays E¹ to E³ of the storage device 600. In other words, the array I has memory elements arranged in fifteen rows and fifteen columns. Although, there is one array I as an example in the second modification, there is no necessity for the array I to have a depth of one, and it is a matter of course that the same effect is given with another depth.

(Operation)

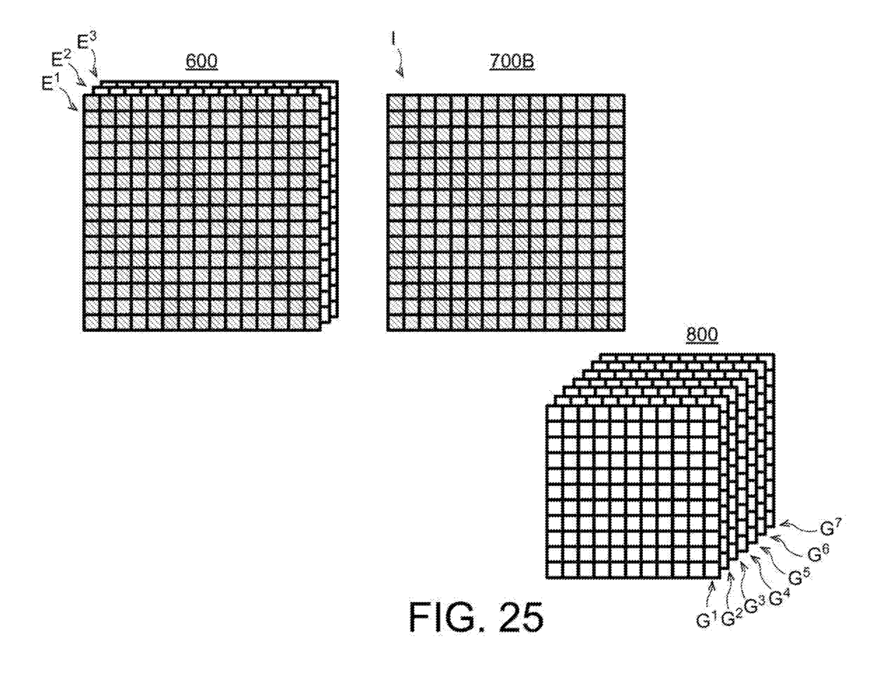

Subsequently, an operation of the arithmetic processing device of the second modification will be explained with reference to FIGS. 25 to 28.

First of all, as shown in FIG. 25, data stored in the memory elements of the array E¹ of the external storage device 600 is read out and stored in the corresponding memory elements of the array I of the storage device 700B. In detail, data stored in memory elements E¹ (m, n) in m rows and n columns of the array E¹ is stored in the corresponding memory elements I (m, n) of the array I.

Succeedingly, a convolution process is performed to data stored in memory elements W₁¹ (1, 1) to W₁¹ (5, 1) of the first column of the array W₁¹ of the first kernel W₁ and data stored in memory elements I (1, 1) to I (15, 1) of the first column of the array I. This convolution process is performed as follows.

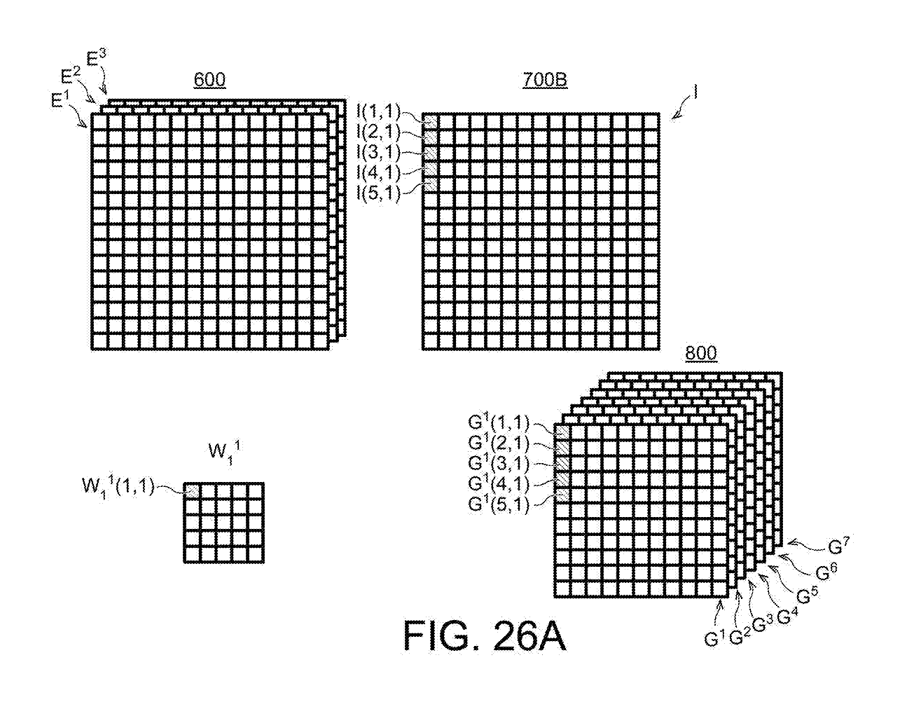

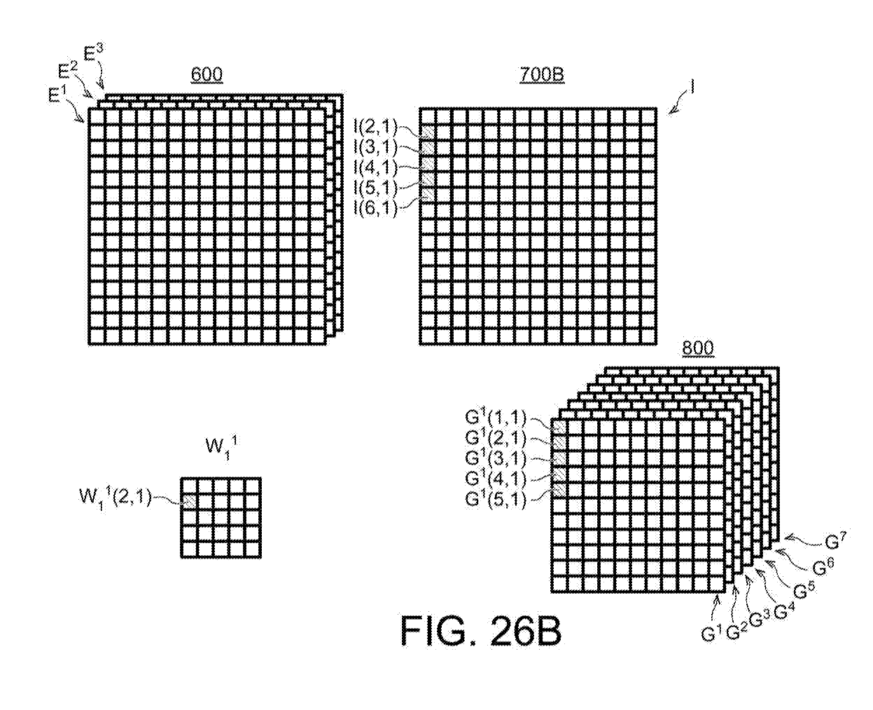

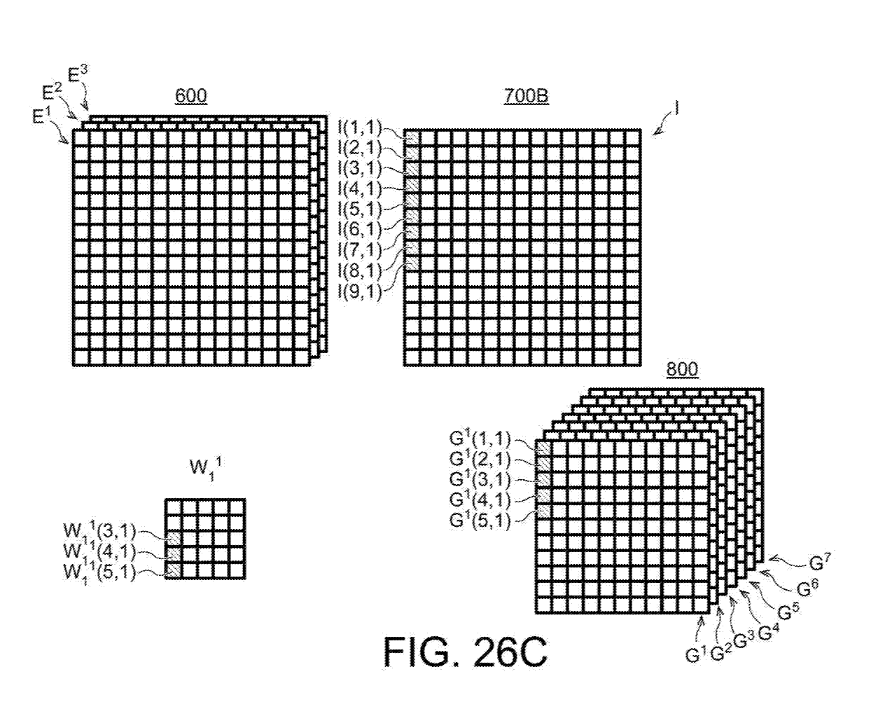

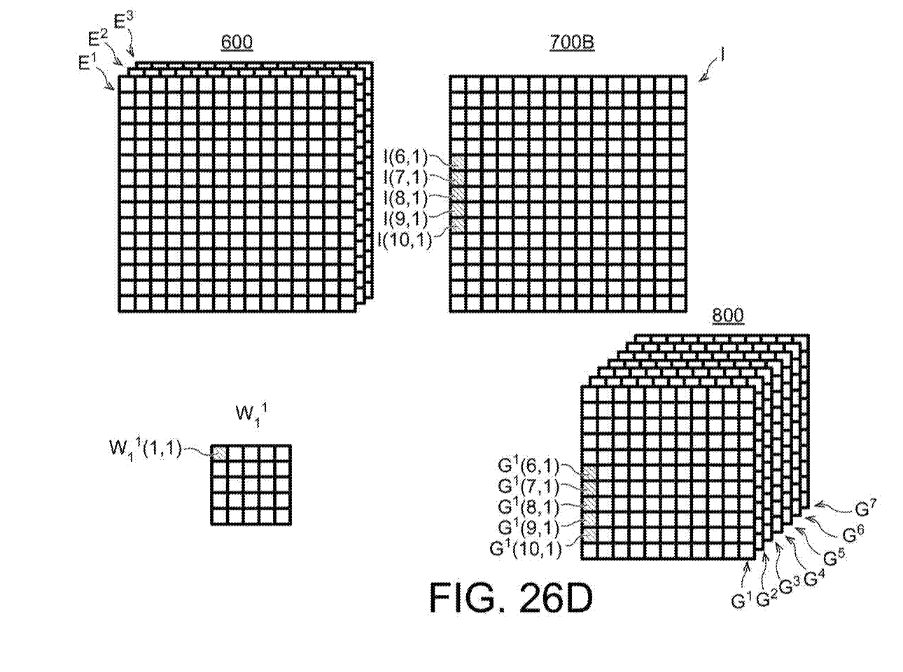

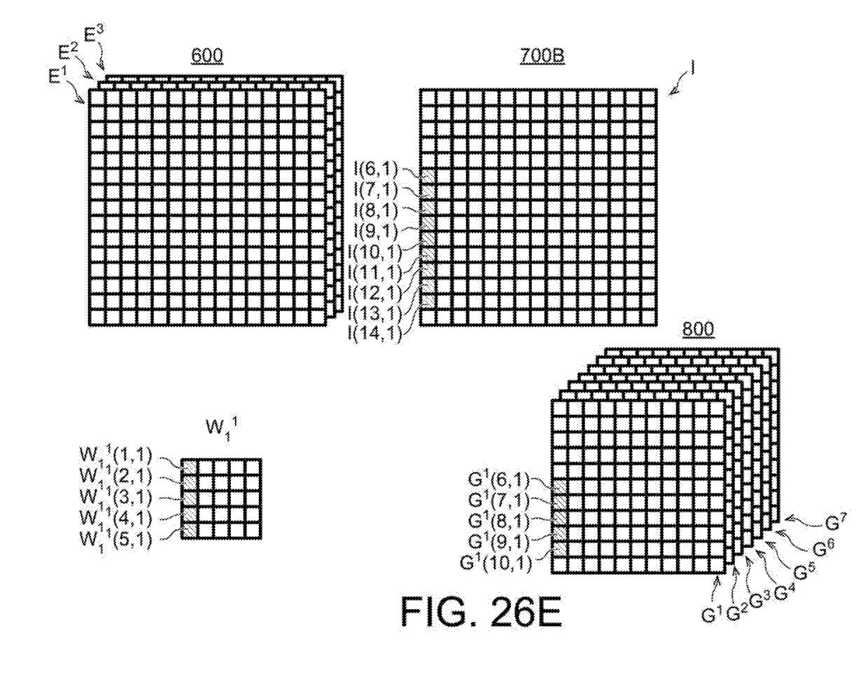

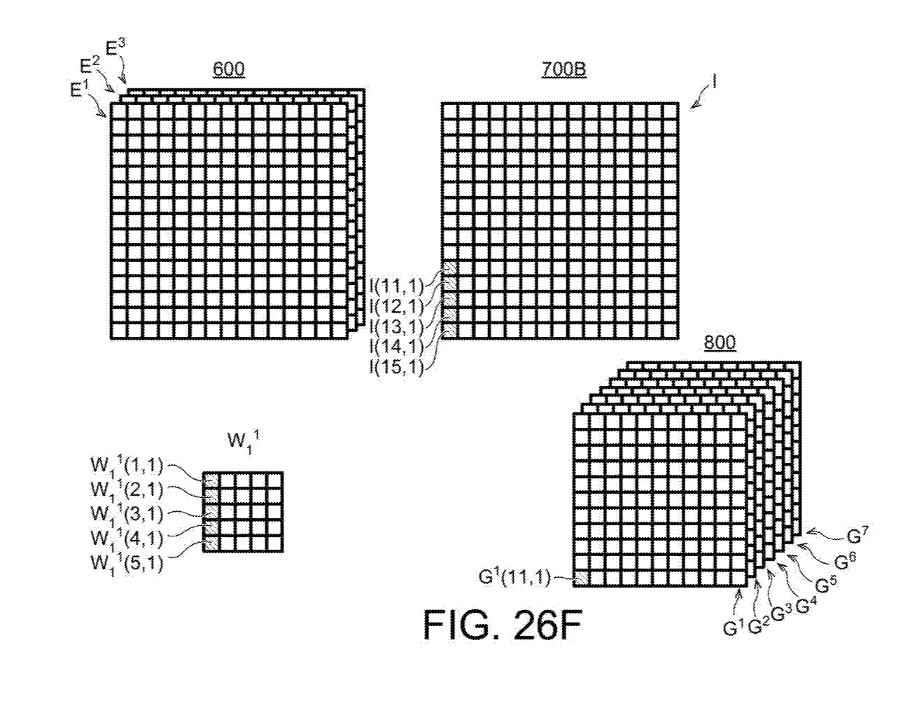

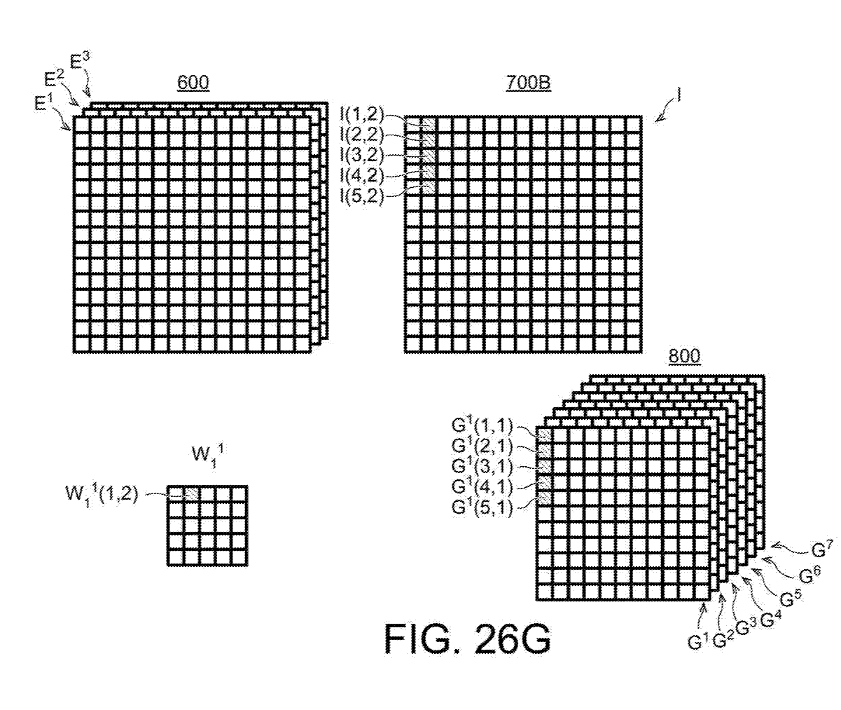

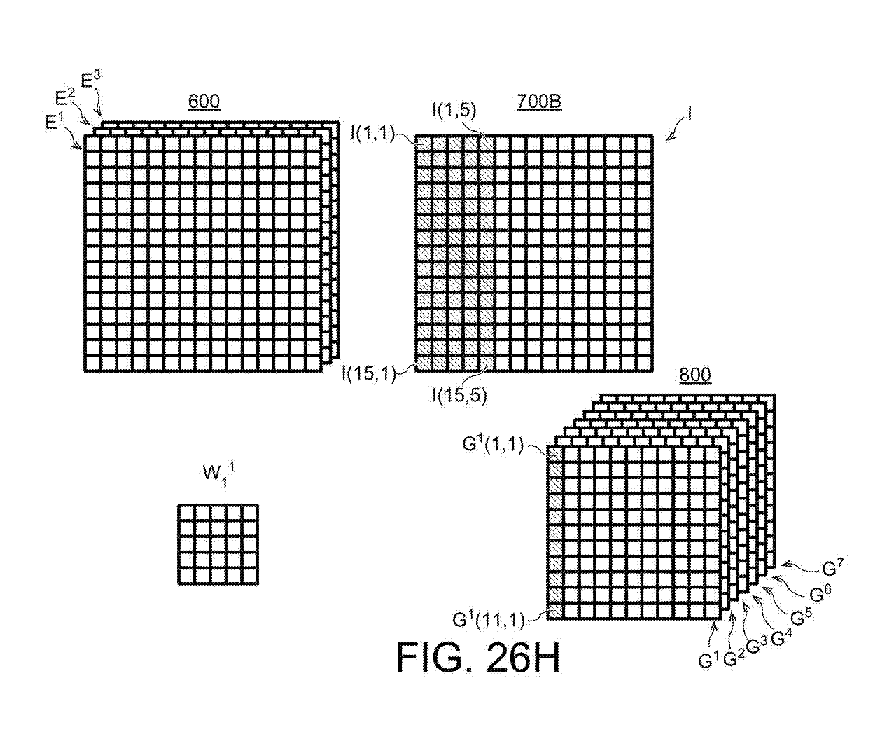

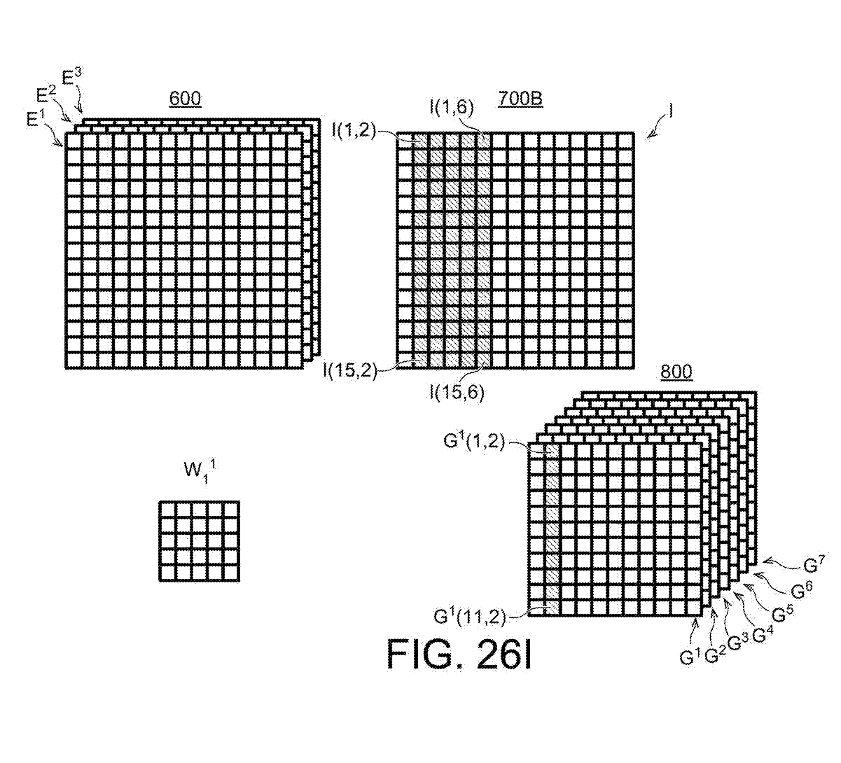

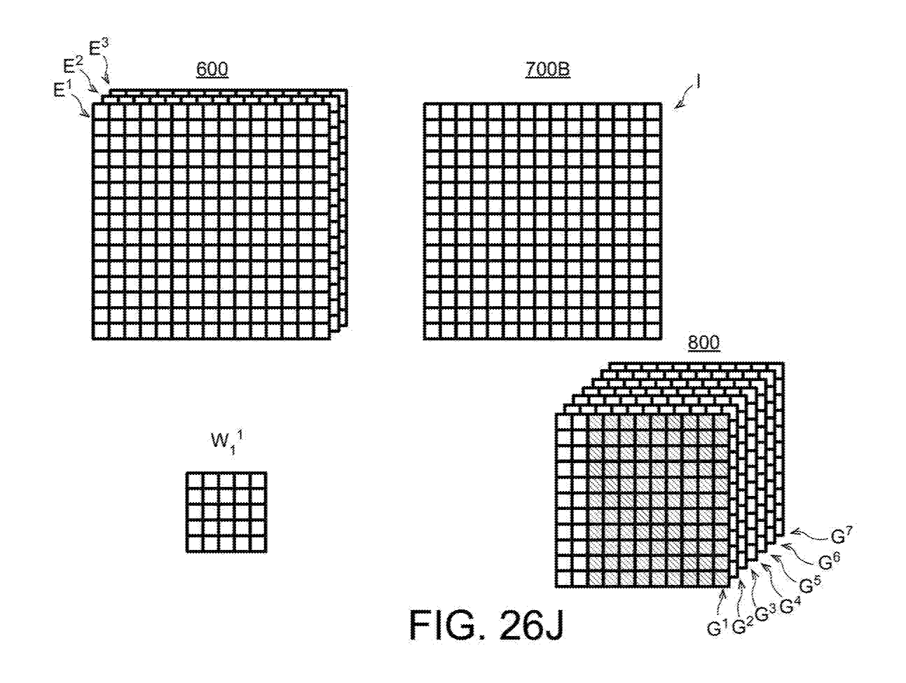

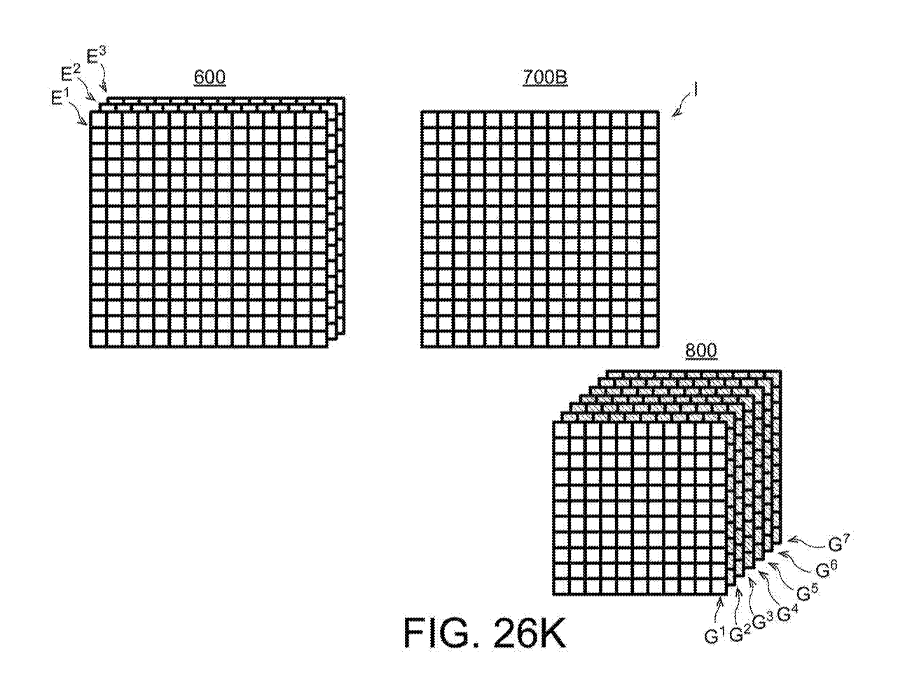

First of all, as shown in FIG. 26A, a product of data stored in a memory element W₁¹ (1, 1) in the first row and first column of the array W₁¹ of the first kernel W₁ and data stored in a memory element I (1, 1) in the first row and first column of the array I is calculated and stored in a memory element G¹ (1, 1) in the first row and first column of the array G¹ of the storage device 800. Thereafter, a product of the data stored in the memory element W₁¹ (1, 1) in the first row and first column of the array W₁¹ and data stored in a memory element I (2, 1) in the second row and first column of the array I is calculated and stored in a memory element G¹ (2, 1) in the second row and first column of the array G¹ of the storage device 800. A product of the data stored in the memory element W₁¹ (1, 1) in the first row and first column of the array W₁¹ and data stored in a memory element I (3, 1) in the third row and first column of the array I is calculated and stored in a memory element G¹ (3, 1) in the third row and first column of the array G¹ of the storage device 800. Succeedingly, a product of the data stored in the memory element W₁¹ (1, 1) in the first row and first column of the array W₁¹ and data stored in a memory element I (4, 1) in the fourth row and first column of the array I is calculated and stored in a memory element G¹ (4, 1) in the fourth row and first column of the array G¹ of the storage device 800. Thereafter, a product of the data stored in the memory element W₁¹ (1, 1) in the first row and first column of the array W₁¹ and data stored in a memory element I (5, 1) in the fifth row and first column of the array I is calculated and stored in a memory element G¹ (5, 1) in the fifth row and first column of the array G¹ of the storage device 800. The result of these processes is shown in FIG. 26A. These processes can be executed in parallel. The parallel processing is advantageous in shortening the process time.

Subsequently, as shown in FIG. 26B, a product of data stored in a memory element W₁¹ (2, 1) in the second row and first column of the array W₁¹ of the first kernel W₁ and the data stored in the memory element I (2, 1) in the second row and first column of the array I is calculated and a sum of this product and the data stored in the memory element G¹ (1, 1) in the first row and first column of the array G¹ is calculated and newly stored in the memory element G¹ (1, 1) in the first row and first column of the array G¹. Succeedingly, a product of the data stored in the memory element W₁¹ (2, 1) in the second row and first column of the array W₁¹ and the data stored in the memory element I (3, 1) in the third row and first column of the array I is calculated and a sum of this product and the data stored in the memory element G¹ (2, 1) in the second row and first column of the array G¹ is calculated and newly stored in the memory element G¹ (2, 1) in the second row and first column of the array G¹. Thereafter, a product of the data stored in the memory element W₁¹ (2, 1) in the second row and first column of the array W₁¹ and the data stored in the memory element I (4, 1) in the fourth row and first column of the array I is calculated and a sum of this product and the data stored in the memory element G¹ (3, 1) in the third row and first column of the array G¹ is calculated and newly stored in the memory element G¹ (3, 1) in the third row and first column of the array G¹. Succeedingly, a product of the data stored in the memory element W₁¹ (2, 1) in the second row and first column of the array W₁¹ and the data stored in the memory element I (5, 1) in the fifth row and first column of the array I is calculated and a sum of this product and the data stored in the memory element G¹ (4, 1) in the fourth row and first column of the array G¹ is calculated and newly stored in the memory element G¹ (4, 1) in the fourth row and first column of the array G¹. Thereafter, a product of the data stored in the memory element W₁¹ (2, 1) in the second row and first column of the array W₁¹ and data stored in a memory element I (6, 1) in the sixth row and first column of the array I is calculated and a sum of this product and the data stored in the memory element G¹ (5, 1) in the fifth row and first column of the array G¹ is calculated and newly stored in the memory element G¹ (5, 1) in the fifth row and first column of the array G¹. The result of these processes is shown in FIG. 26B. These processes can be executed in parallel. The parallel processing is advantageous in shortening the process time.

Subsequently, a product of data stored in a memory element W₁¹ (3, 1) in the third row and first column of the array W₁¹ of the first kernel W₁ and the data stored in the memory element I (3, 1) in the third row and first column of the array I is calculated and a sum of this product and the data stored in the memory element G¹ (1, 1) in the first row and first column of the array G¹ is calculated and newly stored in the memory element G¹ (1, 1) in the first row and first column of the array G¹. Succeedingly, a product of the data stored in the memory element W₁¹ (3, 1) in the third row and first column of the array W₁¹ and the data stored in the memory element I (4, 1) in the fourth row and first column of the array I is calculated and a sum of this product and the data stored in the memory element G¹ (2, 1) in the second row and first column of the array G¹ is calculated and newly stored in the memory element G¹ (2, 1) in the second row and first column of the array G¹. Thereafter, a product of the data stored in the memory element W₁¹ (3, 1) in the third row and first column of the array W₁¹ and the data stored in the memory element I (5, 1) in the fifth row and first column of the array I is calculated and a sum of this product and the data stored in the memory element G¹ (3, 1) in the third row and first column of the array G¹ is calculated and newly stored in the memory element G¹ (3, 1) in the third row and first column of the array G¹. Succeedingly, a product of the data stored in the memory element W,¹ (3, 1) in the third row and first column of the array W₁¹ and the data stored in the memory element I (6, 1) in the sixth row and first column of the array I is calculated and a sum of this product and the data stored in the memory element G¹ (4, 1) in the fourth row and first column of the array G¹ is calculated and newly stored in the memory element G¹ (4, 1) in the fourth row and first column of the array G¹. Thereafter, a product of the data stored in the memory element W₁¹ (3, 1) in the third row and first column of the array W₁¹ and data stored in a memory element I (7, 1) in the seventh row and first column of the array I is calculated and a sum of this product and the data stored in the memory element G¹ (5, 1) in the fifth row and first column of the array G¹ is calculated and newly stored in the memory element G¹ (5, 1) in the fifth row and first column of the array G¹. The result of these processes is shown in FIG. 26B. These processes can be executed in parallel. The parallel processing is advantageous in shortening the process time.

Subsequently, a product of data stored in a memory element W₁¹ (4, 1) in the fourth row and first column of the array W₁¹ of the first kernel W₁ and the data stored in the memory element I (4, 1) in the fourth row and first column of the array I is calculated and a sum of this product and the data stored in the memory element G¹ (1, 1) in the first row and first column of the array G¹ is calculated and newly stored in the memory element G¹ (1, 1) in the first row and first column of the array G¹. Succeedingly, a product of the data stored in the memory element W₁¹ (4, 1) in the fourth row and first column of the array W₁¹ and the data stored in the memory element I (5, 1) in the fifth row and first column of the array I is calculated and a sum of this product and the data stored in the memory element G¹ (2, 1) in the second row and first column of the array G¹ is calculated and newly stored in the memory element G¹ (2, 1) in the second row and first column of the array G¹. Thereafter, a product of the data stored in the memory element W₁¹ (4, 1) in the fourth row and first column of the array W₁¹ and the data stored in the memory element I (6, 1) in the sixth row and first column of the array I is calculated and a sum of this product and the data stored in the memory element G¹ (3, 1) in the third row and first column of the array G¹ is calculated and newly stored in the memory element G¹ (3, 1) in the third row and first column of the array G¹. Succeedingly, a product of the data stored in the memory element W₁¹ (4, 1) in the fourth row and first column of the array W₁¹ and the data stored in the memory element I (7, 1) in the seventh row and first column of the array I is calculated and a sum of this product and the data stored in the memory element G¹ (4, 1) in the fourth row and first column of the array G¹ is calculated and newly stored in the memory element G¹ (4, 1) in the fourth row and first column of the array G¹. Thereafter, a product of the data stored in the memory element W₁¹ (4, 1) in the fourth row and first column of the array W₁¹ and data stored in a memory element I (8, 1) in the eighth row and first column of the array I is calculated and a sum of this product and the data stored in the memory element G¹ (5, 1) in the fifth row and first column of the array G¹ is calculated and newly stored in the memory element G¹ (5, 1) in the fifth row and first column of the array G¹. These processes can be executed in parallel. The parallel processing is advantageous in shortening the process time.

Subsequently, a product of data stored in a memory element W₁¹ (5, 1) in the fifth row and first column of the array W₁¹ of the first kernel W₁ and the data stored in the memory element I (5, 1) in the fifth row and first column of the array I is calculated and a sum of this product and the data stored in the memory element G¹ (1, 1) in the first row and first column of the array G¹ is calculated and newly stored in the memory element G¹ (1, 1) in the first row and first column of the array G¹. Succeedingly, a product of the data stored in the memory element W₁¹ (5, 1) in the fifth row and first column of the array W₁¹ and the data stored in the memory element I (6, 1) in the sixth row and first column of the array I is calculated and a sum of this product and the data stored in the memory element G¹ (2, 1) in the second row and first column of the array G¹ is calculated and newly stored in the memory element G¹ (2, 1) in the second row and first column of the array G¹. Thereafter, a product of the data stored in the memory element W₁¹ (5, 1) in the fifth row and first column of the array W₁¹ and the data stored in the memory element I (7, 1) in the seventh row and first column of the array I is calculated and a sum of this product and the data stored in the memory element G¹ (3, 1) in the third row and first column of the array G¹ is calculated and newly stored in the memory element G¹ (3, 1) in the third row and first column of the array G¹. Succeedingly, a product of the data stored in the memory element W₁¹ (5, 1) in the fifth row and first column of the array W₁¹ and the data stored in the memory element I (8, 1) in the eighth row and first column of the array I is calculated and a sum of this product and the data stored in the memory element G¹ (4, 1) in the fourth row and first column of the array G¹ is calculated and newly stored in the memory element G¹ (4, 1) in the fourth row and first column of the array G¹. Thereafter, a product of the data stored in the memory element W₁¹ (5, 1) in the fifth row and first column of the array W₁¹ and data stored in a memory element I (9, 1) in the ninth row and first column of the array I is calculated and a sum of this product and the data stored in the memory element G¹ (5, 1) in the fifth row and first column of the array G¹ is calculated and newly stored in the memory element G¹ (5, 1) in the fifth row and first column of the array G¹. These processes can be executed in parallel. The parallel processing is advantageous in shortening the process time. The result of the above process is shown in FIG. 26C.

Subsequently, as shown in FIG. 26D, a product of the data stored in the memory element W₁¹ (1, 1) in the first row and first column of the array W₁¹ of the first kernel W₁ and the data stored in the memory element I (6, 1) in the sixth row and first column of the array I is calculated and stored in a memory element G¹ (6, 1) in the sixth row and first column of the array G¹. Thereafter, a product of the data stored in the memory element W₁¹ (1, 1) in the first row and first column of the array W₁¹ and the data stored in the memory element I (7, 1) in the seventh row and first column of the array I is calculated and stored in a memory element G¹ (7, 1) in the seventh row and first column of the array G¹. Thereafter, a product of the data stored in the memory element W₁¹ (1, 1) in the first row and first column of the array W₁¹ and the data stored in the memory element I (8, 1) in the eighth row and first column of the array I is calculated and stored in a memory element G¹ (8, 1) in the eighth row and first column of the array G¹. Succeedingly, a product of the data stored in the memory element W₁¹ (1, 1) in the first row and first column of the array W₁¹ and the data stored in the memory element I (9, 1) in the ninth row and first column of the array I is calculated and stored in a memory element G¹ (9, 1) in the ninth row and first column of the array G¹. Thereafter, a product of the data stored in the memory element W₁¹ (1, 1) in the first row and first column of the array W₁¹ and data stored in a memory element I (10, 1) in the tenth row and first column of the array I is calculated and stored in a memory element G¹ (10, 1) in the tenth row and first column of the array G¹. These processes can be executed in parallel. The parallel processing is advantageous in shortening the process time.

Subsequently, convolution processes in the same manner as explained with reference to FIGS. 26B and 26C are performed using the data W₁¹ (1, 1) to W₁¹ (5, 1) stored in the first column of the array W₁¹ of the first kernel W₁ to the data stored in the memory elements I (7, 1) to I (14, 1) in the seventh row and first column to the fourteenth row and first column of the array I. The result of these convolution processes is stored in the memory elements G¹ (7, 1) to G¹ (10, 1) in the seventh row and first column to the tenth row and first column of the array G¹. The result of these processes is shown in FIG. 26E

Subsequently, as shown in FIG. 26F, convolution processes are performed using the data W₁¹ (1, 1) to W₁¹ (5, 1) in the first column of the array W₁¹ of the first kernel W₁ to the data I (11, 1) to I (15, 1) in the eleventh row and first column to the fifteenth row and first column of the array I. The result of processes is stored in a memory element G¹ (15, 1) in the fifteenth row and first column of the array G¹.

Through the processes described above, the convolution process between the data stored in the memory elements W₁¹ (1, 1) to W₁¹ (5, 1) in the first column of the array W₁¹ of the first kernel W₁¹ and the data stored in the memory elements I (11, 1) to I (15, 1) in the first column of the array I is complete.

Subsequently, a convolution process is performed using data stored in memory elements W₁¹ (1, 2) to W₁¹ (5, 2) of the second column of the array W₁¹ of the first kernel W₁¹ to data stored in memory elements I (1, 2) to I (15, 2) of the second column of the array I. This convolution process is performed as follows.

First of all, as shown in FIG. 26G, a product of data stored in a memory element W₁¹ (1, 2) in the first row and second column of the array W₁¹ and data stored in a memory element I (1, 2) in the first row and second column of the array I is calculated and a sum of this product and the data stored in the memory element G¹ (1, 1) in the first row and first column of the array G¹ is calculated and newly stored in the memory element G¹ (1, 1) in the first row and first column of the array G¹ of the storage device 800. Thereafter, a product of the data stored in the memory element W₁¹ (1, 2) in the first row and second column of the array W₁¹ and data stored in a memory element I (2, 2) in the second row and second column of the array I is calculated and a sum of this product and the data stored in the memory element G¹ (2, 1) in the second row and first column of the array G¹ is calculated and newly stored in the memory element G¹ (2, 1) in the second row and first column of the array G¹ of the storage device 800. A product of the data stored in the memory element W₁¹ (1, 2) in the first row and second column of the array W₁¹ and data stored in a memory element I (3, 2) in the third row and second column of the array I is calculated and a sum of this product and the data stored in the memory element G¹ (3, 1) in the third row and first column of the array G¹ is calculated and newly stored in the memory element G¹ (3, 1) in the third row and first column of the array G¹. Succeedingly, a product of the data stored in the memory element W₁¹ (1, 2) in the first row and second column of the array W₁¹ and data stored in a memory element I (4, 2) in the fourth row and second column of the array I is calculated and a sum of this product and the data stored in the memory element G¹ (4, 1) in the fourth row and first column of the array G¹ is calculated and newly stored in the memory element G¹ (4, 1) in the fourth row and first column of the array G¹. Thereafter, a product of the data stored in the memory element W₁¹ (1, 2) in the first row and second column of the array W₁¹ and data stored in a memory element I (5, 2) in the fifth row and second column of the array I is calculated and a sum of this product and the data stored in the memory element G¹ (5, 1) in the fifth row and first column of the array G¹ is calculated and newly stored in the memory element G¹ (5, 1) in the fifth row and first column of the array G¹. The result of these processes is shown in FIG. 26G. These processes can be executed in parallel. The parallel processing is advantageous in shortening the process time.

Subsequently, a convolution process in the same manner as explained with reference to FIGS. 26B to 26F is performed using the data stored in the memory elements W₁¹ (1, 2) to W₁¹ (5, 2) of the second column of the array W₁¹ to the data stored in the memory elements I (1, 2) to I (15, 2) of the second column of the array I. The result of this convolution process is stored in the memory elements G¹ (1, 1) to G¹ (11, 1) in the first row and first column to the eleventh row and first column of the array G¹.

Subsequently, a convolution process in the same manner as explained with reference to FIG. 26G is performed using the data stored in the memory elements W₁¹ (1, 3) to W₁¹ (5, 3) of the third column of the array W₁¹ to the data stored in the memory elements I (1, 3) to I (15, 3) of the third column of the array I. The result of this convolution process is stored in the memory elements G¹ (1, 1) to G¹ (11, 1) in the first row and first column to the eleventh row and first column of the array G¹. Thereafter, a convolution process in the same manner as explained with reference to FIG. 26G is performed using the data stored in the memory elements W₁¹ (1, 4) to W₁¹ (5, 4) of the fourth column of the array W₁¹ to the data stored in the memory elements I (1, 4) to I (15, 4) of the fourth column of the array I. The result of this convolution process is stored in the memory elements G¹ (1, 1) to G¹ (11, 1) in the first row and first column to the eleventh row and first column of the array G¹. Succeedingly, a convolution process in the same manner as explained with reference to FIG. 26G is performed using the data stored in the memory elements W₁¹ (1, 5) to W₁¹ (5, 5) of the fifth column of the array W₁¹ to the data stored in the memory elements I (1, 5) to I (15, 5) of the fifth column of the array I. The result of this convolution process is stored in the memory elements G¹ (1, 1) to G¹ (11, 1) in the first row and first column to the eleventh row and first column of the array G¹.

Through the processes described above, the convolution process using the array W₁¹ of the first kernel W₁ to the data stored in the memory elements I (1, 1) to I (15, 5) in the first to fifth columns of the array I is complete. The result of process is shown in FIG. 26H.

Subsequently, a convolution process in the same manner as explained with reference to FIGS. 26A to 26H is performed using the array W₁¹ of the first kernel W₁ to the data stored in the memory elements I (1, 2) to I (15, 6) in the second to sixth columns of the array I. The result of this convolution process is stored in the memory elements G¹ (1, 2) to G¹ (11, 2) in the second column of the array G¹, as shown in FIG. 26I.

Succeedingly, a convolution process in the same manner as explained with reference to FIGS. 26A to 26H is performed using the array W₁¹ to the data stored in the memory elements I (1, 3) to I (15, 7) in the third to seventh columns of the array I. The result of this convolution process is stored in the memory elements G¹ (1, 3) to G¹ (11, 3) in the third column of the array G¹. Thereafter, a convolution process in the same manner as explained with reference to FIGS. 26A to 26H is performed using the array W₁¹ to the data stored in the memory elements I (1, 4) to I (15, 8) in the fourth to eighth columns of the array I. The result of this convolution process is stored in the memory elements G¹ (1, 4) to G¹ (11, 4) in the fourth column of the array G¹. Succeedingly, a convolution process in the same manner as explained with reference to FIGS. 26A to 26H is performed using the array W₁¹ to the data stored in the memory elements I (1, 5) to I (15, 9) in the fifth to ninth columns of the array I. The result of this convolution process is stored in the memory elements G¹ (1, 5) to G¹ (11, 5) in the fifth column of the array G¹. Subsequently, a convolution process in the same manner as explained with reference to FIGS. 26A to 26H is performed using the array W₁¹ to the data stored in the memory elements I (1, 6) to I (15, 10) in the sixth to tenth columns of the array I. The result of this convolution process is stored in the memory elements G¹ (1, 6) to G¹ (11, 6) in the sixth column of the array G¹. Thereafter, a convolution process in the same manner as explained with reference to FIGS. 26A to 26H is performed using the array W₁¹ to the data stored in the memory elements I (1, 7) to I (15, 11) in the seventh to eleventh columns of the array I. The result of this convolution process is stored in the memory elements G¹ (1, 7) to G¹ (11, 7) in the seventh column of the array G¹. Subsequently, a convolution process in the same manner as explained with reference to FIGS. 26A to 26H is performed using the array W₁¹ to the data stored in the memory elements I (1, 8) to I (15, 12) in the eighth to twelfth columns of the array I. The result of this convolution process is stored in the memory elements G¹ (1, 8) to G¹ (11, 8) in the eighth column of the array G¹. Thereafter, a convolution process in the same manner as explained with reference to FIGS. 26A to 26H is performed using the array W₁¹ to the data stored in the memory elements I (1, 9) to I (15, 13) in the ninth to thirteenth columns of the array I. The result of this convolution process is stored in the memory elements G¹ (1, 9) to G¹ (11, 9) in the ninth column of the array G¹. Succeedingly, a convolution process in the same manner as explained with reference to FIGS. 26A to 26H is performed using the array W₁¹ to the data stored in the memory elements I (1, 10) to I (15, 14) in the tenth to fourteenth columns of the array I. The result of this convolution process is stored in the memory elements G¹ (1, 10) to G¹ (11, 10) in the tenth column of the array G¹. Succeedingly, a convolution process in the same manner as explained with reference to FIGS. 26A to 26H is performed using the array W₁¹ to the data stored in the memory elements I (1, 11) to I (15, 15) in the eleventh to fifteenth columns of the array I. The result of this convolution process is stored in the memory elements G¹ (1, 11) to G¹ (11, 11) in the eleventh column of the array G¹. The result of these processes is shown in FIG. 26J.

Through the processes described above, the convolution process using the array W₁¹ of the first kernel W₁ to the data stored in the memory elements I (1, 1) to I (15, 15) of the array I is complete.

Subsequently, a convolution process in the same manner as explained with reference to FIGS. 26A to 26J is performed using an array W₂¹ of a second kernel W₂ to the data stored in the memory elements I (1, 1) to I (15, 15) of the array I. The result of this convolution process is stored in memory elements G² (1, 1) to G² (11, 11) of an array G². Subsequently, a convolution process in the same manner as explained with reference to FIGS. 26A to 26J is performed using an array W₃¹ of a third kernel W₃ to the data stored in the memory elements I (1, 1) to I (15, 15) of the array I. The result of this convolution process is stored in memory elements G³ (1, 1) to G³ (11, 11) of an array G³. Thereafter, a convolution process in the same manner as explained with reference to FIGS. 26A to 263 is performed using an array W₄¹ of a fourth kernel W₄ to the data stored in the memory elements I (1, 1) to I (15, 15) of the array I. The result of this convolution process is stored in memory elements G⁴ (1, 1) to G⁴ (11, 11) of an array G⁴. Succeedingly, a convolution process in the same manner as explained with reference to FIGS. 26A to 26J is performed using an array W₅¹ of a fifth kernel W₅ to the data stored in the memory elements I (1, 1) to I (15, 15) of the array I. The result of this convolution process is stored in memory elements G⁵ (1, 1) to G⁵ (11, 11) of an array G⁵. Thereafter, a convolution process in the same manner as explained with reference to FIGS. 26A to 263 is performed using an array W₆¹ of a sixth kernel W₆ to the data stored in the memory elements I (1, 1) to I (15, 15) of the array I. The result of this convolution process is stored in memory elements G⁶ (1, 1) to G⁶ (11, 11) of an array G⁶. Succeedingly, a convolution process in the same manner as explained with reference to FIGS. 26A to 263 is performed using an array W₇¹ of a seventh kernel W₇ to the data stored in the memory elements I (1, 1) to I (15, 15) of the array I. The result of this convolution process is stored in memory elements G⁷ (1, 1) to G⁷ (11, 11) of an array G⁷. The result of these processes is shown in FIG. 26K.

Through the processes described above, the convolution process using the first arrays W₁¹ to W₇¹ of each of the first to seventh kernels W₁ to W₇ to the data stored in the memory elements I (1, 1) to I (15, 15) of the array I is complete. The processes of storing data in the memory elements of the different arrays G¹ to G⁷ of the storage device 800 can be executed in parallel. The parallel processing is advantageous in shortening the process time.

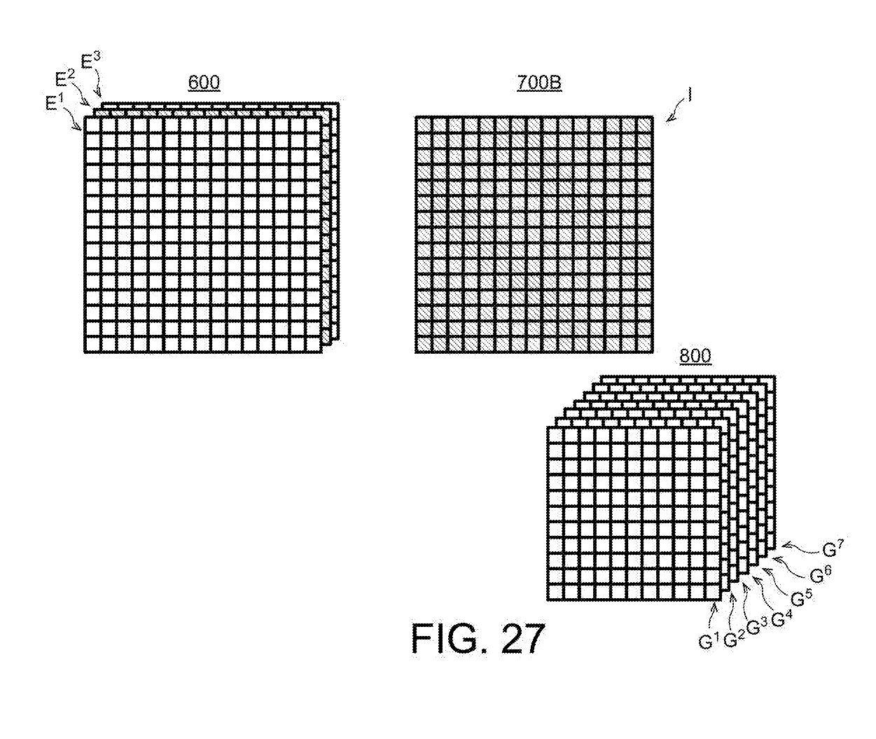

Subsequently, as shown in FIG. 27, data is read out of each memory element of the array E² of the external storage device 600 and stored in the corresponding memory element of the array I. In other words, the data stored in the array E² is also stored in the array I.

Succeedingly, a convolution process in the same manner as explained with reference to FIGS. 26A to 26K is performed using second arrays W₁² to W₇² of each of the first to seventh kernels W₁ to W₇ to the data stored in the memory elements I (1, 1) to I (15, 15) of the array I. The result of this convolution process is stored in the memory elements of the arrays G¹ to G⁷. In this case, a product between a memory element of an i-th (i=1, . . . , 7) array W₁² and a memory element of the array I is processed in such a manner that a sum of data in a memory element of an array Gⁱ, in which the above product is stored, and the above product is calculated and the sum is newly stored in the memory element of the array G¹. The processes of storing data in the memory elements of the different arrays G₁ to G₇ of the storage device 800 can be executed in parallel. The parallel processing is advantageous in shortening the process time.

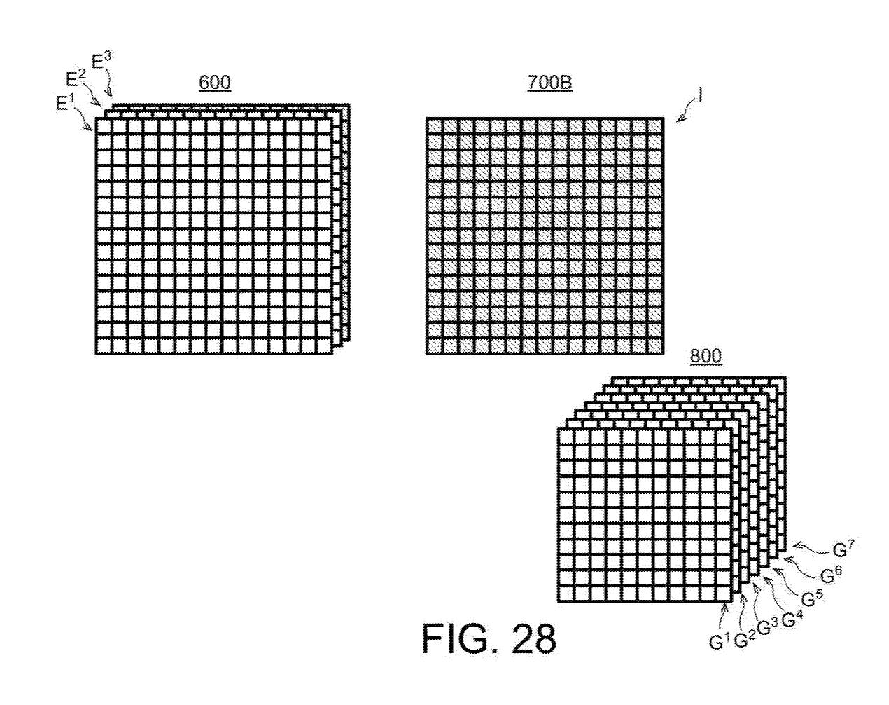

Subsequently, as shown in FIG. 28, data is read out of each memory element of the array E³ of the external storage device 600 and stored in the corresponding memory element of the array I. In other words, the data stored in the array E³ is also stored in the array I.

Succeedingly, a convolution process in the same manner as explained with reference to FIGS. 26A to 26K is performed using third arrays W₁³ to W₇³ of each of the first to seventh kernels W₁ to W₇ to the data stored in the memory elements I (1, 1) to I (15, 15) of the array I. The result of this convolution process is stored in the memory elements of the arrays G¹ to G⁷. In this case, a product between a memory element of an i-th (i=1, . . . , 7) array W₁³ and a memory element of the array I is processed in such a manner that a sum of data in a memory element of the array Gⁱ, in which the above product is stored, and the above product is calculated and the sum is newly stored in the memory element of the array The processes of storing data in the memory elements of the different arrays G₁ to G₇ of the storage device 800 can be executed in parallel. The parallel processing is advantageous in shortening the process time.

Subsequently, to each of the memory elements Gⁱ (1, 1) to Gⁱ (11, 11) of the array Gⁱ (i=1, . . . , 7) of the storage device 800, a sum of the data stored in the above memory element and the bias value Bᵢ is obtained, with an activation function process such as a rectified linear Unit (ReLU) function being applied to the sum as required, and a numerical value of the sum is newly stored in the above memory element. These processes to the different arrays of the storage device 800 can be executed in parallel. The parallel processing is advantageous in shortening the process time.

Through the processes described above, the convolution processes, using the first to seventh kernels W₁ to W₇ to the same data as the data stored in the external storage device 600, are complete.

In the present modification, the storage device 700B has the array I having the same size as each of the arrays E¹ to E³ of the external storage device 600 in the row and column directions. Not only limited to this, for example, the storage device 700B may have an array of a larger size than each of the arrays E¹ to E³ of the external storage device 600 in the row and column directions. Nevertheless, the array I having the same size as each of the arrays E¹ to E³ of the external storage device 600 in the row and column directions gives the maximum effect on decrease in capacity of the storage device 700B.

(Third Modification)

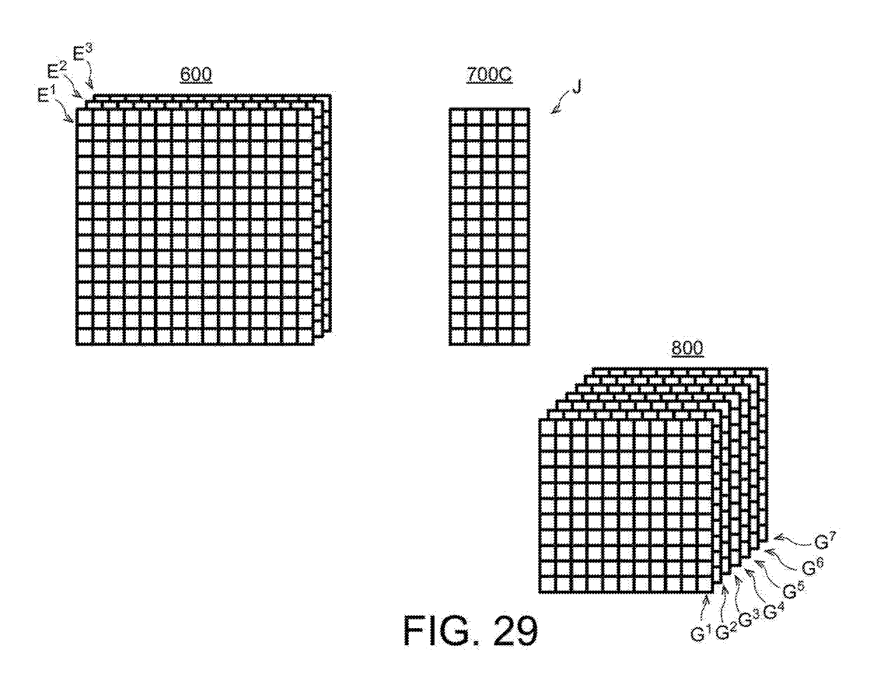

In the second modification shown in FIG. 24, the storage device 7006 includes the array I with the same size as the arrays of the external storage device 600 in the row and column directions and with a smaller number of arrays than the arrays E¹ to E³ of the external storage device 600 in the depth direction. However, as shown in FIG. 29, an array J may be provided to have the same size as each of the arrays E¹ to E³ in the row direction, the same size as the kernels to be used for convolution processes in the column direction, and a smaller number of arrays than the arrays E¹ to E³. In this case, further reduction in circuit area is achieved because of a further decreased number of storage devices. The above example will be explained as a third modification of the third embodiment.

FIG. 29 shows an arithmetic processing device according to the third modification. The arithmetic processing device of the third modification has the same configuration as the arithmetic processing device of the second modification shown in FIG. 24, except for a storage device 700C replaced for the storage device 700B. The storage device 700C is provided with an array J including memory elements in fifteen rows and five columns. The storage device 700C may be provided with a plurality of arrays.

(Operation)

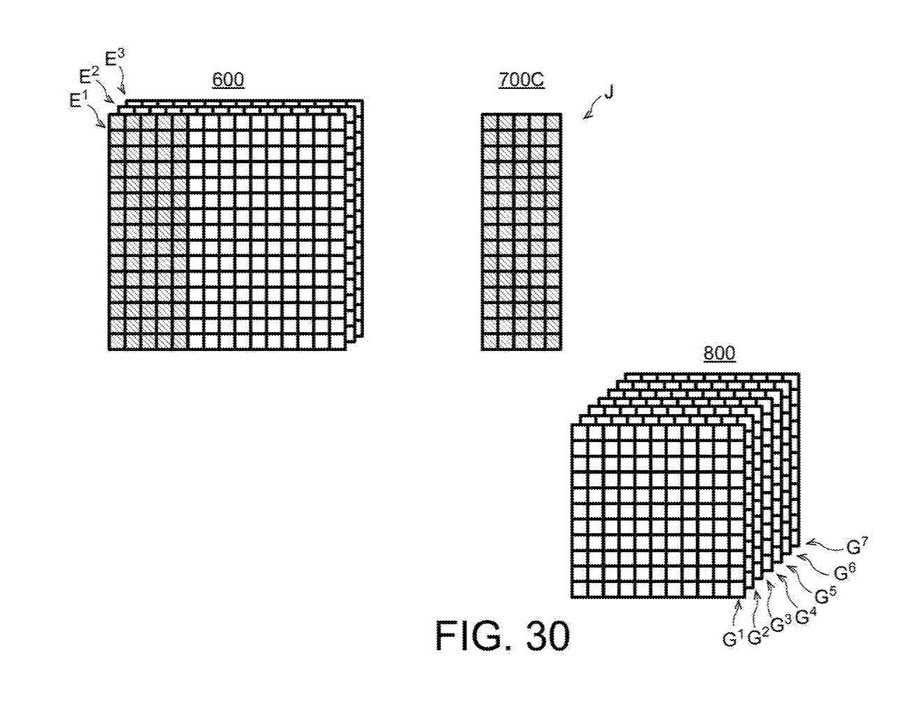

Subsequently, an operation in the third modification will be explained with reference to FIGS. 30 to 32J.

First of all, as shown in FIG. 30, data stored in memory elements E¹ (1, 1) to E¹ (15, 5) in the first to fifth columns of the arrays E¹ of the storage device 600 is read out and stored in the array J of the storage device 700C. When it is defined that m is an integer equal to or larger than one but equal to or smaller than 15 and n is an integer equal to or larger than one but equal to or smaller than 5, data stored in memory elements E¹ (m, n) in m rows and n columns of the array E¹ is stored in memory elements J (m, n) in m rows and n columns of the array J.

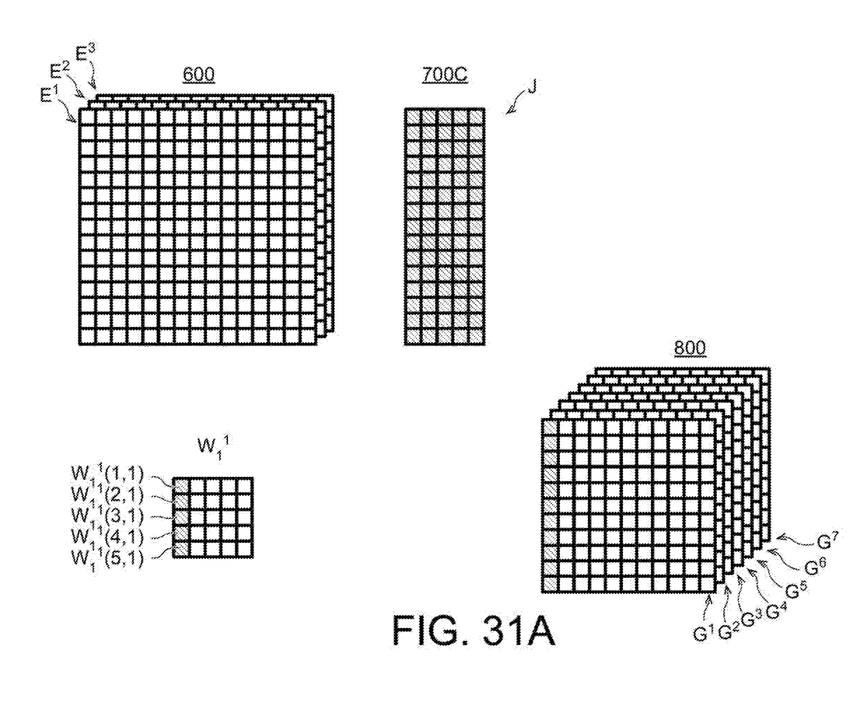

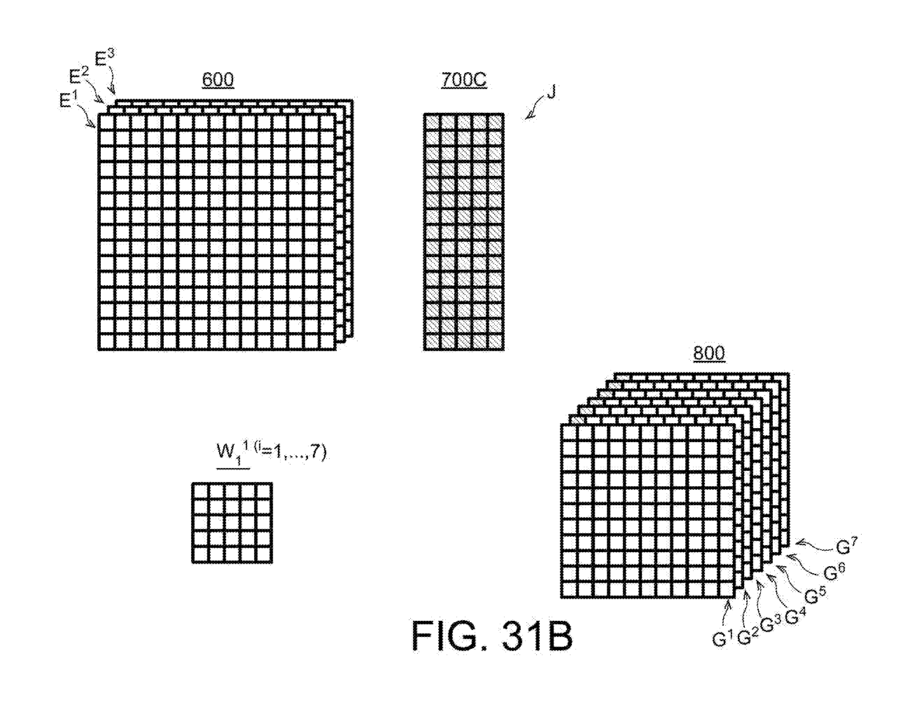

Subsequently, a convolution processes in the same manner as explained with reference to FIGS. 21A to 21C is performed using data W₁¹ (1, 1) to W₁¹ (5, 5) of the array W₁¹ of the first kernel W₁ to data J (1, 1) to 3 (15, 5) in the first to fifth columns of the array J. The result of the convolution process using the array W₁¹ is stored in memory elements G¹ (1, 1) to G¹ (15, 1) in the first column of the array G¹ of the storage device 800 as shown in FIG. 31A.

Subsequently, a convolution process is performed using data (1, 1) to W₁¹ (5, 5) of a first array W₁¹ of an i-th (i=2, . . . , 7) kernel Wᵢ to the data J (1, 1) to J (15, 5) in the first to fifth columns of the array J. The result of convolution process using the array W₁¹ of the i-th (i=2, . . . , 7) kernel Wᵢ is stored in the memory elements in the first column of an array Gⁱ of the storage device 800, as shown in FIG. 31B.

Through the processes described above, the convolution process using each of first arrays W₁¹ to W₇¹ of each of the first to seventh kernels W₁ to W₇ to the data J (1, 1) to J (15, 5) in the first to fifth columns of the array J is complete. The processes of storing data in the first column of the different arrays G¹ to G⁷ of the storage device 800 can be executed in parallel. The parallel processing is advantageous in shortening the process time.

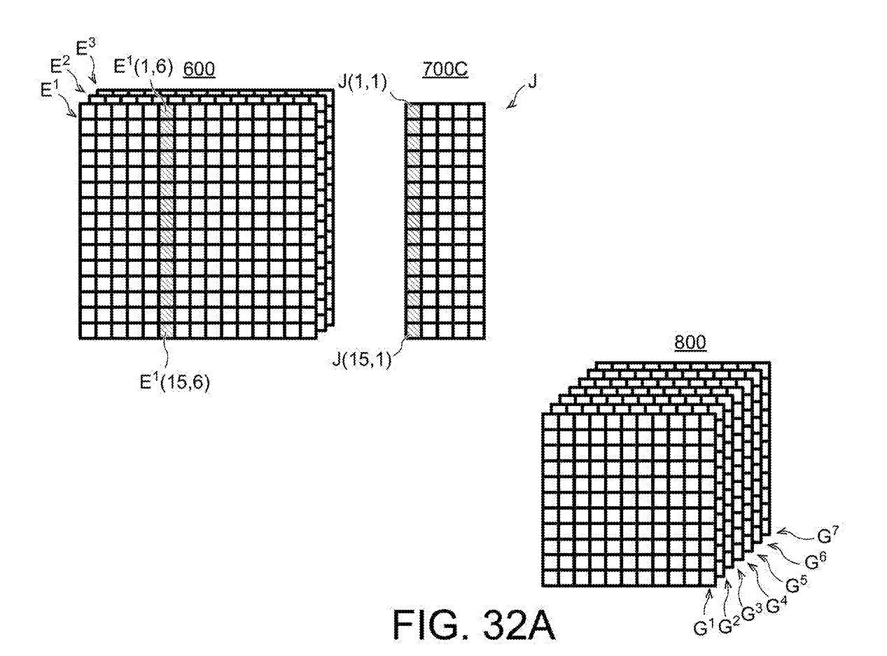

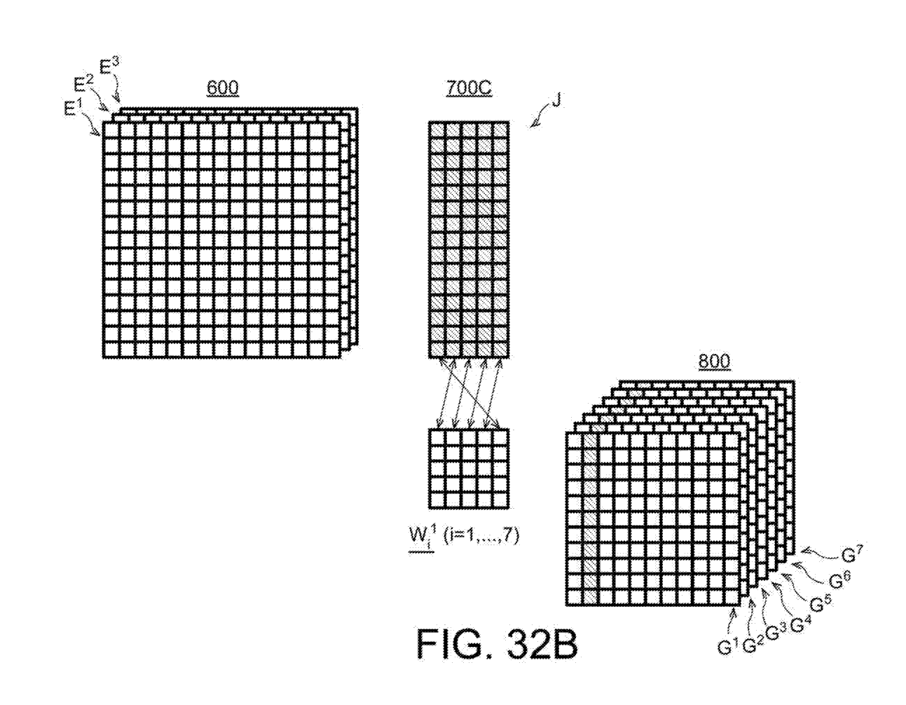

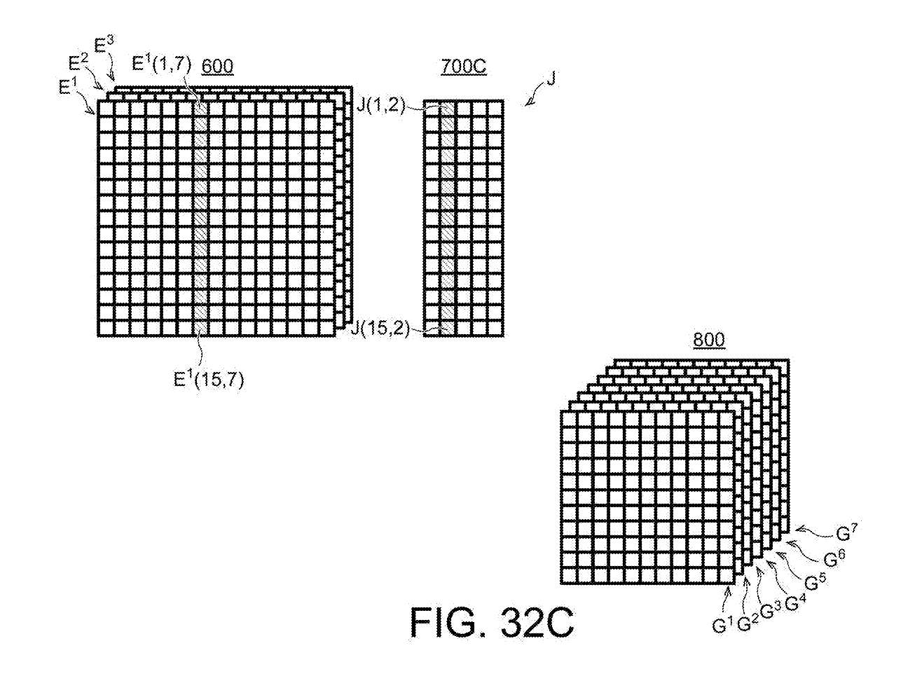

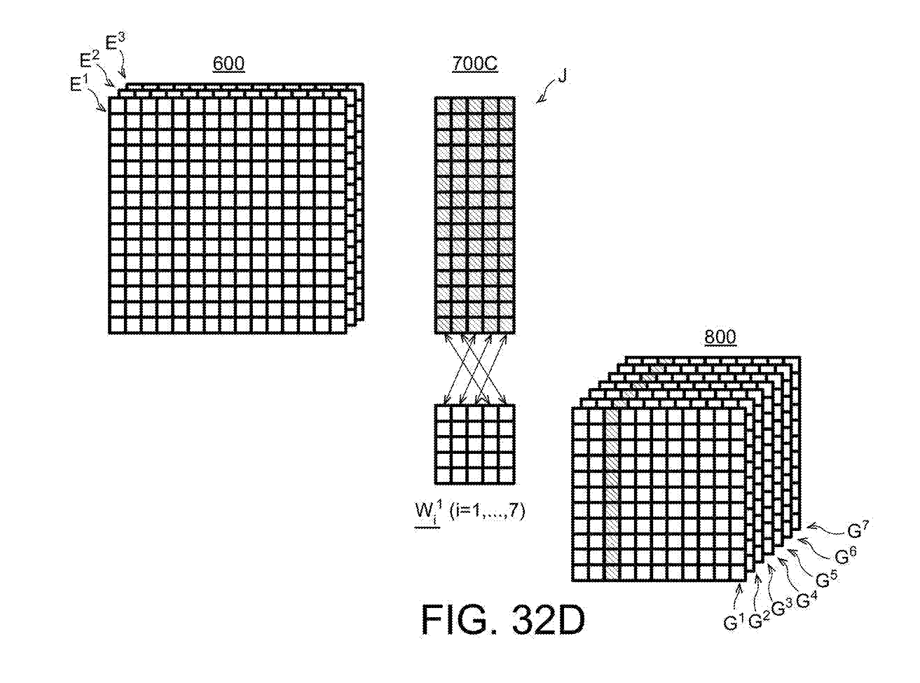

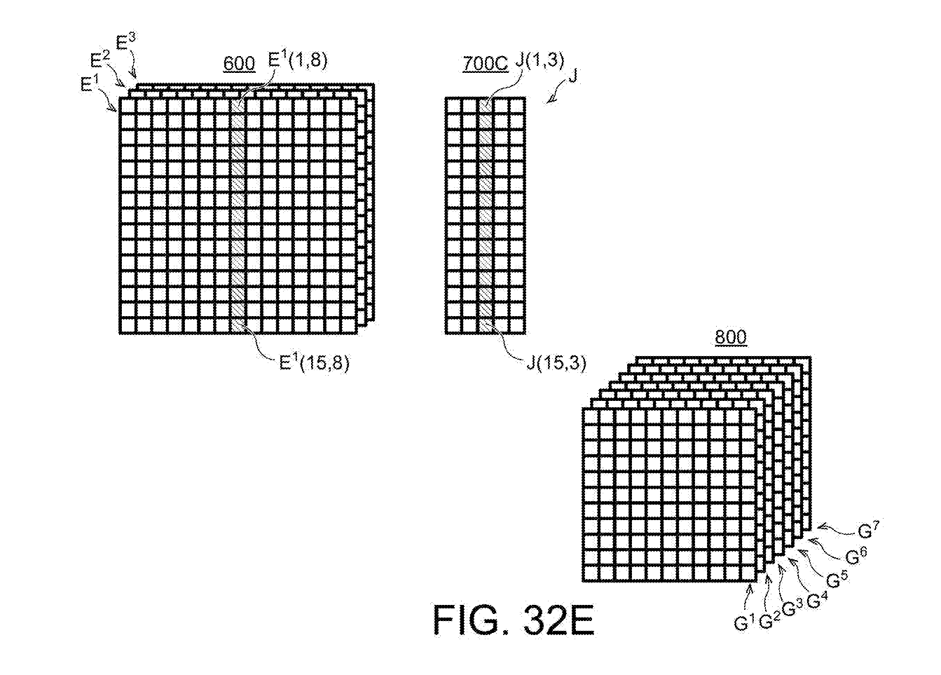

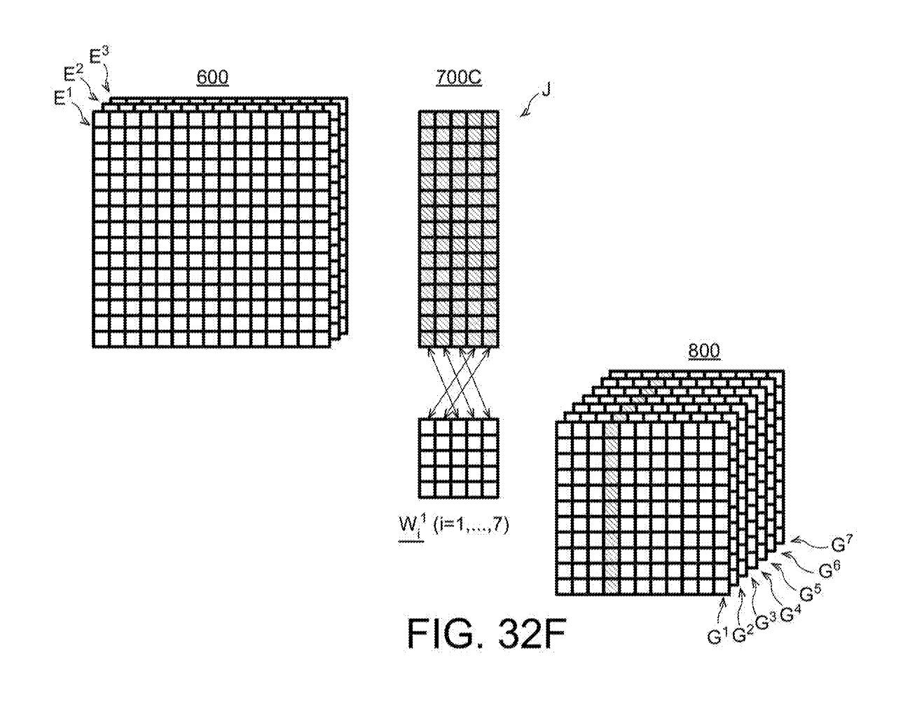

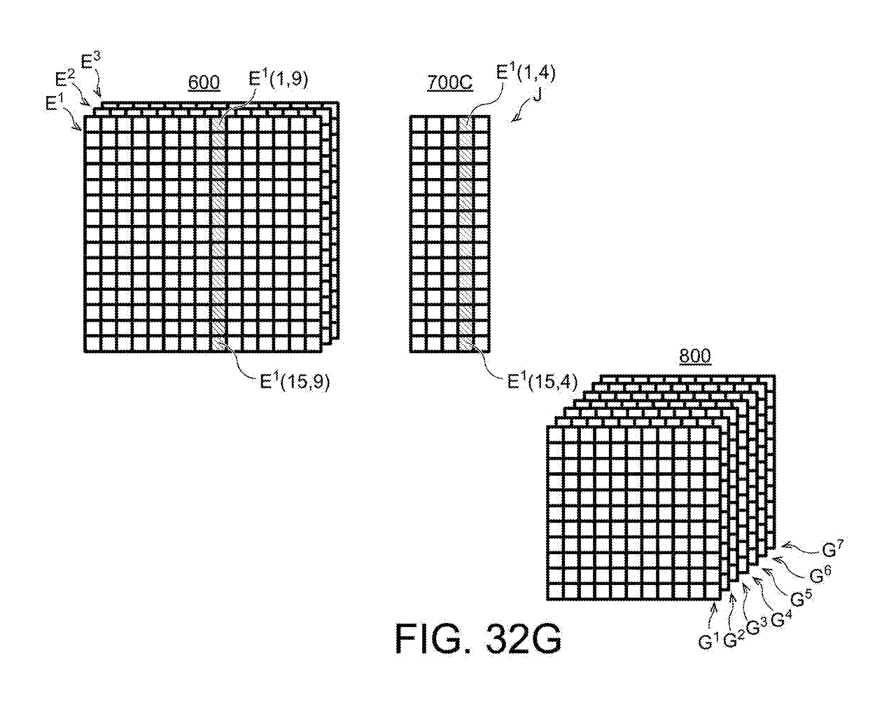

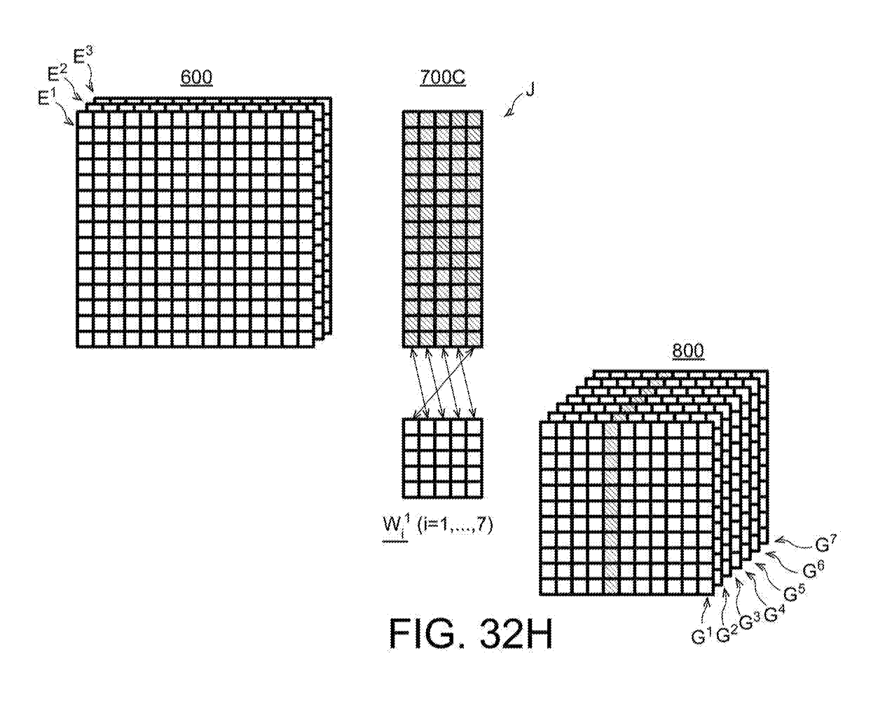

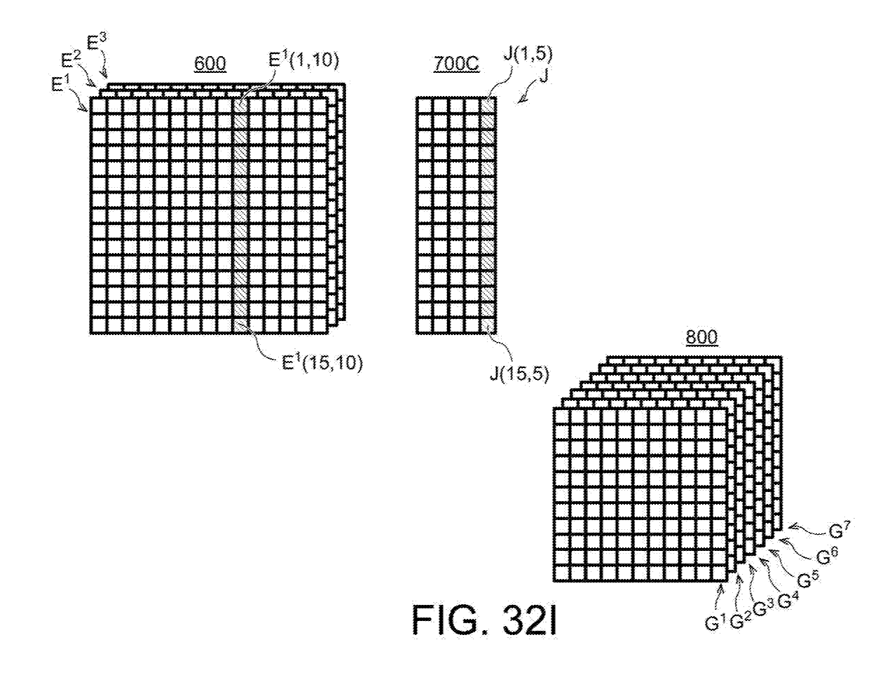

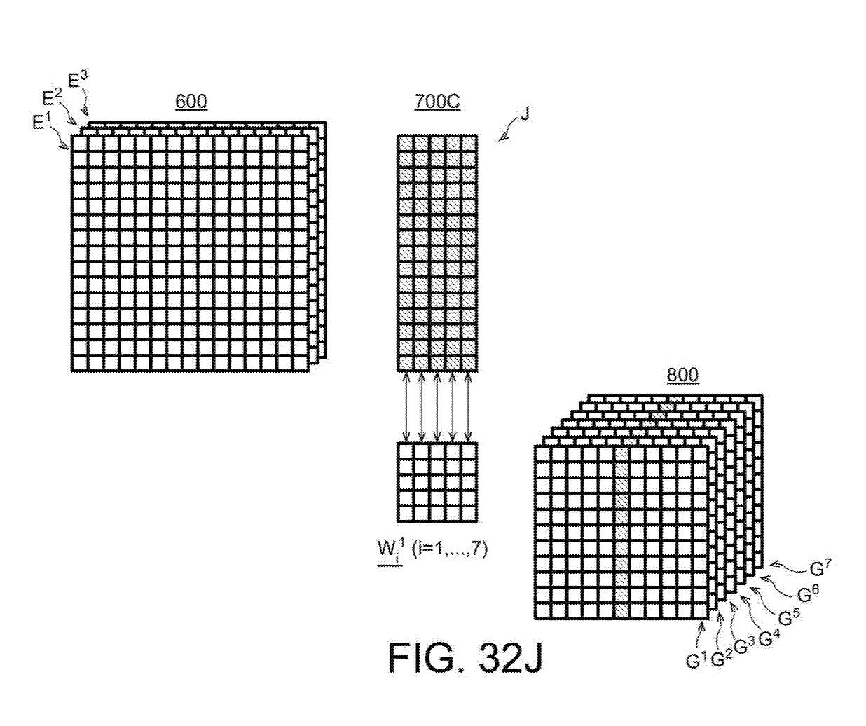

Subsequently, as shown in FIG. 32A, data of memory elements E¹ (1, 6) to E¹ (15, 6) in the sixth column of the array E¹ is read out and stored in the memory elements J (1, 1) to J (15, 1) in the first column of the array J. At this time, data of memory elements in the second column of the array E¹ has been stored in memory elements in the second column of the array J, data of memory elements in the third column of the array E¹ has been stored in memory elements in the third column of the array J, data of memory elements in the fourth column of the array E¹ has been stored in memory elements in the fourth column of the array J, and data of memory elements in the fifth column of the array E¹ has been stored in memory elements in the fifth column of the array J.

Subsequently, a convolution process in the same manner as explained with reference to FIGS. 31A and 31B is performed using the data stored in the i-th (i=1, . . . , 7) kernel Wᵢ to the data stored in the array J. The result of this convolution process is stored in memory elements Gⁱ (1, 2) to Gⁱ (11, 2) in the second column of the array G¹. In detail, in this convolution process, as shown in FIG. 32B, convolution processes are performed to data in the first column of a first array Wᵢ¹ in an i-th (i=1, . . . , 7) kernel Wᵢ and data in the second column of the array J, to data in the second column of the array Wᵢ¹ and data in the third column of the array J, to data in the third column of the array Wᵢ¹ and data in the fourth column of the array J, to data in the fourth column of the array Wᵢ¹ and data in the fifth column of the array J, and to data in the fifth column of the array Wᵢ¹ and data in the first column of the array J. The processes of storing data in the second column of the different arrays G¹ to G⁷ of the storage device 800 can be executed in parallel. The parallel processing is advantageous in shortening the process time.

Subsequently, as shown in FIG. 32C, data of memory elements E¹ (1, 7) to E¹ (15, 7) in the seventh column of the array E¹ is read out and stored in memory elements J (1, 2) to J (15, 2) in the second column of the array J. At this time, data of memory elements in the sixth column of the array E¹ has been stored in memory elements in the first column of the array J, data of memory elements in the third column of the array E¹ has been stored in memory elements in the third column of the array J, data of memory elements in the fourth column of the array E¹ has been stored in memory elements in the fourth column of the array J, and data of memory elements in the fifth column of the array E¹ has been stored in memory elements in the fifth column of the array J.

Subsequently, a convolution process in the same manner as explained with reference to FIGS. 31A and 31B is performed using the data stored in the i-th (i=1, . . . , 7) kernel Wᵢ to the data stored in the array J. The result of this convolution process is stored in memory elements Gⁱ (1, 3) to Gⁱ (11, 3) in the third column of the array G¹. In detail, in this convolution process, as shown in FIG. 32D, convolution processes are performed to data in the first column of the first array Wᵢ¹ in the i-th (i=1, . . . , 7) kernel Wᵢ and data in the third column of the array J, to data in the second column of the array Wᵢ¹ and data in the fourth column of the array J, to data in the third column of the array Wᵢ¹ and data in the fifth column of the array J, to data in the fourth column of the array Wᵢ¹ and data in the first column of the array J, and to data in the fifth column of the array W₁¹ and data in the second column of the array J. The processes of storing data in the third column of the different arrays G¹ to G⁷ of the storage device 800 can be executed in parallel. The parallel processing is advantageous in shortening the process time.

Subsequently, as shown in FIG. 32E, data of memory elements E¹ (1, 8) to E¹ (15, 8) in the eighth column of the array E¹ is read out and stored in memory elements J (1, 3) to J (15, 3) in the third column of the array J. At this time, data of memory elements in the sixth column of the array E¹ has been stored in memory elements in the first column of the array J, data of memory elements in the seventh column of the array E¹ has been stored in memory elements in the second column of the array J, data of memory elements in the fourth column of the array E¹ has been stored in memory elements in the fourth column of the array J, and data of memory elements in the fifth column of the array E¹ has been stored in memory elements in the fifth column of the array J.

Subsequently, a convolution process in the same manner as explained with reference to FIGS. 31A and 31B is performed using the data stored in the i-th (i=1, . . . , 7) kernel Wᵢ to the data stored in the array J. The result of this convolution process is stored in memory elements Gⁱ (1, 4) to Gⁱ (11, 4) in the fourth column of the array G¹. In detail, in this convolution process, as shown in FIG. 32F, convolution processes are performed to data in the first column of the first array Wᵢ¹ in the i-th (i=1, . . . , 7) kernel Wᵢ and data in the fourth column of the array J, to data in the second column of the array Wᵢ¹ and data in the fifth column of the array J, to data in the third column of the array Wᵢ¹ and data in the first column of the array J, to data in the fourth column of the array W₁¹ and data in the second column of the array J, to data in the fifth column of the array W₁¹ and data in the third column of the array J. The processes of storing data in the fourth column of the different arrays G¹ to G⁷ of the storage device 800 can be executed in parallel. The parallel processing is advantageous in shortening the process time.

Subsequently, as shown in FIG. 32G, data of memory elements E¹ (1, 9) to E¹ (15, 9) in the ninth column of the array E¹ is read out and stored in memory elements J (1, 4) to J (15, 4) in the fourth column of the array J. At this time, data of memory elements in the sixth column of the array E¹ has been stored in memory elements in the first column of the array J, data of memory elements in the seventh column of the array E¹ has been stored in memory elements in the second column of the array J, data of memory elements in the eighth column of the array E¹ has been stored in memory elements in the third column of the array J, and data of memory elements in the fifth column of the array E¹ has been stored in memory elements in the fifth column of the array J.

Subsequently, a convolution process in the same manner as explained with reference to FIGS. 31A and 31B is performed using the data stored in the i-th (i=1, . . . , 7) kernel Wᵢ to the data stored in the array J. The result of this convolution process is stored in memory elements Gⁱ (1, 5) to Gⁱ (11, 5) in the fifth column of the array G¹. In detail, in this convolution process, as shown in FIG. 32H, convolution processes are performed to data in the first column of the first array Wᵢ¹ in the i-th (i=1, . . . , 7) kernel Wᵢ and data in the fifth column of the array J, to data in the second column of the array Wᵢ¹ and data in the first column of the array J, to data in the third column of the array Wᵢ¹ and data in the second column of the array J, to data in the fourth column of the array Wᵢ¹ and data in the third column of the array J, and to data in the fifth column of the array W₁¹ and data in the fourth column of the array J. The processes of storing data in the fifth column of the different arrays G¹ to G⁷ of the storage device 800 can be executed in parallel. The parallel processing is advantageous in shortening the process time.

Subsequently, as shown in FIG. 32I, data of memory elements E¹ (1, 10) to E¹ (15, 10) in the tenth column of the array E¹ is read out and stored in memory elements J (1, 5) to J (15, 5) in the fifth column of the array J. At this time, data of memory elements in the sixth column of the array E¹ has been stored in memory elements in the first column of the array J, data of memory elements in the seventh column of the array E¹ has been stored in memory elements in the second column of the array J, data of memory elements in the eighth column of the array E¹ has been stored in memory elements in the third column of the array J, and data of memory elements in the ninth column of the array E¹ has been stored in memory elements in the fourth column of the array J.

Subsequently, a convolution process in the same manner as explained with reference to FIGS. 31A and 31B is performed using the data stored in the i-th (i=1, . . . , 7) kernel Wᵢ to the data stored in the array J. The result of this convolution process is stored in memory elements Gⁱ (1, 6) to Gⁱ (11, 6) in the sixth column of the array G¹. In detail, in this convolution process, as shown in FIG. 32J, convolution processes are performed to data in the first column of the first array Wᵢ¹ in the i-th (i=1, . . . , 7) kernel Wᵢ and data in the first column of the array J, to data in the second column of the array Wᵢ¹ and data in the second column of the array J, to data in the third column of the array Wᵢ¹ and data in the third column of the array J, to data in the fourth column of the array Wᵢ¹ and data in the fourth column of the array J, and to data in the fifth column of the array W₁¹ and data in the fifth column of the array J. The processes of storing data in the sixth column of the different arrays G¹ to G⁷ of the storage device 800 can be executed in parallel. The parallel processing is advantageous in shortening the process time.

Through the processes described above, the convolution process using the first arrays W₁¹ to W₇¹ of each of the first to seventh kernels W₁ to W₇ to the data stored in the memory elements in the first to tenth columns of the array E¹ of the external storage device 600 is complete.

Subsequently, data stored in memory elements in the eleventh column of the array E¹ of the external storage device 600 is read out and this read-out data is stored, as shown in FIG. 32A, in memory elements in the first column the array J of the storage device 700C. Subsequently, a convolution process in the same manner as explained with reference to FIG. 32B is performed using the first array Wᵢ¹ in the i-th (i=1, . . . , 7) kernel Wᵢ to the data stored in memory elements J (1, 1) to J (15, 5) of the array J, the result being stored in memory elements Gⁱ (1, 7) to Gⁱ (11, 7) in the seventh column of the array Gⁱ. Subsequently, data stored in memory elements in the twelfth column of the array E¹ is read out and this read-out data is stored, as shown in FIG. 32C, in memory elements in the second column of the array J of the storage device 700C. Subsequently, a convolution process in the same manner as explained with reference to FIG. 32D is performed using the first array Wᵢ¹ in the i-th (i=1, . . . , 7) kernel Wᵢ to the data stored in the memory elements J (1, 1) to J (15, 5) of the array J, the result being stored in memory elements Gⁱ (1, 8) to Gⁱ (11, 8) in the eighth column of the array Gⁱ. Thereafter, data stored in memory elements in the thirteenth column of the array E¹ is read out and this read-out data is stored, as shown in FIG. 32E, in memory elements in the third column of the array J of the storage device 700C. Subsequently, a convolution process in the same manner as explained with reference to FIG. 32F is performed using the first array Wᵢ¹ in the i-th (i=1, . . . , 7) kernel Wᵢ to the data stored in the memory elements J (1, 1) to J (15, 5) of the array J, the result being stored in memory elements Gⁱ (1, 9) to Gⁱ (11, 9) in the ninth column of the array Succeedingly, data stored in memory elements in the fourteenth column of the array E¹ is read out and this read-out data is stored, as shown in FIG. 32G, in memory elements in the fourth column of the array J of the storage device 700C. Subsequently, a convolution process in the same manner as explained with reference to FIG. 32H is performed using the first array Wᵢ¹ in the i-th (i=1, . . . , 7) kernel Wᵢ to the data stored in memory elements J (1, 1) to J (15, 5) of the array J, the result being stored in memory elements Gⁱ (1, 10) to Gⁱ (11, 10) in the tenth column of the array Gⁱ. Thereafter, data stored in memory elements in the fifteenth column of the array E¹ is read out and this read-out data is stored, as shown in FIG. 32I, in memory elements in the fifth column of the array J of the storage device 700C. Subsequently, a convolution process in the same manner as explained with reference to FIG. 32J is performed using the first array Wᵢ¹ in the i-th (i=1, . . . , 7) kernel Wᵢ to the data stored in memory elements J (1, 1) to J (15, 5) of the array J, the result being stored in memory elements Gⁱ (1, 11) to Gⁱ (11, 11) in the eleventh column of the array Gⁱ.

Through the processes described above, the convolution processes, using the first arrays W₁¹ to W₇¹ of each of the first to seventh kernels W₁ to W₇ to the same data as the data stored in the array E¹ of the external storage device 600, are complete.

Subsequently, a convolution process, using j-th (j=2, 3) arrays W₁^{j} to W₇^{j} of each of the first to seventh kernels W₁ to W₇ to the same data as the data stored in an array E^{j} (j=2, 3) of the external storage device 600, is performed in the same manner as the process explained with reference to FIGS. 31A to 32J and as the process after the process explained with reference to FIG. 32J. A sum of a product calculated in the above process and data stored in memory elements of the arrays G¹ to G⁷ in which the product is to be stored is calculated, and the sum is newly stored in the memory elements of the arrays G¹ to G⁷ in which the product is to be stored.

Through the processes described above, the convolution processes, using the first to seventh kernels W₁ to W₇ to the same data as the data stored in the arrays E¹ to E³ of the external storage device 600, are complete.

Subsequently, when it is defined that m and n are an integer equal to or larger than one but equal to or smaller than 11, a sum with the bias value Bᵢ is obtained to memory elements Gⁱ (m, n) in m rows and n columns of the array Gⁱ (i=1, . . . , 7), with an activation function process such as a rectified linear Unit (ReLU) function being applied to the sum as required, and a numerical value of the sum is newly stored in the above memory elements Gⁱ (m, n). These processes to the different arrays of the storage device 800 can be executed in parallel. The parallel processing is advantageous in shortening the process time.

In the third modification, the storage device 700C has the array J with the same size as each of the arrays E¹ to E³ of the external storage device 600 in the row direction and with the same size as the kernels to be used for convolution processes in the column direction. Not only limited to this, for example, an array may be provided to have a larger size than each of the arrays E¹ to E³ in the row direction and a larger size than the kernels to be used for convolution processes in the column direction. Nevertheless, like the third modification, the array J with the same size as each of the arrays E¹ to E³ in the row direction and with the same size as the kernels to be used for convolution processes in the column direction gives the maximum effect on decrease in the number of storage devices.

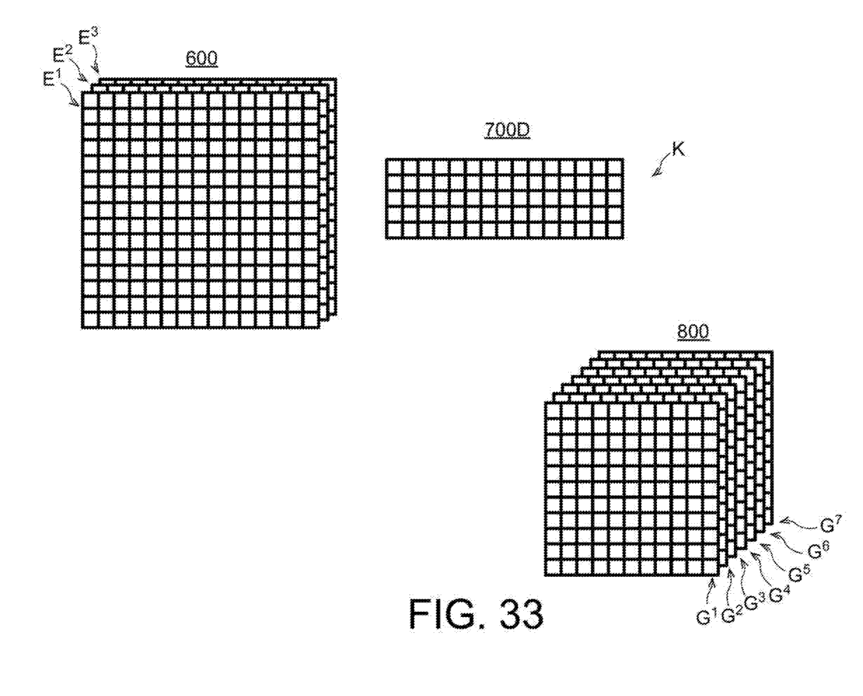

In the third modification, the storage device 700C has arrays with the same size as each of the arrays E¹ to E³ in the row direction and with the same size as the kernels to be used for convolution processes in the column direction, the number of the arrays being smaller than that of the arrays E¹ to E³. Not only limited to this, for example, as shown in FIG. 33, an array may be provided to have the same size as each of the arrays E¹ to E³ in the column direction and the same size as the kernels to be used for convolution processes in the row direction, the number of the arrays being smaller than that the arrays E¹ to E³. In this case, through the processes explained with reference to FIGS. 30 to 32J, with exchanged coordinates between the column and row directions in the drawings, numerical values for which necessary processes are applied to the arrays E¹ to E³ are stored in all of the storage devices that configure the storage device 800.

As explained above, according to the third embodiment and its modifications, the storage devices can have a smaller capacity than conventional ones, and hence an arithmetic processing device of a small occupied area can be provided.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An arithmetic processing device comprising:
a first storage device including at least one first array having memory elements arranged in a first direction and a second direction intersecting with the first direction;
a second storage device including at least one second array having memory elements arranged in the first direction;
a third storage device including at least one third array having memory elements arranged in the first and second directions, the third array having a smaller number of memory elements arranged in the first direction than the memory elements of the first array, arranged in the first direction, and having a smaller number of memory elements arranged in the second direction than the memory elements of the first array, arranged in the second direction; and
a first process layer, using data stored in the memory elements of the third array, to perform a convolution process to data stored in the memory elements of the first array, and to store a result of the convolution process in the memory elements of the second array.

2. The arithmetic processing device according to claim 1, wherein the memory elements of the second array are arranged one-dimensionally only in the first direction.

3. The arithmetic processing device according to claim 1, wherein the second array has a smaller number of memory elements arranged in the first direction than the memory elements of the first array, arranged in the first direction.

4. The arithmetic processing device according to claim 1, wherein the first process layer performs the convolution process along the first direction.

5. The arithmetic processing device according to claim 1, wherein the second storage device includes a plurality of second arrays.

6. The arithmetic processing device according to claim 1, wherein the first storage device includes m (m≥1) first arrays and the third storage device includes m third arrays.

7. The arithmetic processing device according to claim 6, wherein the third storage device further includes m (m≥1) fourth arrays each having memory elements arranged in the first and second directions, the fourth array having an equal number of memory elements arranged in the first and second directions to the memory elements of the third array, arranged in the first and second directions, respectively,
the second storage device includes two second arrays, and
the first process layer stores a result of a convolution process using the third array in one of the two second arrays and stores a result of a convolution process using the fourth array in the other of the two second arrays.

8. The arithmetic processing device according to claim 1 further comprising:
a fourth storage device including at least one fifth array having memory elements arranged in the first and second directions; and
a second process layer to perform a pooling process to data stored in the memory elements of the second array, and to store a result of the pooling process in the memory elements of the fifth array.

9. The arithmetic processing device according to claim 1 further comprising:
a fourth storage device includes at least one fifth array having memory elements arranged in the first and second directions;
a fifth storage device includes at least one sixth array having memory elements arranged in the first and second directions; and
a second process layer, using data stored in the memory elements of the sixth array, to perform a convolution process to data stored in the memory elements of the second array, and to store a result of the convolution process in the memory elements of the fifth array.

10. An arithmetic processing device comprising:
a readout device that reads out at least part of data from an external storage device including at least one first array having memory elements arranged in a first direction and a second direction intersecting with the first direction;
a first storage device including at least one second array having memory elements arranged in the first and second directions, the at least part of data read out by the readout device being stored in the second array;
a third storage device including at least one third array having memory elements arranged in the first and second directions;
a fourth storage device including at least one fourth array having memory elements arranged in the first and second directions; and
a process layer, using data stored in the memory elements of the fourth array, to perform a convolution process to data stored in the memory elements of the second array, and to store a result of the convolution process in the memory elements of the third array.

11. The arithmetic processing device according to claim 10, wherein the second array has an equal number of memory elements arranged in the first direction to the memory elements of the first array, arranged in the first direction, and has an equal number of memory elements arranged in the second direction to the memory elements of the first array, arranged in the second direction.

12. The arithmetic processing device according to claim 10, wherein the second array has an equal number of memory elements arranged in the first direction to the memory elements of the first array, arranged in the first direction, and has an equal number of memory elements arranged in the second direction to the memory elements of the fourth array, arranged in the second direction.
